(19) United States
(12) Patent Application Publication
(10) Pub. No.: US 2004/0163050 A1
(43) Pub. Date: Aug. 19, 2004

(54) Systems and methods for managing negotiated transactions

(76) Inventor: Bruce Edward Matter, North Potomac, MD (US)

Correspondence Address: BIRCH STEWART KOLASCH & BIRCH, PO BOX 747, FALLS CHURCH, VA, 22040-0747, US

(21) Appl. No.: 10/717,576

(22) Filed: Nov. 21, 2003

Related U.S. Application Data
(60) Provisional application No. 60/427,925, filed on Feb. 14, 2003.

(51) Int. Cl. G06F 17/21

(52) U.S. Cl. 715/530

(57) ABSTRACT

The present invention relates generally to systems and methods for storing a plurality of documents, where each of the plurality of documents is divided into a plurality of clauses. Each of the plurality of clauses may be stored separately. Systems and methods further include the ability to store comments and modifications relating to associated clauses, together with identifying information. The comments and modifications may be considered in the generation of a final document.

### RELATED APPLICATION DATA

This application is related to and claims priority to U.S. Provisional Application No. 60/427,925, filed Nov. 21, 2002, entitled “Method and System of Managing Negotiated Transactions”, which is expressly incorporated herein by reference in its entirety.

### BACKGROUND OF THE INVENTION

1. Field of the Invention

The present invention relates generally to network applications and more specifically, to systems and methods managing negotiated transactions and document preparation over a network.

2. Description of Related Art

Current computer programs that automate document assembly and track document change activity contemplate or describe the document language as “boiler-plate” or “template” clauses that are intended to remain fixed during the document preparation process. Some of these document clauses contain data fields for data that are expected to vary from document to document. For example, the name and address of a party to a contract document, the date of the contract, the contract price, and other similar pieces of information are generally referred to as contract data.

However, these computer programs do not contemplate including the document clauses themselves in a unified method or system for managing the document preparation process. Conventional systems do not record, index and save the original proposed document, changes to a document made during the document preparation process, nor the comments and approvals with respect to each change. This prohibits the retrieval and review of this information on an enterprise-wide, real-time basis.

As such, there is a need for a unified system and method that manages all types of information related to the document preparation process.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1A is an exemplary system environment for implementing the features of the present invention;

FIG. 1B is an exemplary diagram of the components of a server computer, consistent with the principles of the present invention;

FIG. 1C is an exemplary diagram of the components of a client device, consistent with the principles of the present invention;

FIG. 1D-1E illustrate an example of a data storage scheme that employs the use of separate cells within separate worksheets, and how the data may be indexed, related to, and displayed in multiple separate worksheets consistent with the principles of the present invention;

FIG. 2 illustrates a data storage scheme that employs the use of combining separate worksheets into a single workbook consistent with the principles of the present invention;

FIG. 3-4 illustrate relationships between cells, worksheets and workbooks consistent with the principles of the present invention;

FIG. 5 illustrates an example of a Comments Worksheet consistent with the principles of the present invention;

FIG. 6 is a data flow chart illustrating the overall data flow and user interface points consistent with the principles of the present invention;

FIGS. 7-30 illustrate examples of user interface screens for use in an application consistent with the principles of the present invention;

FIG. 31 illustrates one embodiment of the invention in a networked environment consistent with the principles of the present invention;

FIG. 32 is a flowchart diagram illustrating one embodiment of the invention in a network environment consistent with the principles of the present invention;

FIG. 33 illustrates one embodiment of the invention in an email network environment consistent with the principles of the present invention;

FIG. 34 is a flowchart diagram illustrating one embodiment of the invention in an email network environment consistent with the principles of the present invention;

FIG. 35 is an block diagram depicting a workstation operating in a network environment consistent with the principles of the present invention;

FIG. 36 is a flowchart diagram illustrating one example of a method of creating master matrices consistent with the principles of the present invention;

FIG. 37 is a flowchart diagram illustrating one example of a method of searching and editing content consistent with the principles of the present invention;

FIG. 38 is a flowchart diagram illustrating one example of a method of creating Baseline Documents consistent with the principles of the present invention;

FIGS. 39A-B are an exemplary flow diagram illustrating the creation of Baseline Documents consistent with the principles of the present invention;

FIG. 40 is a flowchart diagram illustrating one example of a method of creating and transmitting an Active Document Container consistent with the principles of the present invention;

FIG. 41 is a flowchart diagram illustrating one example of a method of generating a Document in final form consistent with the principles of the present invention;

FIG. 42 is a flowchart diagram illustrating one example of a Document reader's experience after logging-in to an Active Document Container consistent with the principles of the present invention;

FIG. 43 is a flowchart diagram illustrating one example of a user's experience after logging-in to an Active Document Container that contains a reader's comments and proposed changes to the Document consistent with the principles of the present invention;

FIG. 44 is a flowchart diagram offering another illustration of a user's experience after logging-in to an Active Document Container that contains a reader's comments and proposed changes to the Document, requesting senior-user feedback on a reader's comments and approval of a reader's proposed changes to a Document consistent with the principles of the present invention;

FIG. 45 is a flowchart diagram illustrating one example of a user's experience accessing an Active Document Container via a web interface consistent with the principles of the present invention;

FIG. 46 is a flowchart diagram illustrating one example of using the system to collect public comments on a Document consistent with the principles of the present invention;

FIG. 47 is a flowchart diagram illustrating one example of relationships between internal data and external databases consistent with the principles of the present invention;

FIG. 48 is a flowchart diagram illustrating one example of the method of updating information in the system from external database sources consistent with the principles of the present invention; and

FIG. 49 is a flowchart diagram illustrating one example of the method of exchanging information in the system with other external software applications consistent with the principles of the present invention.

### DETAILED DESCRIPTION

Reference will now be made in detail to the features of the principles of the present invention, examples of which are illustrated in the accompanying drawings. Wherever possible, the same reference numbers will be used throughout the drawings to refer to the same or like parts.

The present invention relates generally to methods and systems for managing negotiated transactions and receiving, storing and retrieving comments and proposed changes to other forms of documents that are made at different times and that come from different sources. In systems consistent with the present invention, multiple users communicate through a networked environment to access an application located on a network. For exemplary purposes, the disclosure herein is directed to an application for generating and managing a transactional document. It should be understood, however, that the principles consistent with the present invention are applicable to a variety of applications and certain principles of the invention are not limited to the transactional document described herein. For example, principles consistent with the present invention may be applied to documents related to government procurement processes, rulemaking and legislative processes, peer review processes, etc. Alternatively, the application may reside on a stand-alone personal computer where the file may be updated based upon information received at the stand-alone personal computer, i.e., by direct input through I/O devices including keyboard, secondary storage device via floppy disk, etc.

For example, with regard to rulemaking and legislative processes, public comments may be received and stored electronically within the context of each clause of the proposed legislation and/or rule. This would increase the efficiency of the review and possible incorporation of the public's comments. This would further increase accountability for changes to proposed legislation and rules by creating a public record of the source of comments that resulted in changes to the rules and/or legislation.

For an additional example, with regard to peer review processes, in academic publishing, articles requiring peer review may be issued using features consistent with the present invention. Those participating in the peer review process may submit their comments and criticisms within the context of the particular portion or clause of an article.

Definitions

Master Matrices—refers to the matrices of Worksheets and Workbooks that contain the original text of documents.

Baseline Document—refers to the sub-set of Provisions/Clauses selected from the Master Matrices and assembled in a sequence that creates what would be commonly referred to as a “standard form” document. The selected Provisions/Clause are displayed in the Baseline Document but may not be accessed for purposes of changing the text of the Provision/Clause.

Baseline Document Container—refers to the Workbook that contains the Baseline Document and other Worksheets, including the Comments Worksheet, Business Rules, Law, and other Annotations Worksheets.

Active Document Container—refers to a copy of the Baseline Document Container with respect to the Workbook and Worksheets contained therein but is a separate file, i.e. an Excel file, that has a unique name or identification code (or both), and that is used as a starting point to obtain comments/proposed changes from others. This file may be accessed via a web interface or transferred to others via email, floppy disk, etc., opened and used by others on a stand-alone workstation.

Active Document—refers to the copy of the Baseline Document that is in an Active Document Container.

Comments Worksheet—refers to a Worksheet which functions as a register for each Provision/Clause in an Active Document to collect comments and proposed changes suggested by Active Document readers, and to associate and store those comments and proposed changes associated with the specific Provision/Clause to enable easy retrieval of all comments/changes suggested and made to any give Provision/Clause.

These and other terms are further defined elsewhere in this specification.

System Architecture

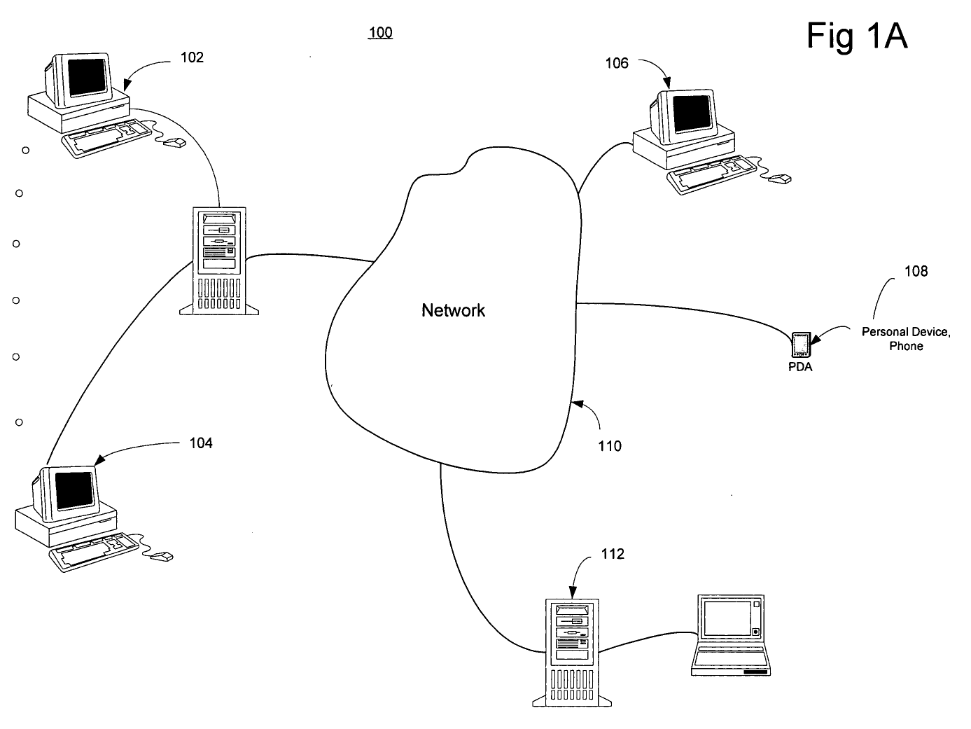

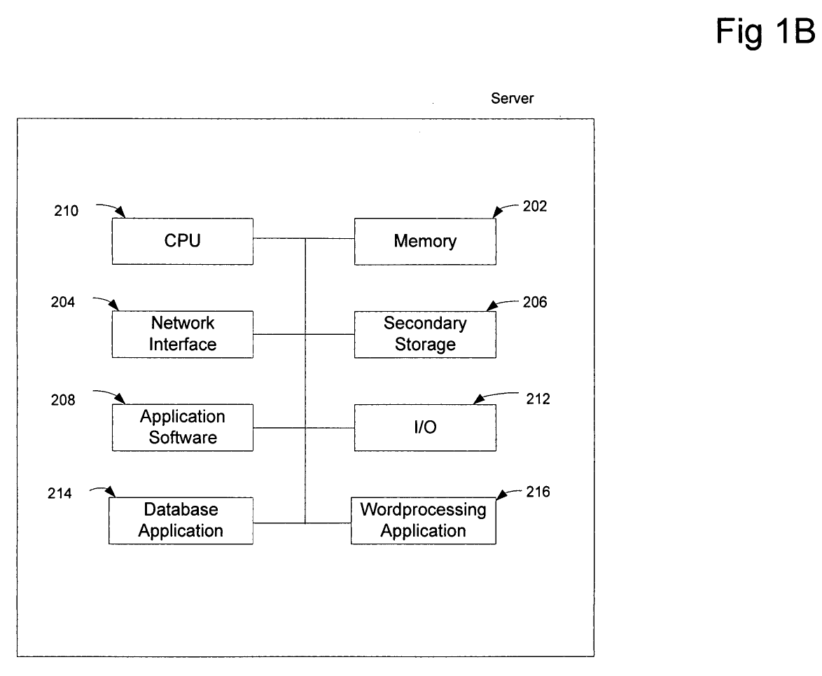

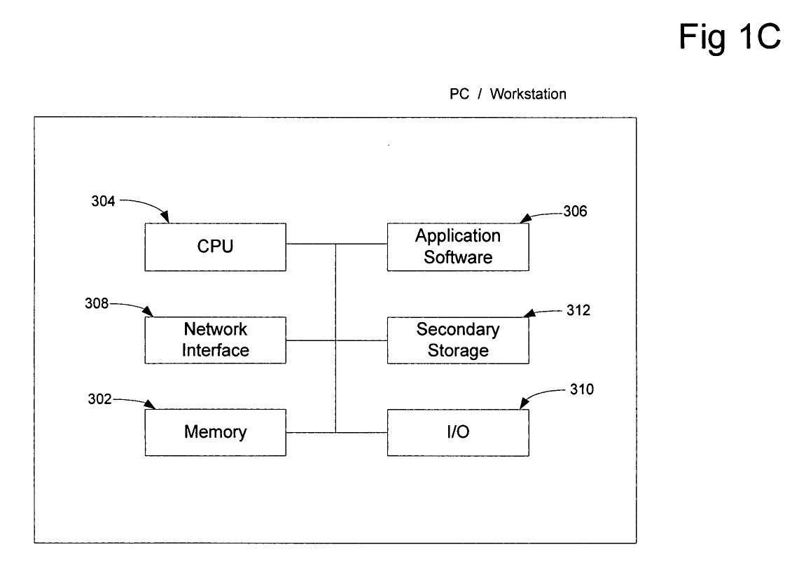

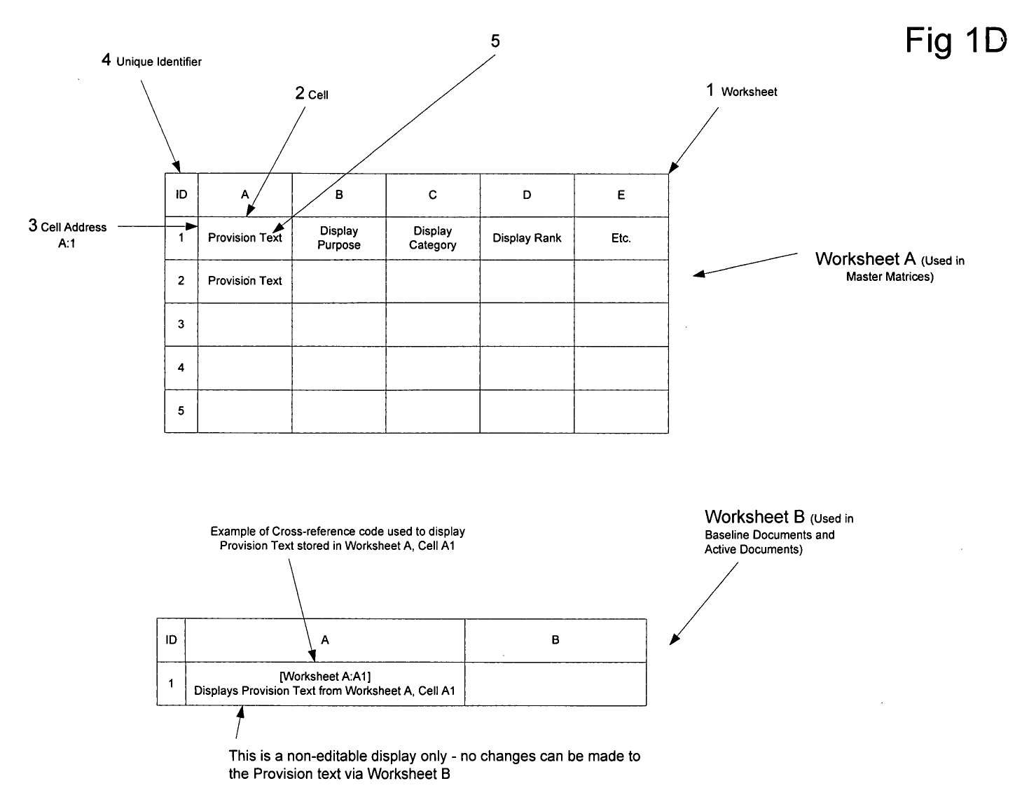

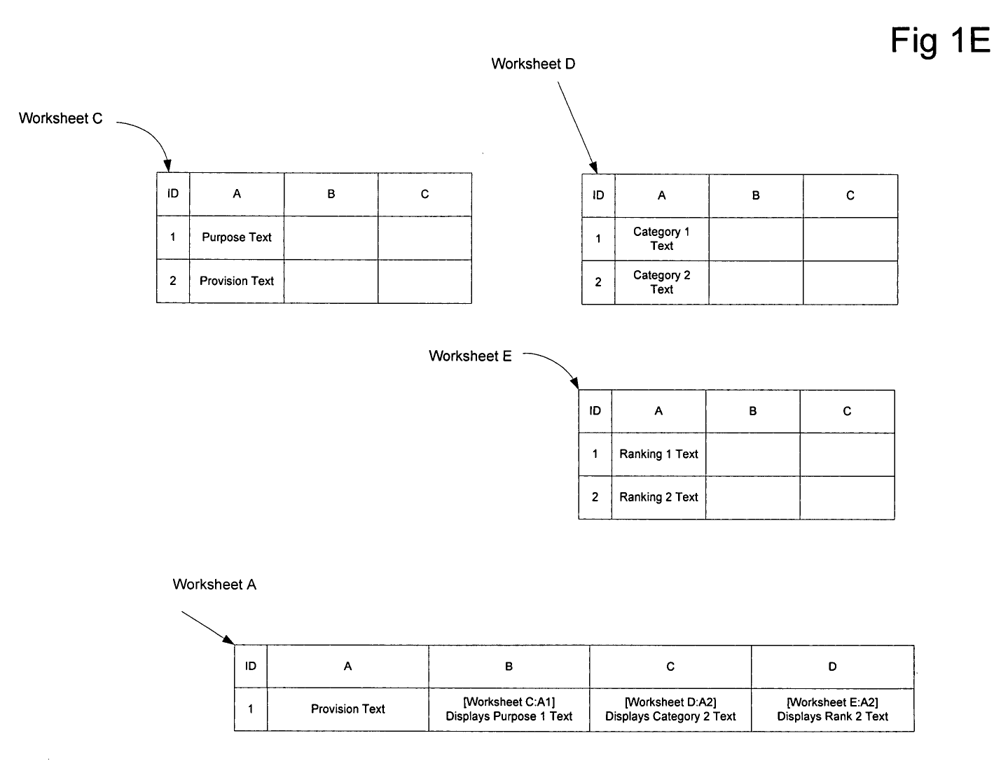

FIG. 1A is an exemplary diagram of a system environment 100 for implementing the principles of the present invention. The components of system 100 can be implemented through any suitable combinations of hardware, software, and/or firmware. As shown in FIG. 1, system 100 includes a plurality of client devices 102, 104, 106, and 108, communicating with server 112 via network 110. While only a few client devices are depicted in FIG. 1, it may be appreciated by one of ordinary skill in the art that more client devices may operate within the system environment. Network 110 may be implemented as the Internet. It may further be appreciated that network 110 may be implemented as any local or wide area network, either public or private. It may further be appreciated that there may be additional networks operating in environment 100 wherein additional client devices may interact with server 112. It may further be appreciated by one of ordinary skill in the art that one of the client devices may act as server 112.

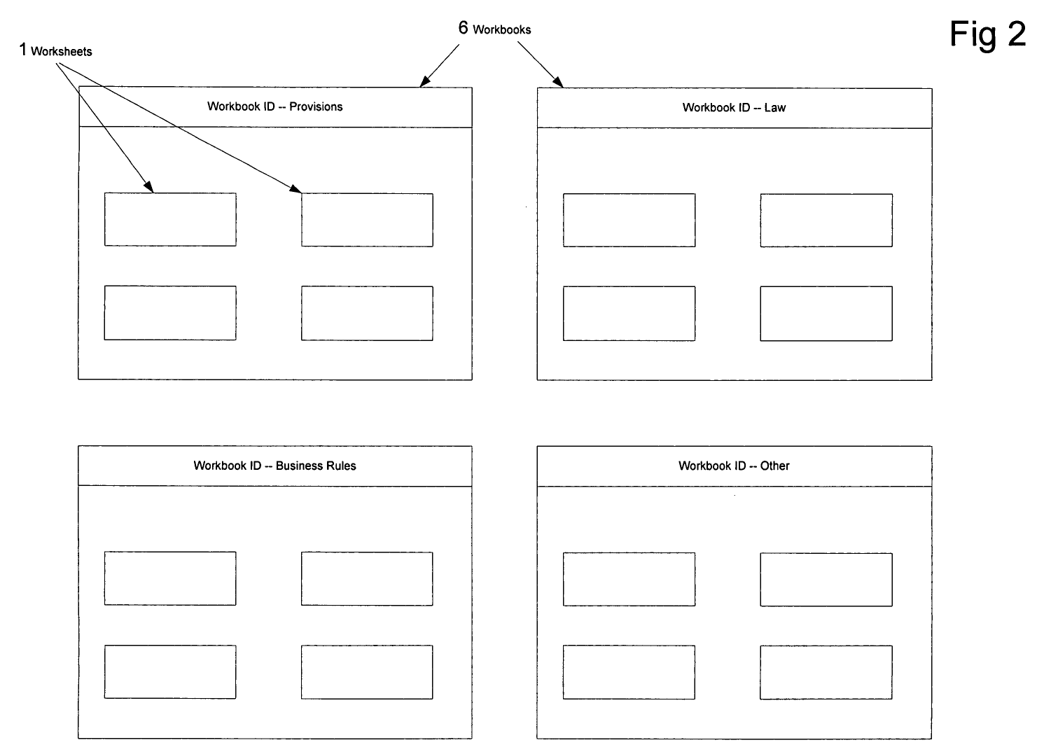

FIG. 1B depicts an exemplary block diagram of server computer 112 that may be implemented in system environment 100, consistent with the principles of the present invention. As shown in FIG. 2, server computer 112 includes memory 202, network interface application 204, secondary storage 206, application software 208, central processing unit (CPU) 210, input/output devices 212, database application 214 and word processing application 216. Input/output devices 212 may include, for example, a keyboard, a mouse, a video cam, a microphone and speakers, a display, a storage device, and/or a printer. Server computer 112 may be communicably linked with client devices to provide access to applications stored in application software 208. Application software 208 may operate with Microsoft's Excel® spreadsheet software. It may be appreciated that the application software may be implemented with other known spreadsheet applications.

FIG. 1C depicts an exemplary block diagram of client devices 102, 104, 106, and 108 that may be implemented in system environment 100, consistent with the principles of the present invention. While the description herein is directed to client device 102, it may be appreciated that the client devices 104, 106, and 108 may function similarly to client device 102. Client device 102 may be implemented as a workstation, a personal computer, or any personal handheld device that is capable of accessing server 112 on network 110, i.e., a Personal Digital Assistant (PDA), a cellular telephone, or any other device that is capable of operating on either network 110.

As shown in FIG. 1C, client device 102 may include, for example, memory 302, processor 304, software 306, network interface 308, input/output devices 310, and secondary storage 312. A user may, through network interface 308, access server 112 through network 110. Network interface 308 may be implemented as any conventional browser application to facilitate interaction with applications on server 112 on network 110. Input/output devices 310 may include, for example, a keypad, a video cam, a microphone and speakers, a display, and a storage device.

It may be appreciated by one of ordinary skill in the art that while the disclosure herein is directed to a client/server environment, principles consistent with the present invention may be implemented in a peer-to-peer environment or a stand-alone personal computer.

Master Clause Matrices

FIG. 1D illustrates a worksheet 1 (“Worksheet”) of cells 2 often found in spreadsheet programs. Each cell may be associated with or otherwise have a unique identifier 3 (“Cell Address”). Cell Addresses may be determined by the intersection coordinates of individually identified rows and columns, typical of a spreadsheet. Each Worksheet may be associated with a unique identifier 4. Each Cell may contain separate Clauses 5. FIG. 1D further illustrates an example of relating or cross-referencing a cell 2 in Worksheet A with a cell 2 in Worksheet B. The content of the source cell 2 in Worksheet A may be displayed in the target cell 2 in Worksheet B. However, the content may not be accessible via Worksheet B for purposes of making changes to the content. Also, if the content is changed in the source cell, the change will be reflected in the display via Worksheet B automatically. FIG. 1D further illustrates an example of how multiple Worksheets may be used to store different content and then display that content in another Worksheet. The advantage of this feature is the ability to enable the display of content in an environment that protects the content from unauthorized changes, yet allows an authorized change via the source cell to populate all other related target cells automatically.

Document text (“Provision” or “Clause”) may be indexed using Cell Address 3 information or other methods of identifying each Clause. For example, Clauses with similar purposes may be stored in one or more Worksheets. One example in the context of contract Documents, is a Worksheet 1 of indemnity Clauses where the first column in each row could be used to store a unique indemnity Clause with adjacent columns in the same row containing information related to the Clause such as its specific purpose, ranking of importance, or its relationship to specified sets of Clauses that form various Documents, its relationship to other Clauses, or business rules, explanations, annotations, or other information that may be contained in Cells in the same or in other Worksheets.

FIG. 2 illustrates how further indexing may be accomplished by combining Worksheets 1 into a unique set comprising a workbook (“Workbook”) 6. Again, within the context of contract Documents, a separate Worksheet 1 could be used to store indemnity Clauses for different types of transactions. For example, a Worksheet 1 of indemnity Clauses typically used in publishing contracts and a Worksheet 1 of indemnity Clauses typically used in construction contracts, as well as other Worksheets 1 of indemnity Clauses, could be combined into one Workbook 6 of indemnity Clauses. Separate Worksheets 1 could also be used to store Clauses used in different types of transactions within the same industry. For example, separate Worksheets 1 could be designated to store similar but distinct grant of rights Clauses from similar but distinct publishing transactions such as those between an author and publisher for a trade book, college textbook, and an elementary and high school textbook, could be stored in separate Worksheets and combined into a single Workbook 6.

Baseline Document Containers

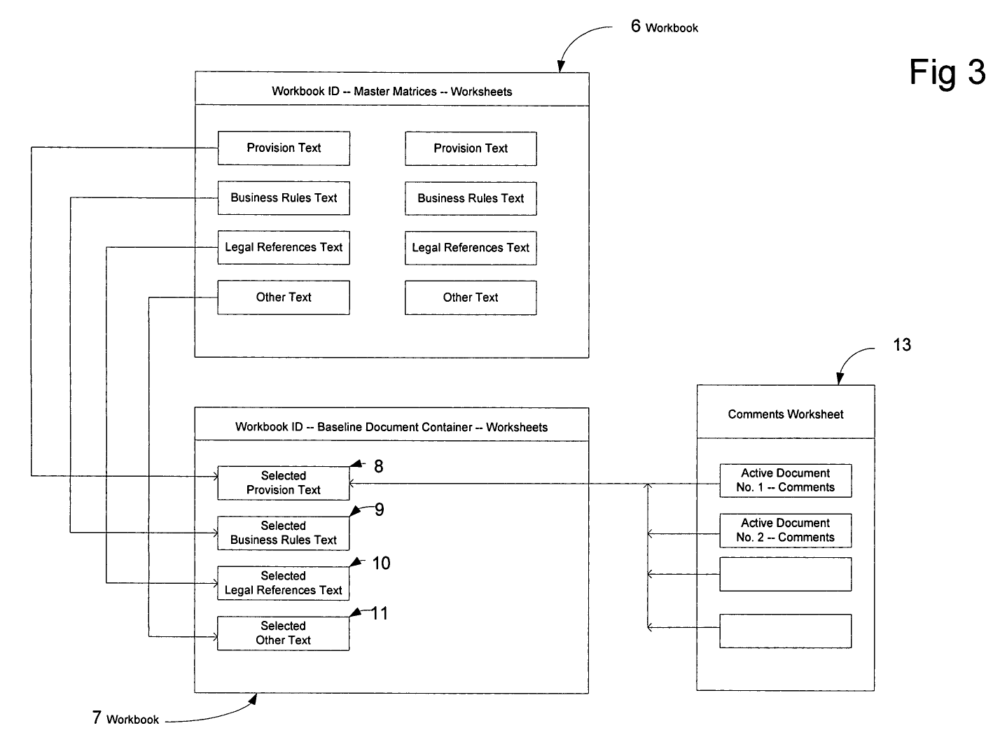

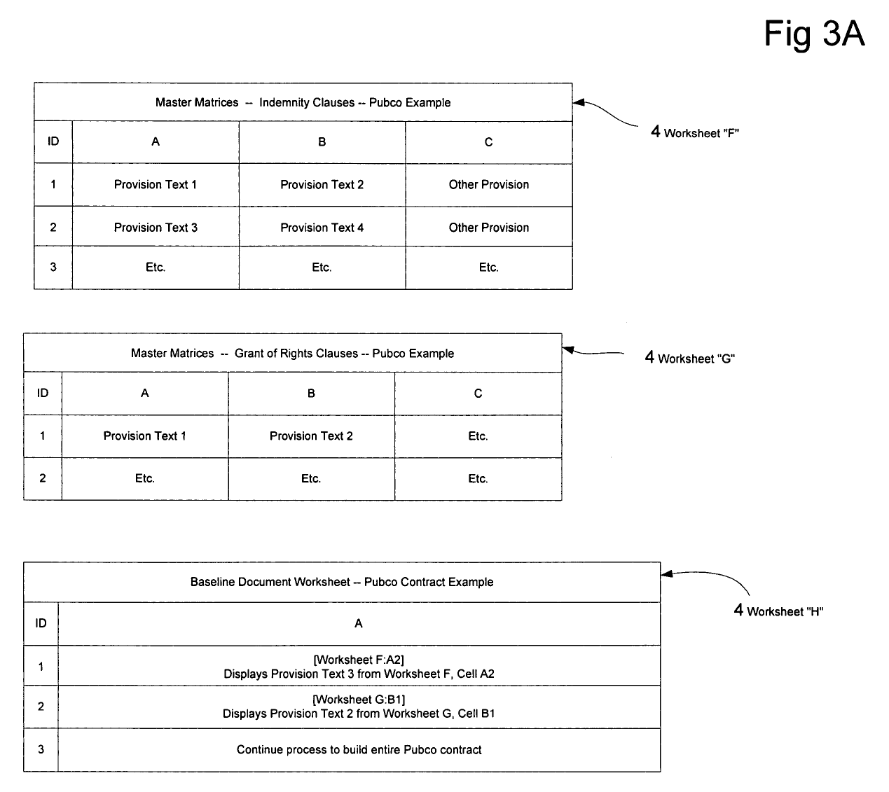

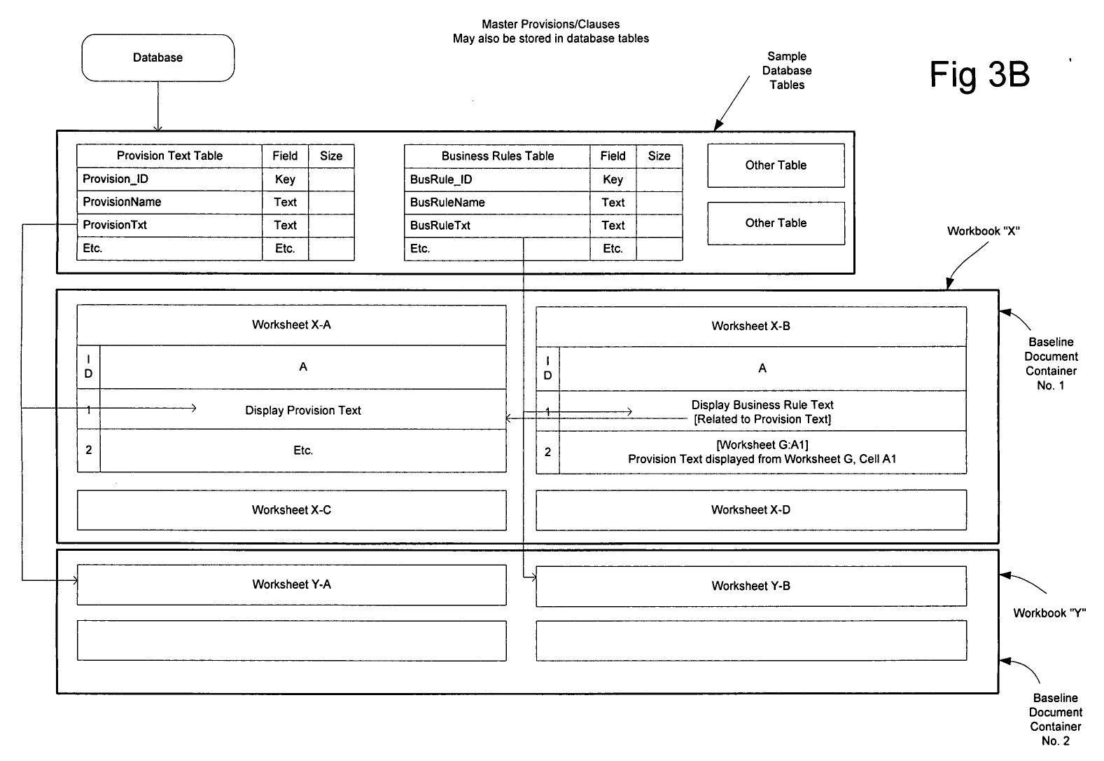

FIG. 3 illustrates how Workbooks containing master Clauses (“Master Matrices”) 6 may be related to additional Workbooks 7 that may be stored as separate files, each of which may be identified with its own unique file name, for the purpose of displaying a subset of Clauses that comprise a Document (“Baseline Document”) 8, and for storing and displaying other related information in other Worksheets within the same Workbook (each such Workbook a “Baseline Document Container”). Another of the Worksheets in the Baseline Document Container 7 may be used to display selected business rules 9, another to display selected law 10, and others 11 to store and display additional information related to the Clauses in the Baseline Document 8 (“Annotations”). The Annotations may be linked to each Cell Address 3 in the Baseline Document 8 to enable an authorized Baseline Document 8 reader to access the Annotations for further information about a particular Clause. Access to Annotations may be restricted to one document reader using a form of security such as a combination of user identification code and password or other form of encryption.

For example, a Baseline Document Container 7 may include a Worksheet 1 that displays a sub-set of Clauses comprising a Baseline Document 8 appropriate for trade book publishing transactions. In the same Baseline Document Container 7, separate Worksheets may each display business rules 9, applicable law 10, or other information 11 such as legal advice, each of which are relevant to the purpose of a particular Clause within the context of the Baseline Document 8. Each Annotation may be stored in separate Worksheets 1 with a separate Cell Address 3 so that the Annotation is context sensitive and relates to a particular Clause in the Baseline Document 8. Access to the Annotations may also be controlled to allow only one reader or multiple authorized readers to view the Annotations.

The Clauses and Annotations displayed in Cells 2 in the Baseline Document Container 7 may be based on links, pointers or other forms of reference to the master Clauses in the Master Matrices 6. Using this method, the actual content of any Clause would only need to be entered in the Master Matrices 6. The Clause would be displayed in the Baseline Document 8 without enabling readers to change the Clause or Annotations when viewing them via the Baseline Document Container 7 interface. Thus, the Baseline Document 8 becomes a non-editable “standard form” Document. This provides greater control over the original Baseline Document 8 and any Clauses contained therein.

FIG. 3A illustrates another example of how Provisions may be stored in Worksheets and related to other Worksheets that may be stored in separate Workbooks. Worksheet F and Worksheet G illustrate an example of storing Provision text in each Cell. The advantage of this approach is that the entire Worksheet is dedicated to storing Provision text, as opposed to Provision text and other information related to a particular Provision within the same Row. Each Cell Address functions as the method of locating and identifying and associating the Provision text within the Cell and cross-referencing or linking it to the associated Business Rule and other Annotations related to the specific Provision. The Baseline Document may be assembled in a separate Worksheet illustrated by Worksheet H that may be part of a Baseline Document Container Workbook. Associated Business Rules, Law and other Annotations may also be assembled in the same Baseline Document Container Workbook.

FIG. 3B illustrates another example of how Provisions may be stored in database tables and related to Worksheets that may be stored in separate Workbooks. The Database Tables illustrate examples of Provision Tables and Business Rules Tables that may be used to store and index the Provisions and Business Rules. Other tables may be used to store Law and other Annotations. Workbook X contains Worksheet XA, Worksheet XB, and other Worksheets. Cell A1 in Worksheet XA is related to a Provision stored in the Provision Table so that the Provision is displayed in Workbook X, Worksheet XA, Cell A1. The same process may also be used for Business Rules, Law and other Annotations as illustrated in Worksheet XB. Also, the Business Rule displayed in Worksheet XB, Cell A1, would be related to the Provision text displayed in Worksheet XA, Cell A1 because they are in the same Baseline Document Container, Workbook X. The advantage of this approach is that the database tables would store the master Provisions that could be easily retrieved and managed. Also, the database could store additional information about the Cells, Worksheets, and Workbooks, relationships or links between and among the same, users, and other related information.

Active Document Container

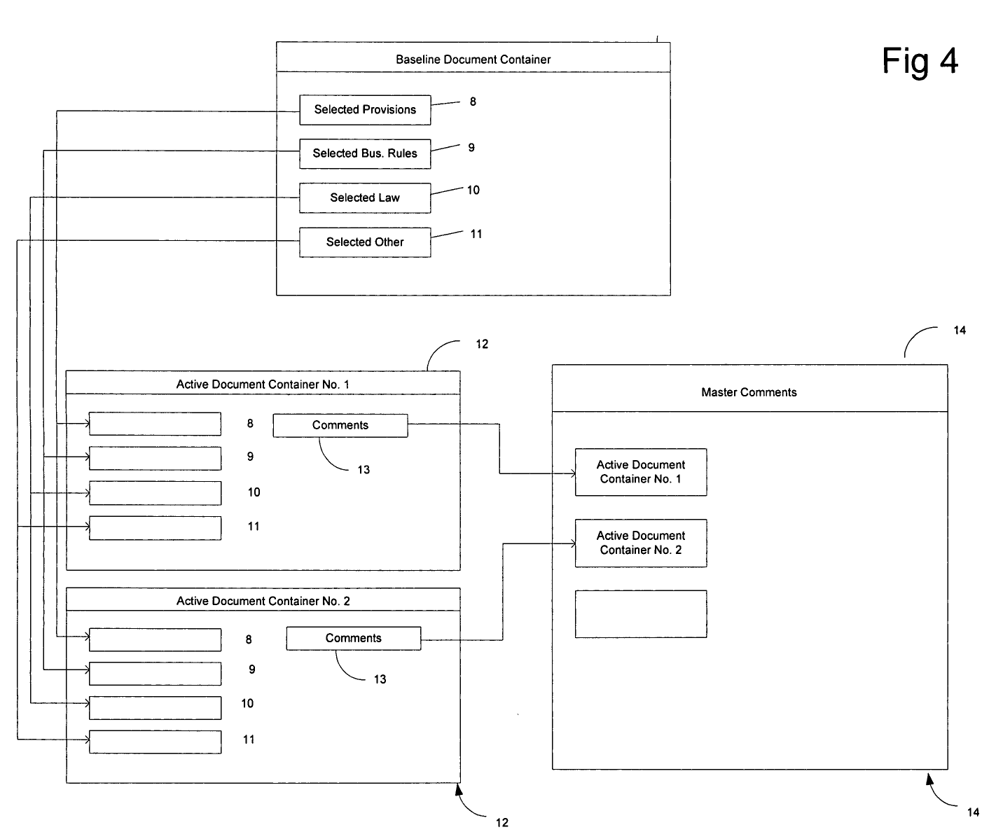

FIG. 4 illustrates how copies of the Baseline Document Containers 7 may be made and stored as separate Workbook 6 files that comprise Active Document Containers 12, each of which may be identified with its own unique file name, for the purpose of publishing the Baseline Document for comments or other feedback on the Clauses contained in the Baseline Document (each such Workbook an “Active Document Container”) 12.

Each Active Document Container 12 may be linked back to its originating Baseline Document Container 7 in the same manner that the Baseline Document Container 7 is linked back to the Master Matrices 6.

Each Active Document Container 12 may function in the same manner as the Baseline Document Container 7 with respect to the plurality of Worksheets 1 contained in the Active Document Container 12.

Comment Worksheet Features

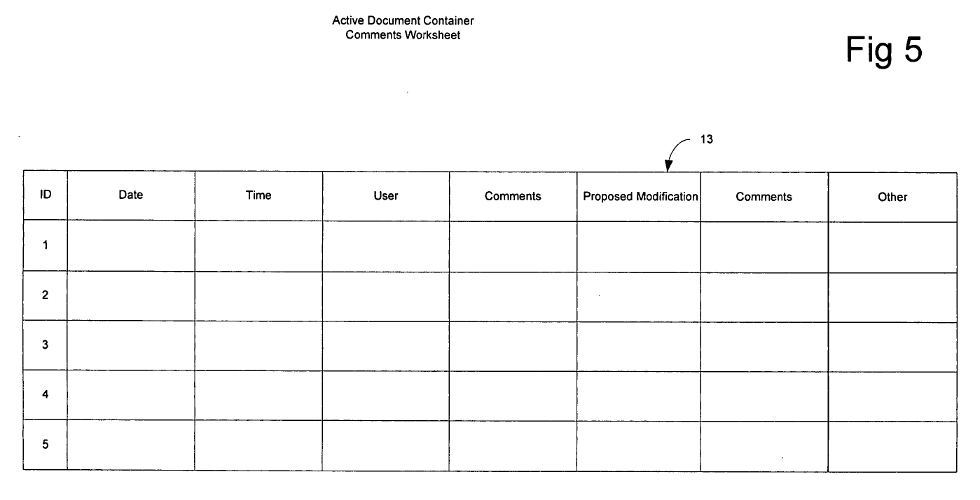

FIGS. 4 and 5 also reveal that the Active Document Container 12 may also include a Worksheet 1 that collects and stores comments related to each displayed Clause (“ADC Comments Worksheet”) 13, or link to an external master Worksheet 1 that compiles comments via all Active Document Containers (“Master Comments Worksheet”) 14 to accomplish the same purpose, or both. The ADC Comments Worksheet 13 and the Master Comments Worksheet 14 may contain virtually the same features (both hereinafter referred to as the “Comments Worksheet”), and may be accessible by one or more authorized readers while the Clause is being viewed in the context of the Document display by activating a command button or selecting the Cell 2 containing the displayed Clause, or by using some other selection device. The Comments Worksheet would then display the activated Clause, and, in the same display, adjacent to the Clause, the Comments Worksheet may display a plurality of rows and columns to collect information from the reader. For example, below the activated Clause, each row may represent a comment line with multiple columns creating Cells 2 for the date, time, reader identification code, reader's comments, and any proposed changes to the language of the activated Clause.

System Overview

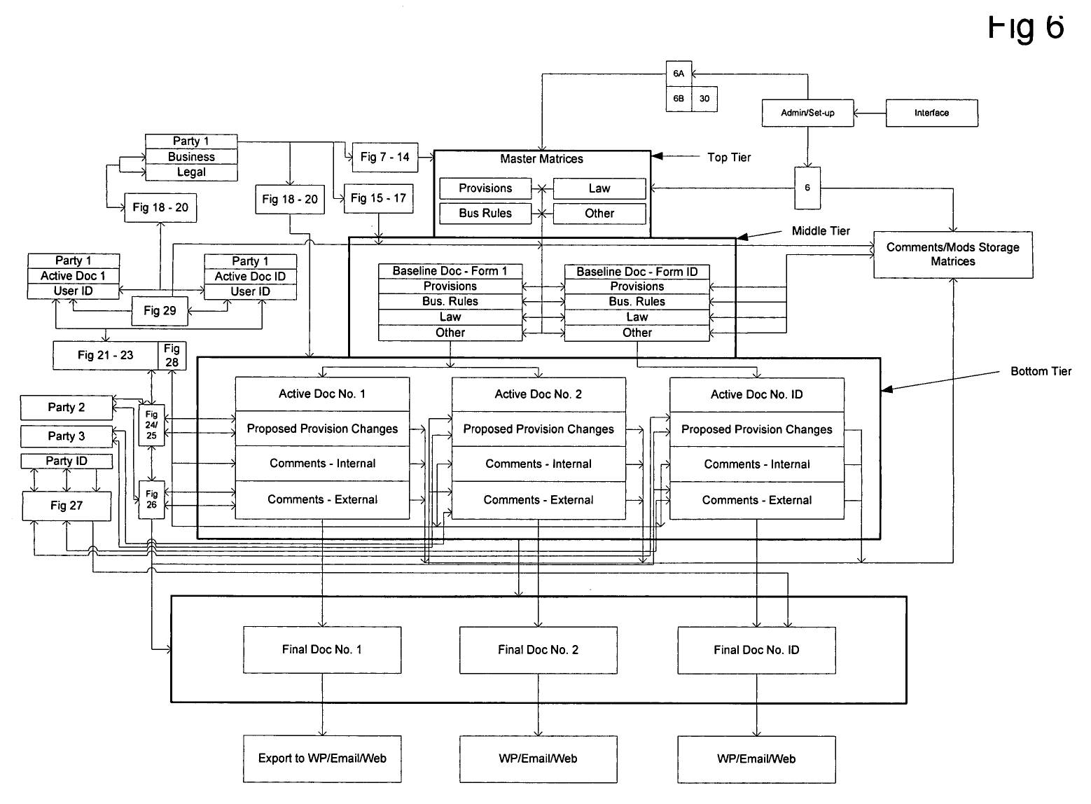

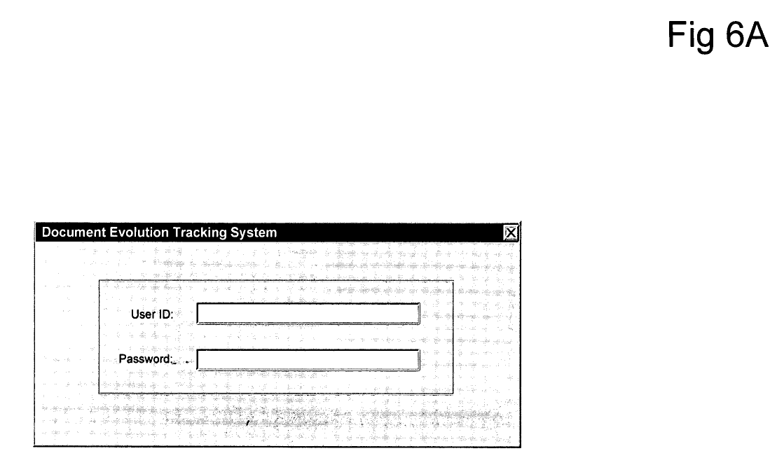

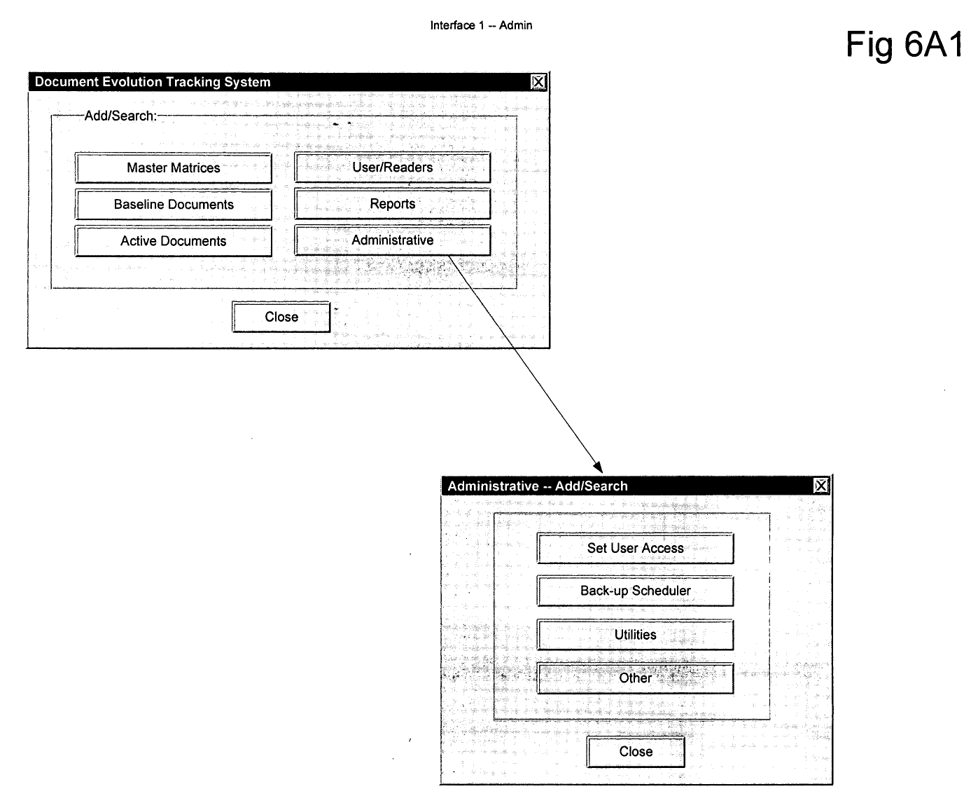

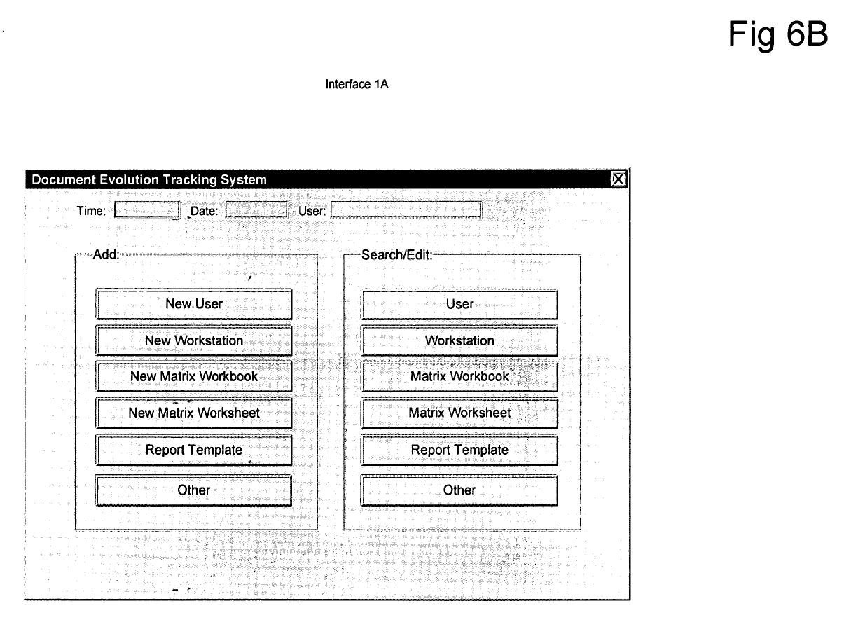

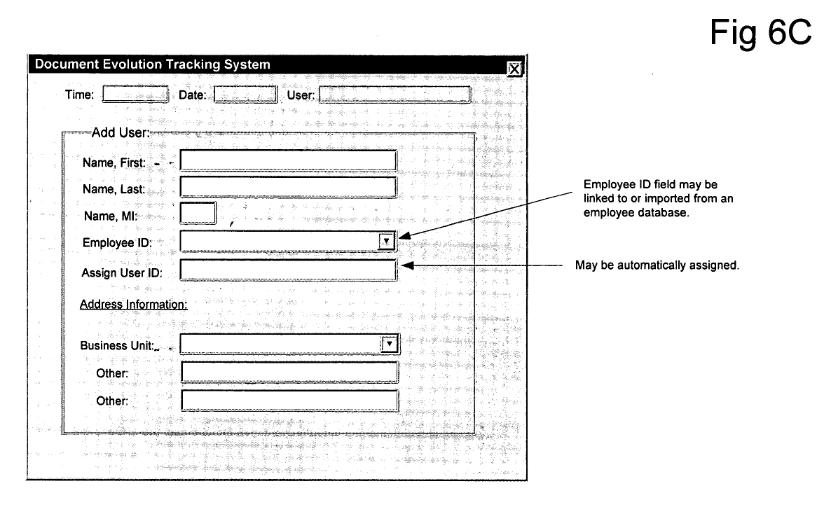

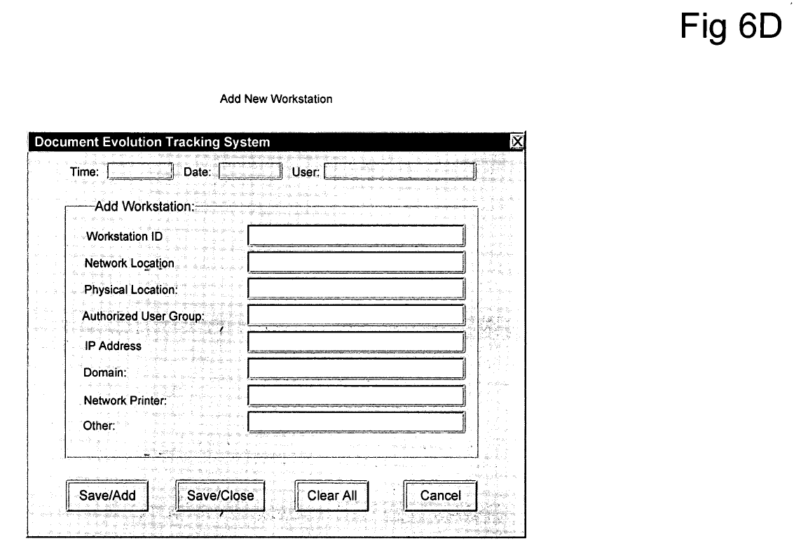

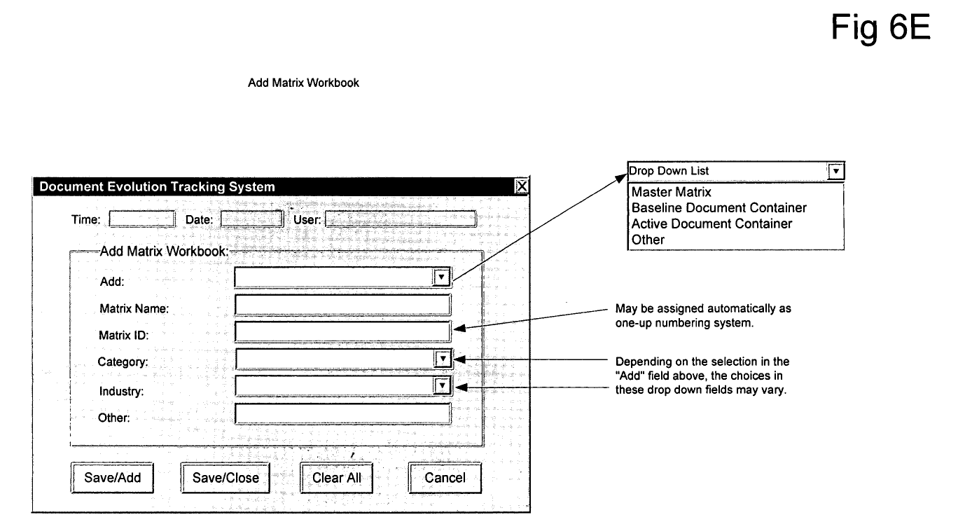

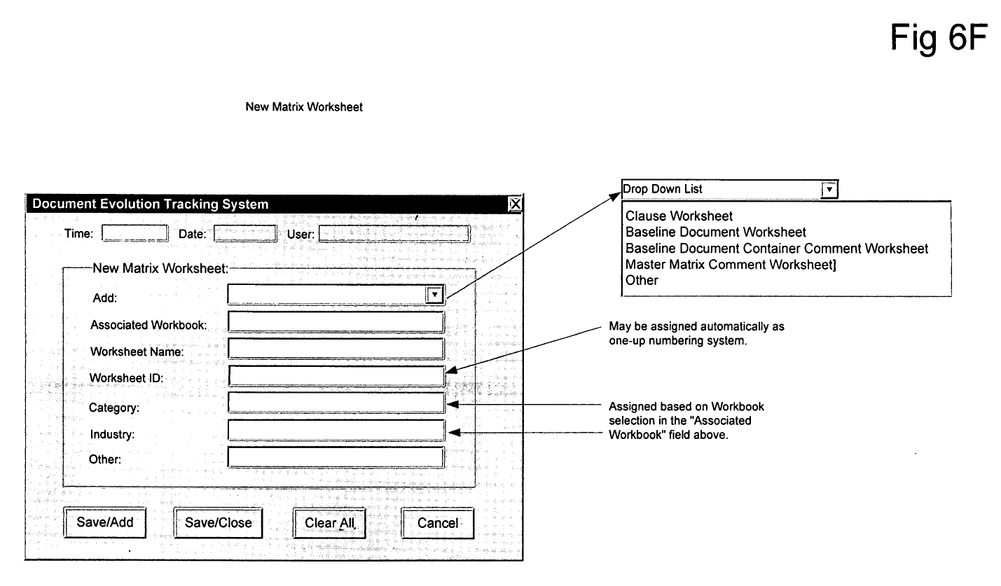

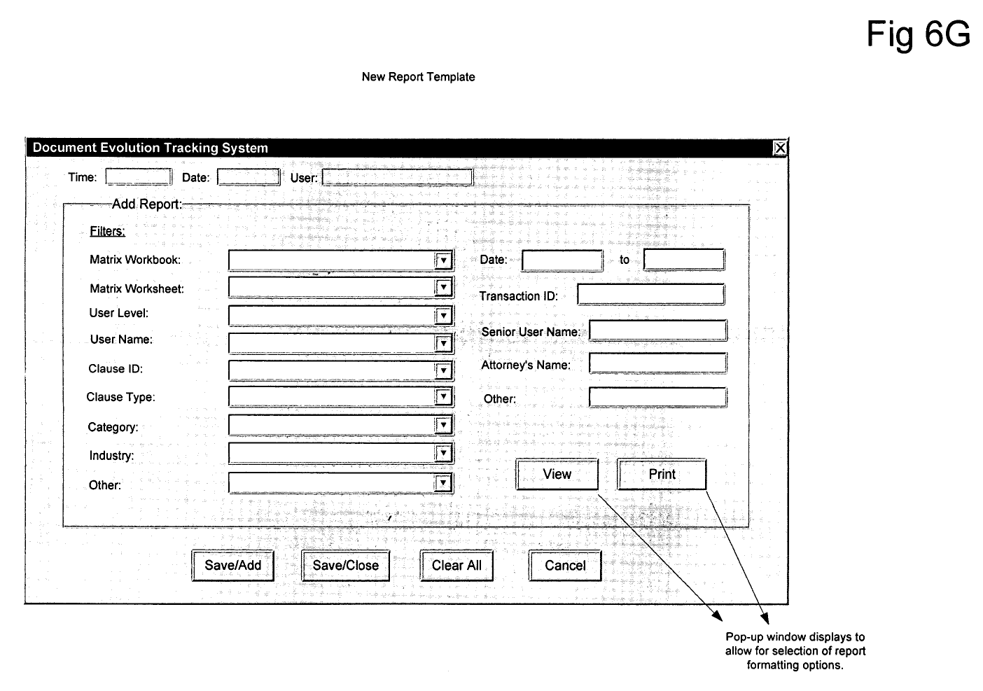

FIG. 6 reveals relationships between and among the Master Matrices, Baseline Documents, Active Document Containers, and readers, and includes data flow and user and reader interface points. The Master Matrices grouping in the top center tier reveals the Workbooks of Clauses or “Provisions” as referenced in FIG. 6, Business Rules, Law, and Other information or Annotations; there relationships with the Baseline Documents, and in turn, their relationships with the Active Document Containers. The Baseline Documents group is in the next tier down, and the Active Document Containers are in the bottom tier. The “Baseline Document—Form 1” and “Baseline Document—Form ID” reveal that the system will accommodate multiple Baseline Documents, with the Baseline Document—Form ID representing any number of subsequent Baseline Documents that will each have a unique identification number, and that each will be derived from the Workbooks in the Master Matrices group. The “Active Doc No 1,” “Active Doc No 2,” and “Active Doc No ID” represent separate Active Document Containers and also reveal that the system will accommodate multiple Active Document Containers that will each be derived from the Baseline Documents, and that each will have a unique identification number.

The Active Document Containers will be the equivalent of a copy of the Baseline Document—Form ID, and, in addition, will include Comment Worksheets for the purpose of allowing readers to add comments and proposed changes to Document Clauses on a Clause-by-Clause basis. The “Comments-Internal” and “Comments-External” reveals that the system may accommodate keeping certain comments confidential. For example, in a contract Document context, a large business entity negotiating a transaction may want to keep certain comments between its personnel from being revealed to the other party to the transaction. The “Comments-Internal” label represents these comments. While the “Comments-External” label represents the comments that the business entity receives from the other party as well as the business entity's reply comments.

All of the Internal-Comments and External-Comments may be stored within the Active Document Container, and they in turn may be passed on to an independent storage Workbook that could store all comments and proposed changes.

Also, in FIG. 6 the “Party 1” label represents a reader who is an “internal” system user. Again, for example, in the contract Document context, Party 1 could represent a primary or frontline negotiator for a large business entity. In this context, there may be multiple primary negotiators in a “Contracts Department” or in a “Sales Department” and thus there are two depictions of “Party 1,” one with “Act. Doc 1” and the other with “Act. Doc ID” revealing that the system may accommodate multiple Active Document Containers being used by multiple users at the same time. These may be peer-to-peer users. There is also a senior-level “Party 1” which is represented by the depiction that includes “Business” and “Legal” labels. The comments and proposed changes shared among the various Party 1 users may be kept confidential, and would not be automatically accessible to other parties. “Party 2” and “Party 3” are examples of readers who do not have full access to the system. They can only add their own comments and view the non-confidential reply comments from the Party 1.

The “Final Doc No 1,” “Final Doc No 2,” and “Final Doc ID” labels represent the final form of the Documents that are generated upon completion of the Document preparation process. These labels reveal that the system may accommodate multiple Final Documents (Final Doc) from both the same Baseline Documents via multiple Active Document Containers. The “Export to WP/Email/Web” label (and other “WP/Email/Web” labels) reveals that the system may accommodate delivering the Final Doc to another Party using various options. WP is the abbreviation for word processor and indicates that the Final Doc may be printed from a word processor and delivered on paper. Another option is to email the word processor file to another party. Another option is to enable access to the Final Doc via a web page, display it on a web page, or allow FTP or other downloading of an electronic version of the Final Doc.

The line drawings in FIG. 6 reveal one example of the data flow. The small boxes identified by other Figure references are examples of user interface points, and examples of these interfaces are further illustrated in the referenced Figures.

User Interfaces

FIG. 6A illustrates an example of a login screen with fields for a user identification code and password to allow access. FIG. 6A1 illustrates an example of an initial screen which may display multiple command buttons or other navigational devices to allow the authorized user/reader to add and/or search new Master Matrices, Baseline Documents, Active Documents, User/Readers, and Reports. This example screen also displays an example of a pop-up window that authorized user/readers may activate using the Administrative command button.

FIG. 6B illustrates further examples of command buttons for certain administrative functions such as adding a new user, workstation, Workbook or Worksheet within the Master Matrices group, examples of command buttons to enable searching and editing of the same, and command buttons for creating and editing of report templates that relate to the Master Matrices. The “Other” command buttons are included to indicate that other similar administrative functions can be added here.

FIG. 6C illustrates an example of a screen with fields for adding a new user that may display multiple command buttons or other navigational devices to allow the authorized user to add new user identification information.

FIG. 6D—illustrates an example of a screen with fields for adding a new workstation that may display multiple command buttons or other navigational devices to allow the authorized user to add workstation information.

FIG. 6E—illustrates an example of a screen with fields for adding a new Matrix Workbook that may display multiple command buttons or other navigational devices to allow the authorized user to add new Matrix Workbook identification information.

FIG. 6F—illustrates an example of a screen with fields for adding a new Matrix Worksheet that may display multiple command buttons or other navigational devices to allow the authorized user to add new Matrix Worksheet identification information.

FIG. 6G—illustrates an example of a screen with fields for adding a new Report Template that may display multiple command buttons or other navigational devices to allow the authorized user to add new Report Template identification information.

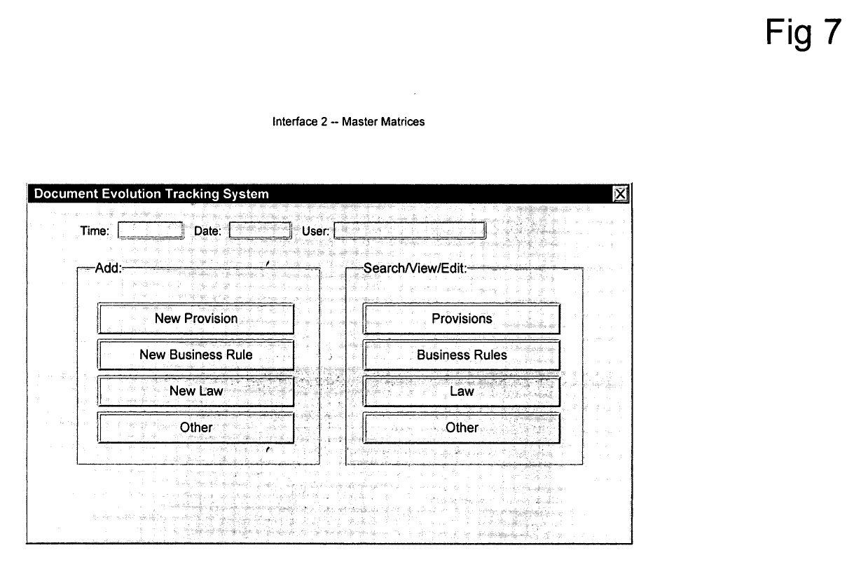

FIG. 7 illustrates an example of a user interface screen to access the Master Matrices. Fields representing the time and date of access, and the user's identification code, are shown, and there is no significance to the location within the screen display. Alternatively, these may be hidden fields. Their purpose is to track a user's use of this function by recording the date, time and user identification code and associate the same with any functions performed via this interface for audit purposes. These fields may be associated with all user interfaces for this same purpose.

The ADD command buttons show “New Provision,” “New Bus. Rule,” “New Law” and “Other.” Each command button allows the user to add new text to each respective category, which may be saved in a Master Matrices Worksheet within a Master Matrices Workbook.

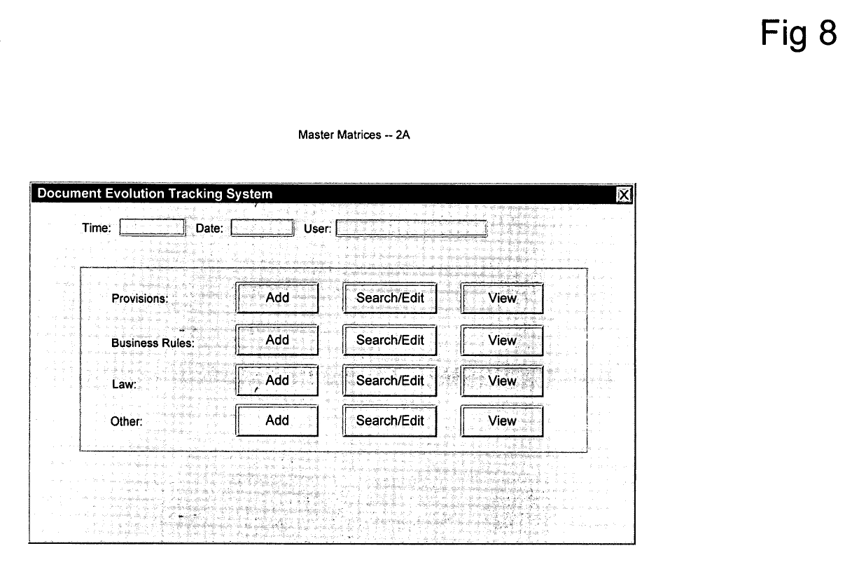

FIG. 8 illustrates another example of this same interface screen.

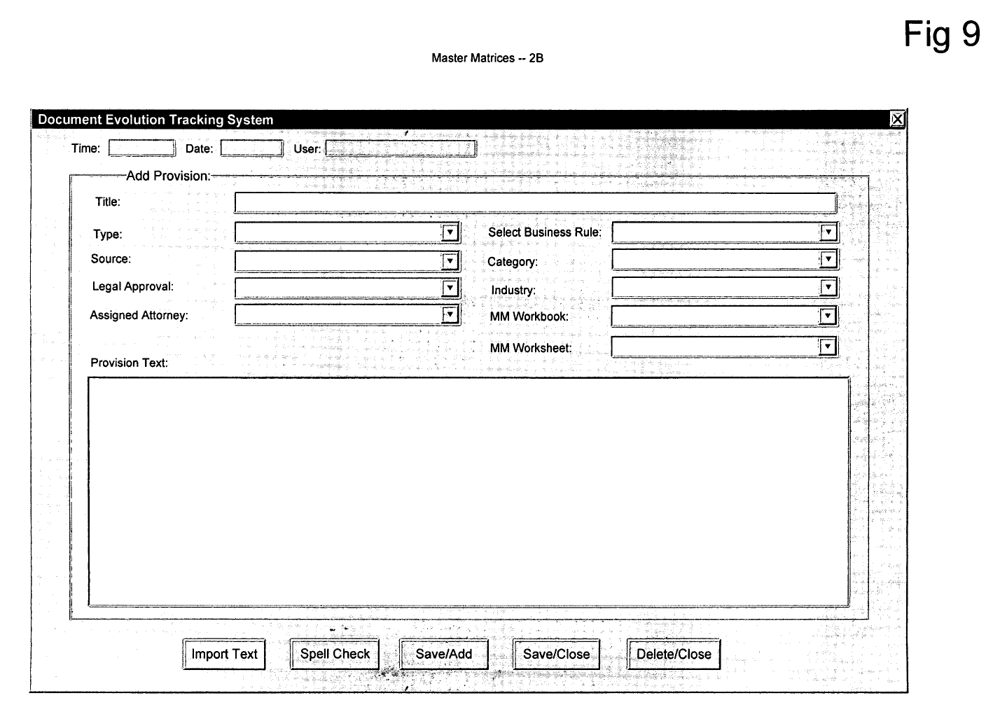

FIG. 9 illustrates an example of an interface screen used to ADD a Provision or Clause to a Master Matrix Worksheet. The Time, Date, and User ID fields are again for audit purposes. The Title field allows the user to include a text description of the Provision or Clause being added. For example, “Indemnity” or “Insurance” or “Choice of Law” labels. The Type field may be a “drop-down” list field with the option of adding a new item to the list on the fly. This field is a secondary identifier for the type of Clause to be added. The Source field allows the user to identify the source of the Clause being added. For example, if the user is copying the Clause from a pre-existing standard form document, then this field will allow the user to track that information and associate it with the Clause. This feature will allow the user to then select all Clauses from the same source and thereby automatically reassemble the source document as a Baseline Document within the system. The Cat field and the Industry field allow the user to include additional cross-references to permit further indexing of the Clause. The Select Business Rule field allows the user to associate a Business Rule with the Clause at the time the Clause is being added to the system. The Legal Approval field allows the user to flag whether an authorized attorney has reviewed the Clause for inclusion within the system as indexed. The default value may be set to NO, and this feature may be used to prevent use of the Clause being added until the Clause has been reviewed and approved by an authorized attorney.

The Attorney Assigned field allows the user to assign the Clause to an authorized attorney for review. By making this assignment, an automatic request in the form of an email or other form of communication, may be sent to the assigned attorney notifying him or her that the Clause needs legal review. The Attorney Assigned field may also be associated with the Type field so that a predetermined authorized attorney would be selected based on the Type of Clause being added. For example, if the Type field equals “Indemnity” then the Attorney Assigned field equals attorney X. This could also merely narrow the scope of options of authorized attorneys available in the drop-down list to those attorneys who specialize in the Type of Clause being added to the system.

The MM Worksheet and MM Workbook fields allow the user to identify the Worksheet in the Master Matrices group where the Clause will be stored. If the Worksheet exists then the MM Workbook field may be automatically filled-in with the associated Workbook. New Worksheets may be added and associated with a Workbook in the Master Matrices group from this screen on the fly via a pop-up window that reveals the ADD Worksheet and ADD Workbook screens.

The Provision Text field is a text field that allows the user to enter the text of the Clause being added. The Import Text command button allows the user to search for existing text in another file, copy it and paste it into the Provision Text field. The Spell Check command button allows the user to check the spelling of the text in the Provision Text field. The Save/Add command button allows the user to save the Clause in the Provision Text field and all other associated information, and then screen would refresh and allow the user to begin adding another Clause in the same manner. The Save/Close command button allows the user to save the newly added Clause and all other associated information and to close this screen. The Delete/Close command button allows the user to clear all fields and close the screen without saving any new information.

Any combination of one or more fields may be identified within the system as fields that require information before the system will save any new Clause information. For example, if a user forgets to complete the Type field, the system may flag this omission, and display a pop-up reminder screen before saving a new Clause.

FIG. 10 illustrates an example of an interface screen that allows the user to search, view and edit Clauses that are in the system. The Time, Date and User fields serve the same purpose as previously described. The user may search by the Title, Type, Source, Cat, Industry and User name (user who added the Clause) fields. The user may also use the Key Word field. The system may be configured to enable the Key Word function to search the Provision Text field only or any combination of the Clause fields. The Date Restrictions fields allow the user to limit the field of search by the date the Clause was added to the system. The Search command button activates the search.

The search results may be displayed within the same screen as illustrated in FIG. 10 or in a pop-up or new screen display. As currently illustrated, one example of displaying the search results is to split the screen and display in a list of a single row entries information that may include the Clause title, type, category, industry, source, and user. When the focus is on any given row, the “Display Provision Text” field would display the text of the related Clause. Double-clicking any given row or other navigational option will allow the user to open and activate the Clause screen thereby enabling the user to make changes to the Clause text and any data in the other related data fields.

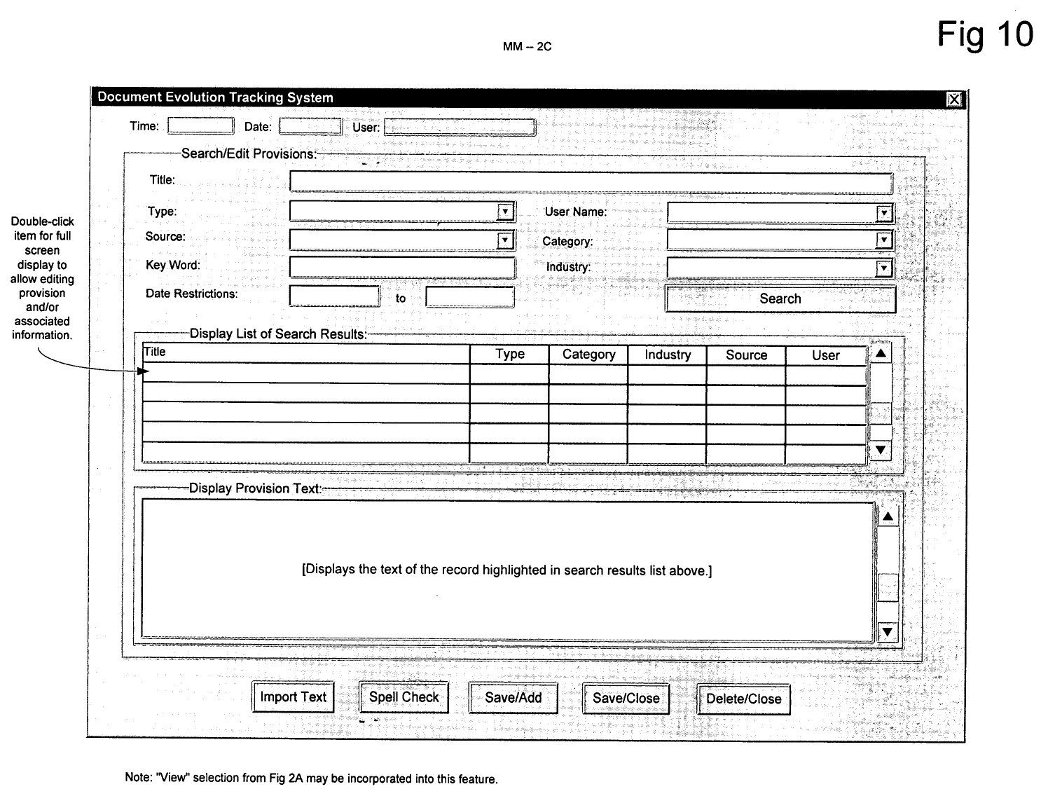

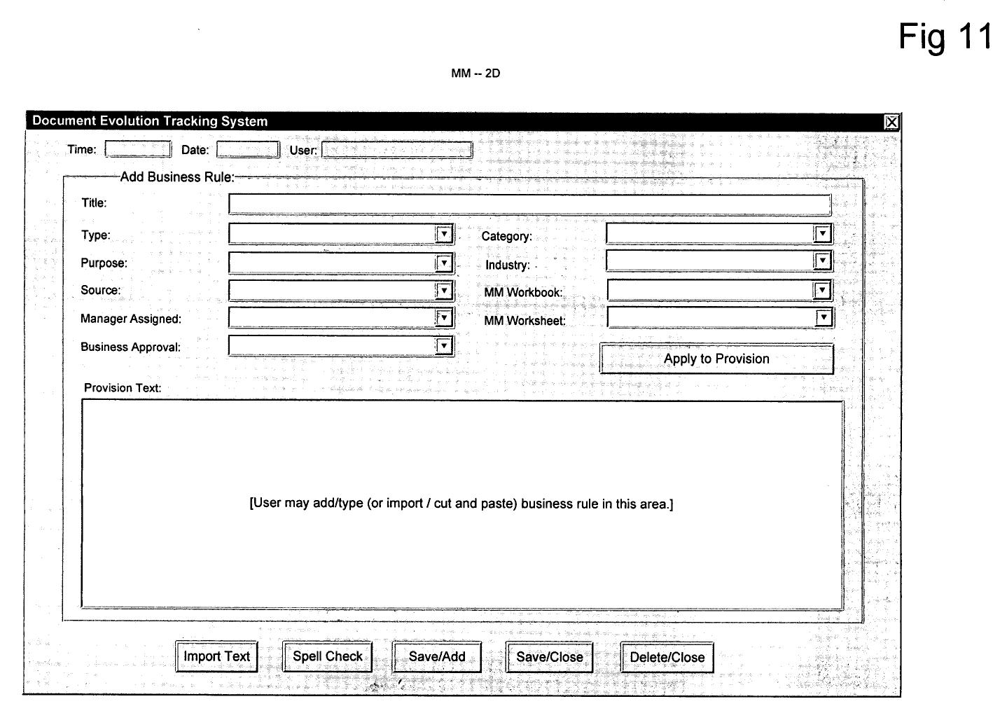

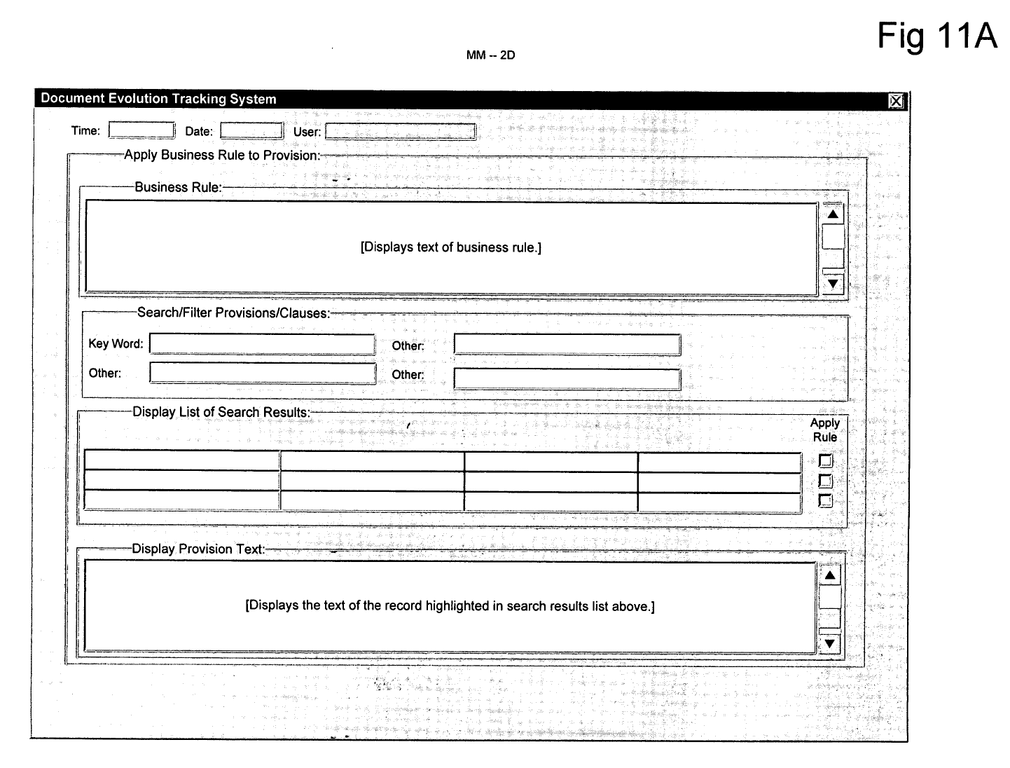

FIG. 11 illustrates an example of an interface screen used to ADD a Business Rule to a Master Matrix Worksheet. The Time, Date, and User ID fields are again for audit purposes. The Title field allows the user to include a text description of the Business Rule being added. For example, “Indemnity” or “Insurance” or “Choice of Law” labels. The Type field may be a “drop-down” list field with the option of adding a new item to the list on the fly. This field is a secondary identifier for the type of Business Rule to be added. The Source field allows the user to identify the source of the Business Rule being added. For example, if the user is copying the Business Rule from a pre-existing policy document, then this field will allow the user to track that information and associate it with the Business Rule. This feature will allow the user to then select all Business Rules from the same source and thereby automatically reassemble the source document as a reference document within the system. The Cat field and the Industry field allow the user to include additional cross-references to permit further indexing of the Business Rule. The Bus. App. field allows the user to flag whether an authorized manager has formally approved the Business Rule for inclusion within the system as indexed. The default value may be set to NO, and this feature may be used to prevent use of the Business Rule being added until the Business Rule has been reviewed and approved by an authorized manager.

The Assigned Manager field allows the user to assign the Business Rule to an authorized attorney for review. By making this assignment, an automatic request in the form of an email or other form of communication, may be sent to the assigned manager notifying him or her that the Business Rule needs business manager review. The Assigned Manager field may also be associated with the Type field so that a predetermined business manager would be selected based on the Type of Business Rule being added. For example, if the Type field equals “Indemnity” then the Assigned Manager field equals manager X. This could also merely narrow the scope of options of authorized managers available in the drop-down list to those managers who specialize in the Type of Business Rule being added to the system.

The MM Worksheet and MM Workbook fields allow the user to identify the Worksheet in the Master Matrices group where the Business Rule will be stored. If the Worksheet exists then the MM Workbook field may be automatically filled-in with the associated Workbook. New Worksheets may be added and associated with a Workbook in the Master Matrices group from this screen on the fly via a pop-up window that reveals the ADD Worksheet and ADD Workbook screens.

The Business Rule Text field is a text field that allows the user to enter the text of the Business Rule being added. The Import Text command button allows the user to search for existing text in another file, copy it and paste it into the Business Rule Text field. The Spell Check command button allows the user to check the spelling of the text in the Business Rule Text field. The Save/Add command button allows the user to save the Business Rule in the Business Rule Text field and all other associated information, and then screen would refresh and allow the user to begin adding another Business Rule in the same manner. The Save/Close command button allows the user to save the newly added Business Rule and all other associated information and to close this screen. The Delete/Close command button allows the user to clear all fields and close the screen without saving any new information.

Any combination of one or more fields may be identified within the system as fields that require information before the system will save any new Business Rule information. For example, if a user forgets to complete the Type field, the system may flag this omission, and display a pop-up reminder screen before saving a new Business Rule.

The Apply To Provision/Clause command button allows the user to relate the Business Rule to a particular Clause or to a category of Clauses at the time the Business Rule is being added to the system. FIG. 11A illustrates an example of an interface screen that allows a user to apply a Business Rule to a particular Clause or category of Clause. The Business Rule field displays the text of the Business Rule being applied. The Search/Filter Provisions/Clauses area may contain a Key Word search field and function, and possibly other fields that may help set a search/filter query. The Display Results area may be displayed on the same screen or a pop-up or new full-screen display, and would display summary results and a full-text display of each relevant Clause. The Apply Business Rule check boxes allow the user to select the Clause to which the Business Rule will be applied.

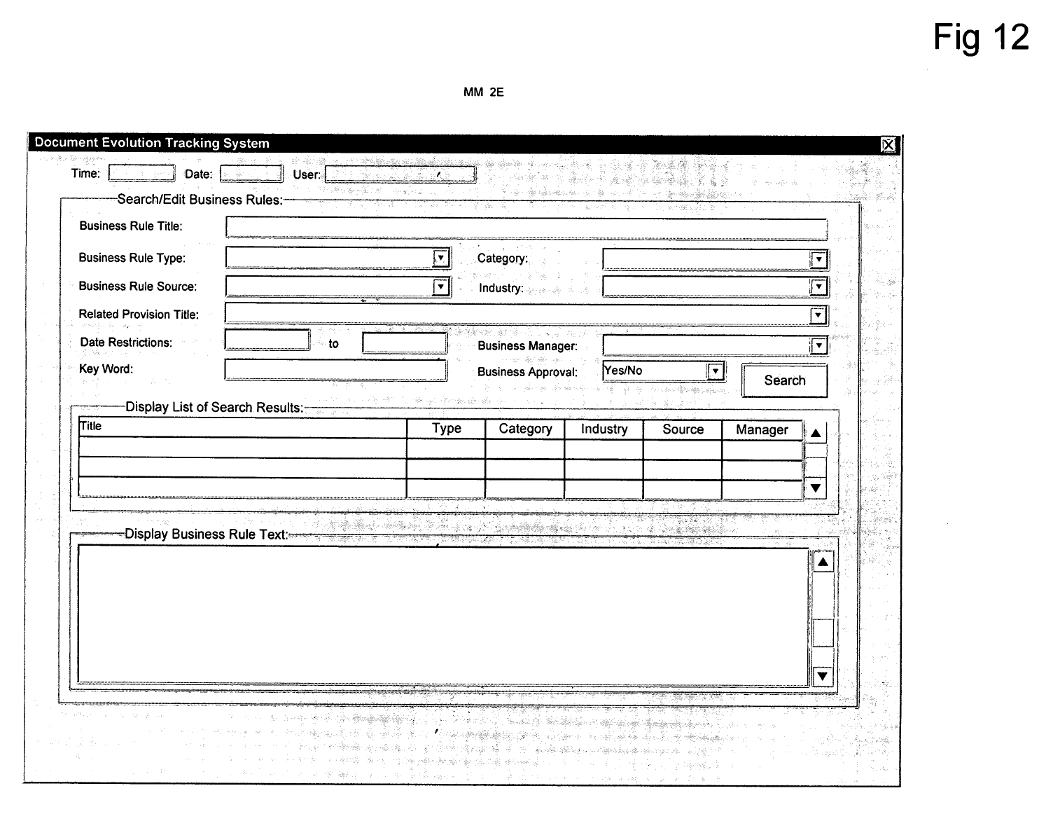

FIG. 12 illustrates an example of an interface screen that allows the user to search, view and edit Business Rules that are in the system. The Time, Date and User fields serve the same purpose as previously described. The user may search by the Title, Type, Source, Cat, Industry and User name (user who added the Business Rule) fields. The user may also search by the Title drop-down field, the Business Rule Approval status field, or the Business Manager drop-down field. The user may also use the Key Word field. The system may be configured to enable the Key Word function to search the Business Rule Text field only or any combination of the Business Rule fields. The Date Restrictions fields allow the user to limit the field of search by the date the Business Rule was added to the system. The Search command button activates the search.

The search results may be displayed within the same screen as illustrated in FIG. 12 or in a pop-up or new screen display. As currently illustrated, one example of displaying the search results is to split the screen and display in a list of a single rows of information that may include the Business Rule title, type, category, industry, source, and manager. When the focus is on any given row, the “Display Business Rule Text” field would display the text of the related Business Rule. Double-clicking any given row or other navigational option will allow the user to open and activate the Business Rule screen thereby enabling the user to make changes to the Business Rule text and any data in the other related data fields.

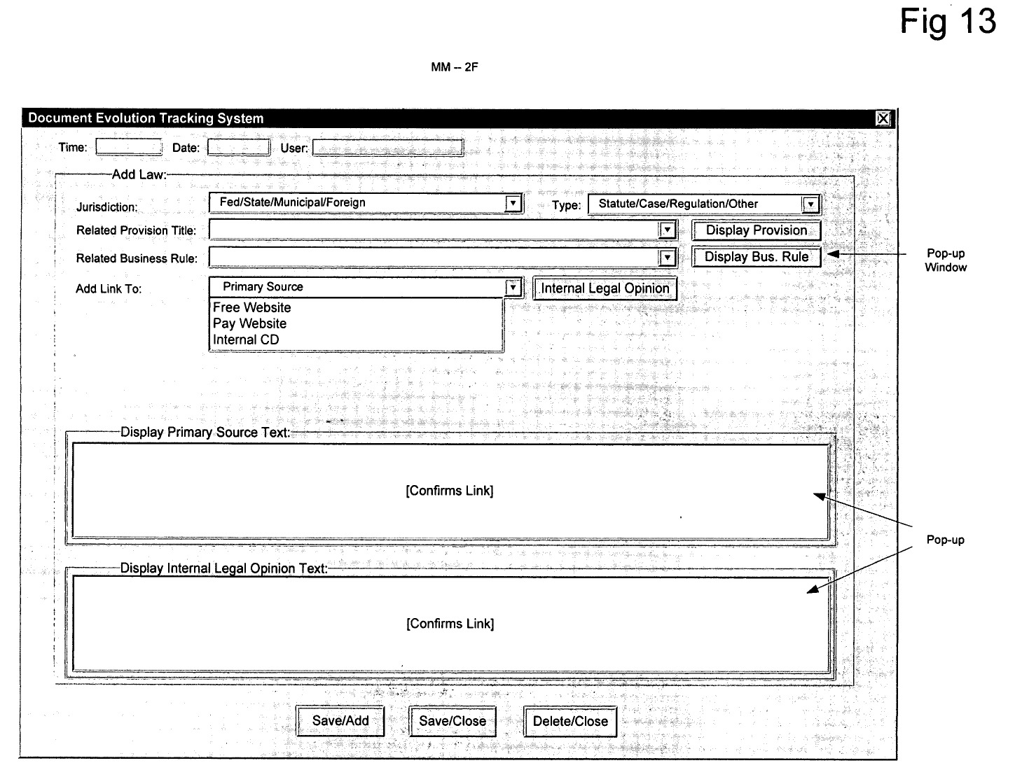

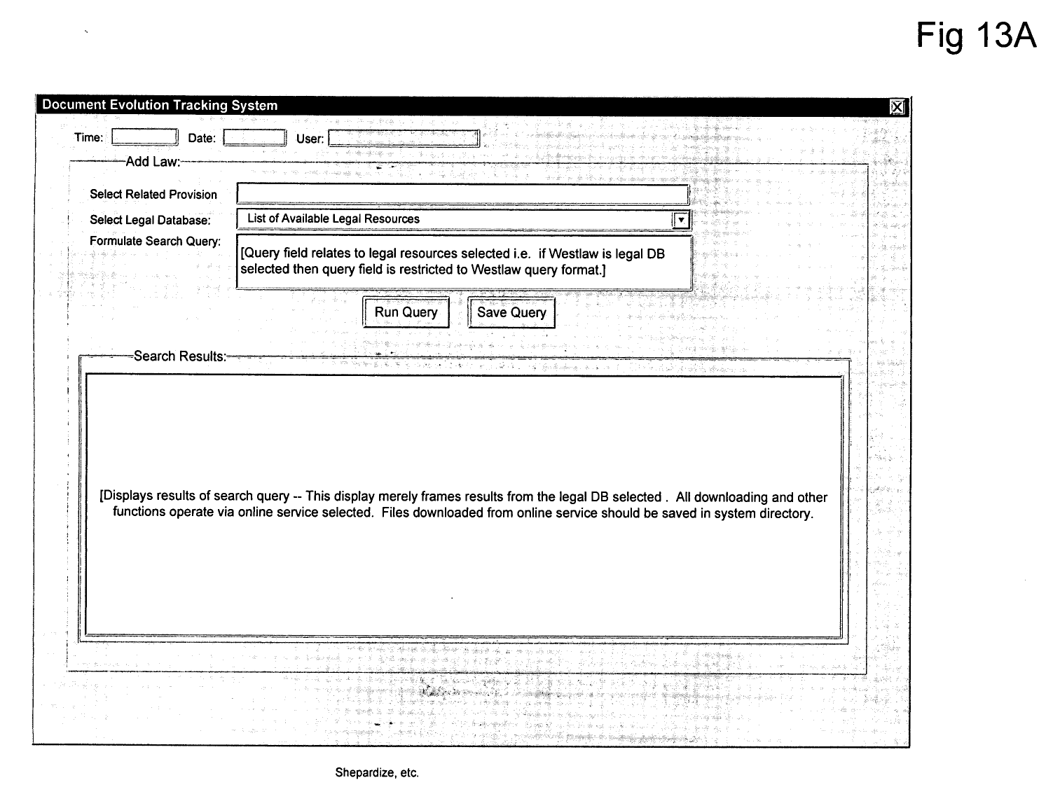

FIG. 13 illustrates an example of an interface screen used to ADD a legal reference to a Master Matrix Worksheet. The Time, Date, and User ID fields are again for audit purposes. If the user has become aware of a new statute, court decision, regulation or other legal material that is relevant to a particular Clause or Business Rule, then this screen may be used to access the legal source material by accessing an external database either on the user's network or on the web or other online service. Selecting the Primary Source command button will allow the user to perform this task using a screen like the one illustrated in FIG. 13A. The Select Related Provision field would be automatically filled-in if the user selected that from the prior screen. Using the Select Legal Database drop-down field allows the user to choose an available online legal research service like Westlaw or Lexis. Once an online service is selected, the user may formulate a search query in the “Formulate Search Query” field. When satisfied with the form of query, the user may select Run Query and the system will perform an automated login sequence that would connect to the selected service. Once connected, the query would be uploaded to the online service and executed. The online service screen would display in the search results field. Once the user finds the relevant legal material, it may be downloaded and saved within the system. Selecting the Internal Legal Opinion command button allows the user to access prior legal opinions that may be stored in electronic form in a location within the system or on the user's network. The user may then select the relevant Provision/Clause using the Related Provision Title field. The user may also select the relevant Business Rule using the Related Bus. Rule field. The Display Provision and Display Bus Rule command buttons allow the user to pop-up the full-text display of the selected Provision and Business Rule.

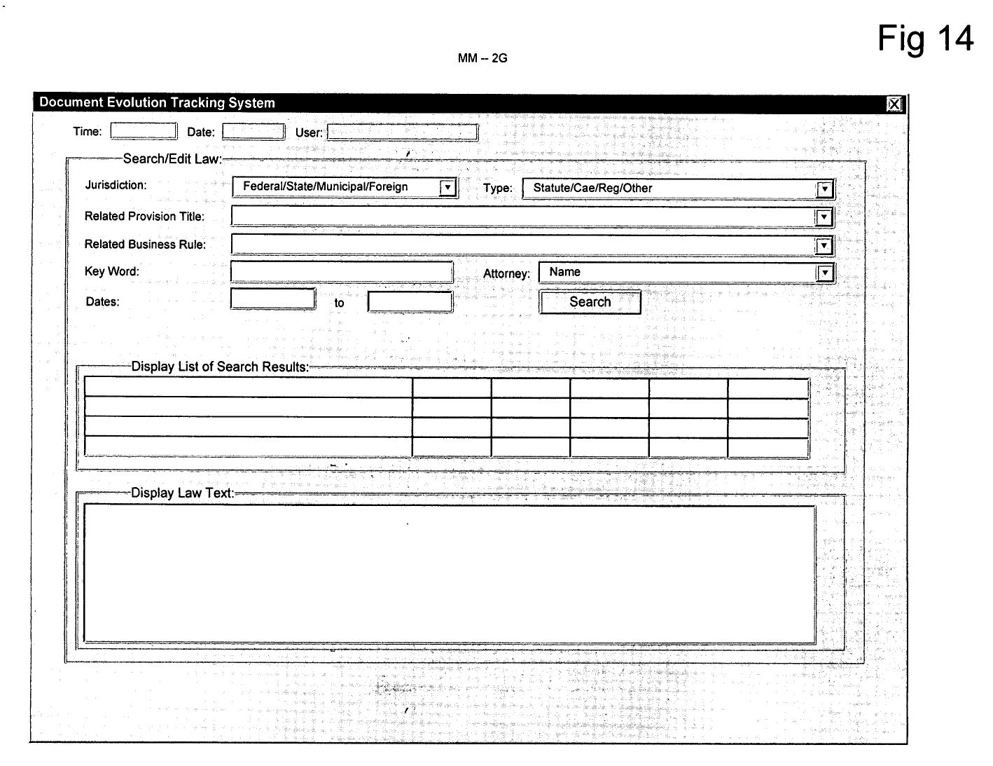

FIG. 14 illustrates an example of an interface screen used to search, view, and edit Law content or links or other pointers or references stored in the Master Matrices. The Time, Date, and User ID fields are again for audit purposes. The Jurisdiction field may be used to narrow a search to a specific jurisdiction or set of jurisdictions. The Type field may also be used to narrow the search to a specific type of Law content. The Related Provision Title and the Related Business Rule Title fields may be used to narrow the search if the user knows the title of a particular Provision or Business Rule relevant to the Law being searched. The Key Word field may be used to narrow the search using specific words or combination of words. The Date fields may be used to narrow the dates of the search. These dates may be related to the date the Law became effective, or may be related to the date the Law was added to the system, or both. The Attorney field relates to the name of the attorney who approved the inclusion of material as Law content. The Search command button executes the search based on the content of the fields described. A search may be performed on one or many fields as a single query. The Display List of Search Results field displays summary information about each of the Law entries that meets the query. The Display Law Text displays the full-text of the Law of the entry in the results field that is highlighted or otherwise maintains the current focus.

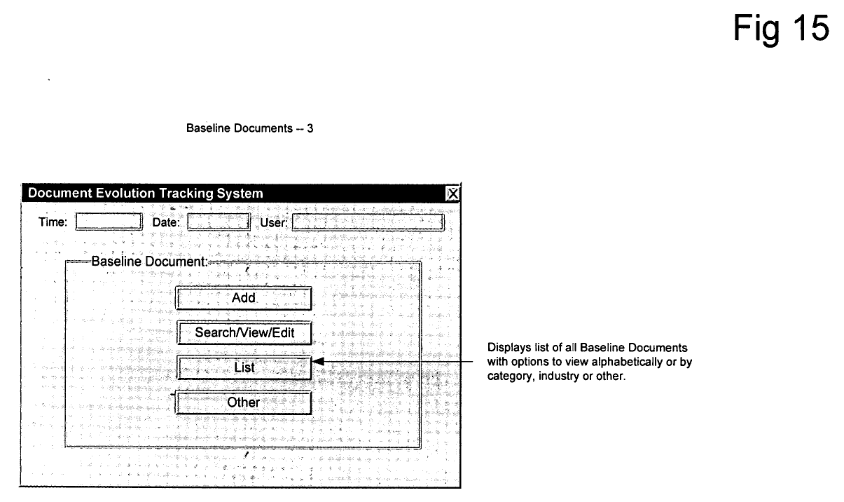

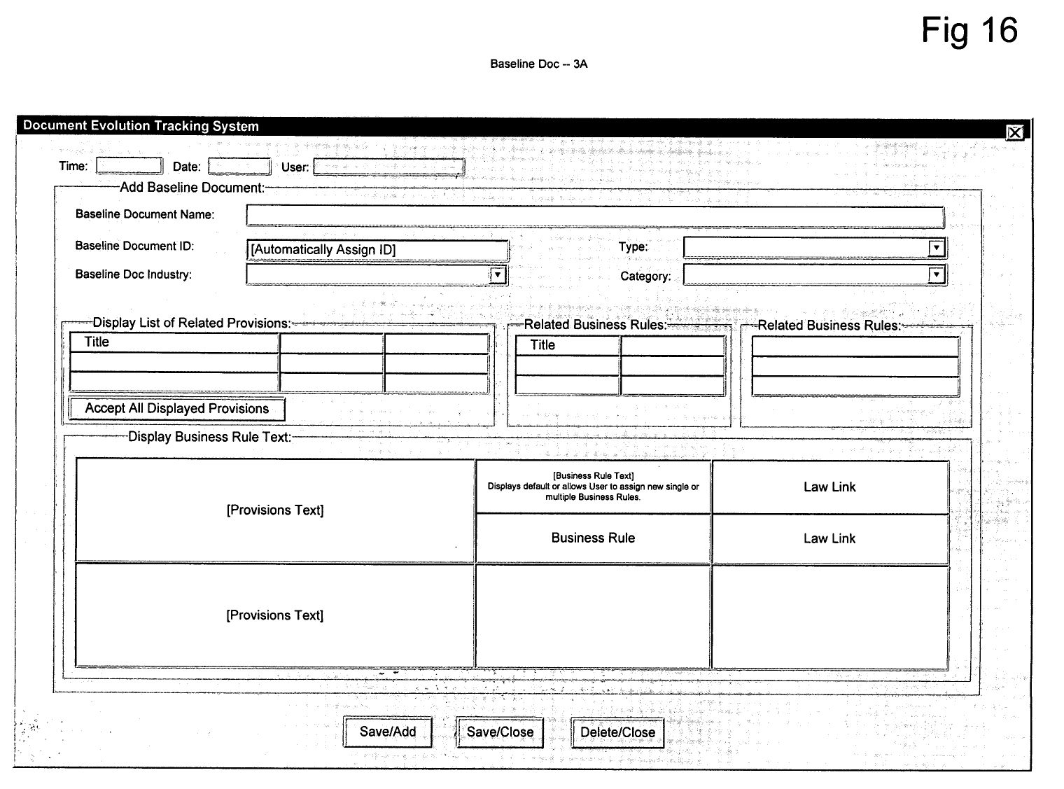

FIG. 15 illustrates an example of an interface screen used to add, search, view, and edit Baseline Documents. The Time, Date, and User ID fields are again for audit purposes. Selecting the ADD command button displays the Add Baseline Doc screen like the one illustrated in FIG. 16. A Baseline Document name may be added using the Baseline Doc Name field. A Baseline Document identification number may be automatically assigned and appear in the Baseline Doc ID field. The user may also relate\index the Baseline Document by type, industry and category using the Type, BL Doc Industry, and Cat fields respectively. Depending on such selections, the related Provisions\Clauses will appear in summary form along with the related Business Rules and Law in their respective display areas. The user may then select the Clauses relevant to the Baseline Document being prepared by double-clicking each Clause individually, or, by group using the Accept All Displayed Provisions command button or by other ways of selection. The resulting Baseline Document will then be displayed in the Display Baseline Doc field or in a pop-up or separate full screen display that will also reveal each related Business Rule and Law citation. The Save/Add command button allows the user to save the Baseline Document as assembled, and clear the screen and begin adding a subsequent Baseline Document. The Save/Close command button allows the user to save the newly added Baseline Document and all other associated information and to close this screen. The Delete/Close command button allows the user to clear all fields and close the screen without saving any new information.

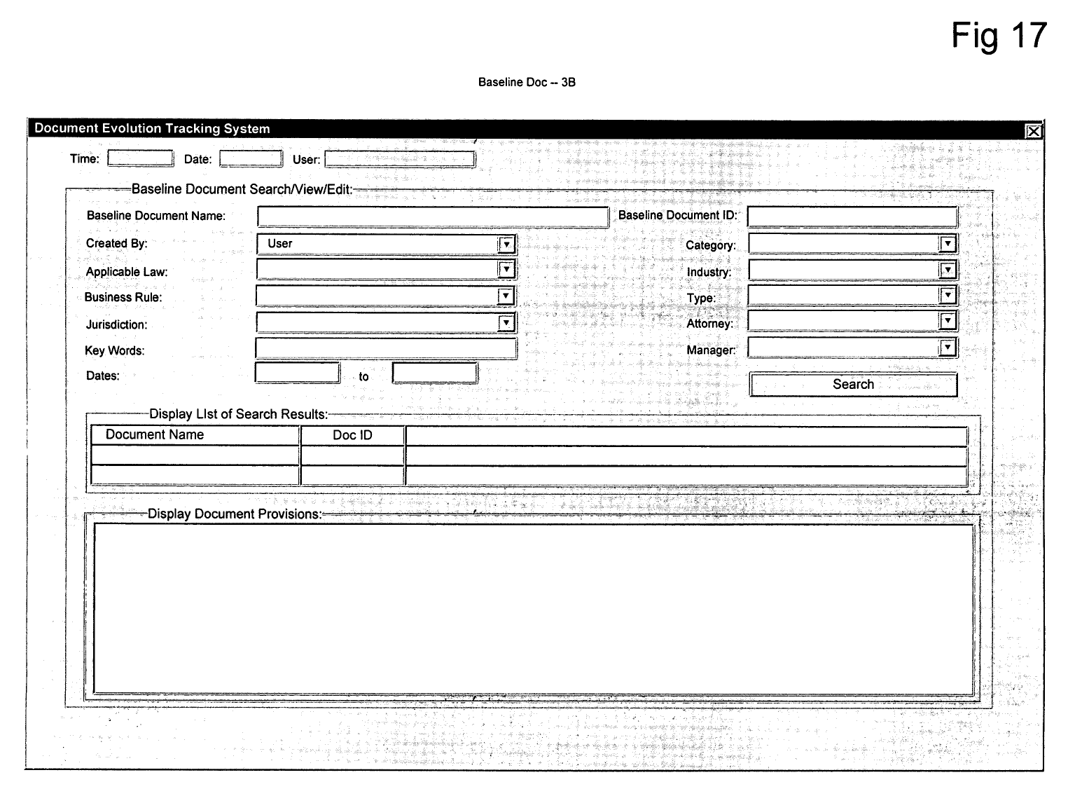

Selecting the Search/View/Edit command button in FIG. 15 displays the Baseline Doc Search/View/Edit screen like the one illustrated in FIG. 17. Here, again, the Time, Date, and User ID fields are again for audit purposes. A user may search for a Baseline Document using one or more of the following fields: BL Doc Name, BL Doc ID, Type, Cat, Ind, Created By, Dates, Jurisd, Applicable Law, Bus. Rule Title, Key Word, Attorney, or Manager. The user may execute the search using the Search command button.

The search results may be displayed in the Display List of Search Results field or in a pop-up window or a separate full screen. The Baseline Documents that match the search criteria may be listed in summary form that displays the Baseline Document name, the identification code, and other summary information as depicted here. When a summary row is selected, the Baseline Document Clauses may be displayed in the Display Document Provisions field or in a pop-up window or a separate full screen. By double-clicking on the summary row in the Display List of Search Results field or by using another navigational option, a full screen display similar to that of the Add Baseline Document screen could appear in a View/Edit mode allowing the user to make changes to the Baseline Document and save them.

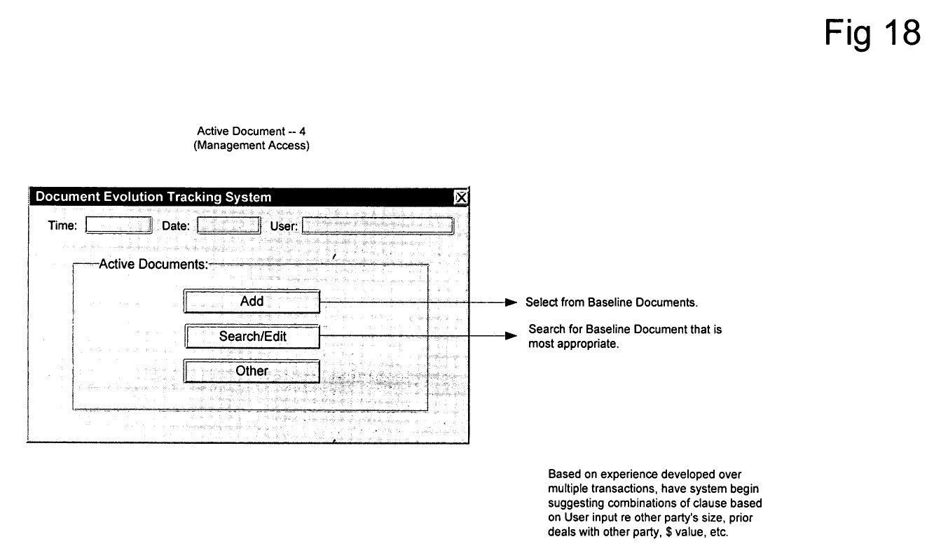

FIG. 18 illustrates an example of an interface screen used to add, search, view, and edit Active Document Containers. The Time, Date, and User ID fields are again for audit purposes.

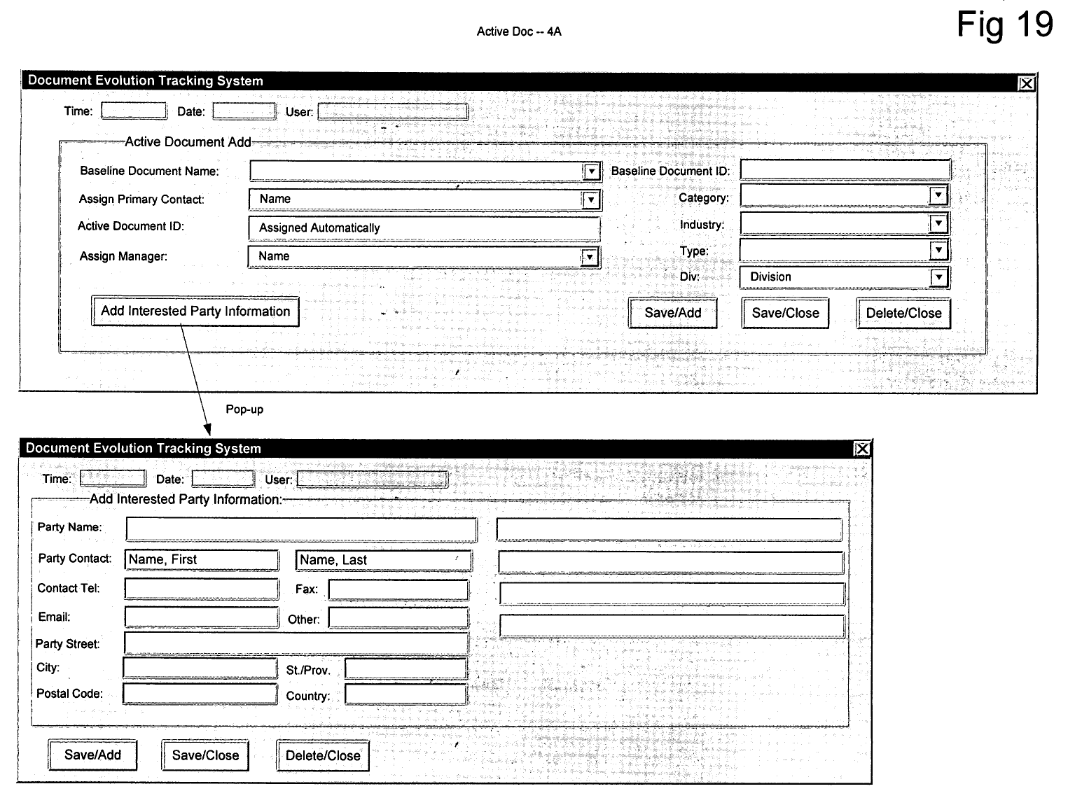

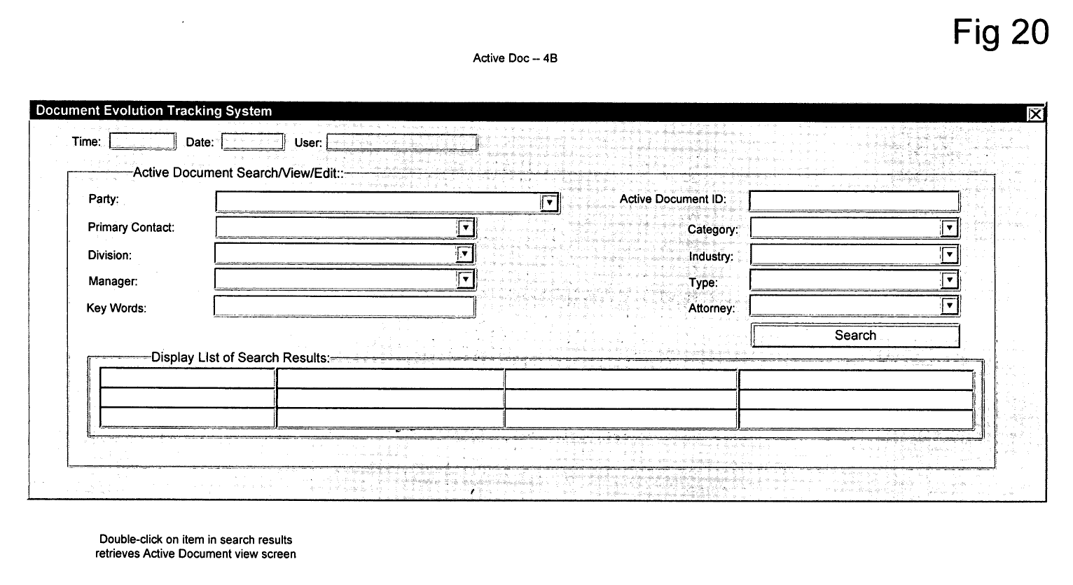

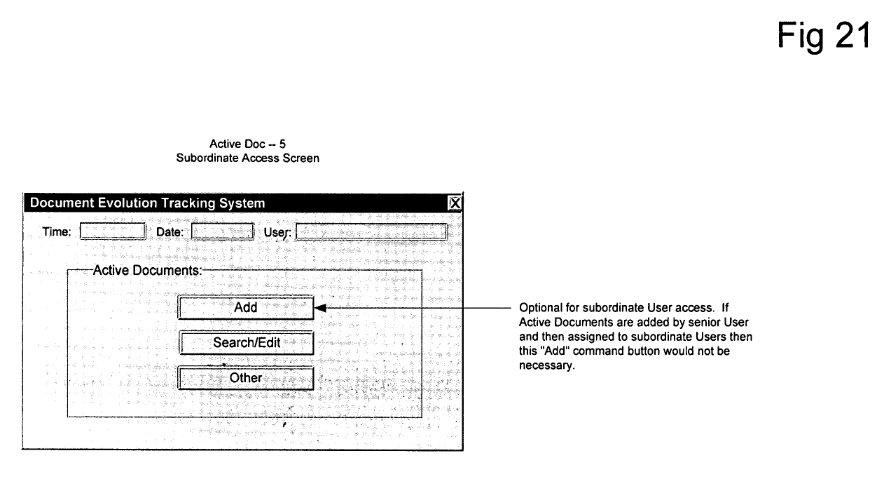

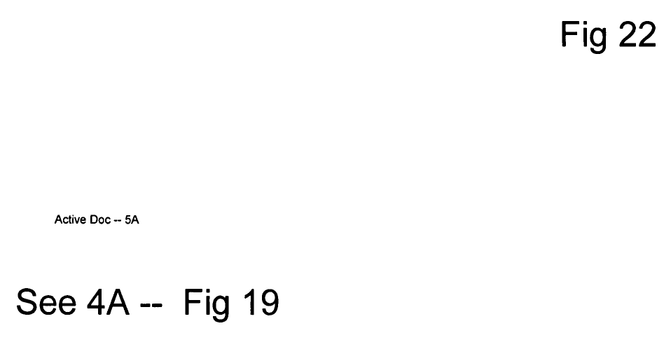

Selecting the ADD command button displays the Active Doc Add screen like the one illustrated in FIG. 19. Here, again, the Time, Date, and User ID fields are again for audit purposes. The Type, Cat, and Industry fields may be used to narrow the selection of Baseline Documents available from which an Active Document may be selected. If the user knows the Baseline Document desired, then it may be selected using the BL Doc Name drop-down field or by entering the Baseline Document identification code in the BL Doc ID field. The Assign Manager, Assign Primary Contact, and Div fields illustrate an example of how responsibility for an Active Document may be assigned to various levels of users within an organization. Access to these fields may be limited to use by senior users or management, or they may be assigned by a default setting that is related to the Baseline Document that is selected. The Active Doc ID field may be completed automatically upon selection of a Baseline Document. Again, this could be a simple one-up numeric code, or it could be related to the Baseline Document selected. In either event, it should be a unique identifier for the Active Document being created. Selecting the Add Interested Party Information command button will allow the user to add identifying information that will be associated with the Active Document. For example, if the Active Document is a contract for a particular transaction, then the user may add the other party's name, address, contact information, and other information deemed relevant to the particular Active Document. This information-collecting screen may also be related to the particular Active Document being created so that different information collecting fields would be displayed to allow for the collection of information necessary for the specific type of Active Document. The Save/Add command button allows the user to save the Active Document as assembled, and clear the screen and begin adding a subsequent Active Document. The Save/Close command button allows the user to save the newly added Active Document and all other associated information and to close this screen. The Delete/Close command button allows the user to clear all fields and close the screen without saving any new information. These command buttons function the same way for the pop-up screen related to the Add Interested Party Information command button.

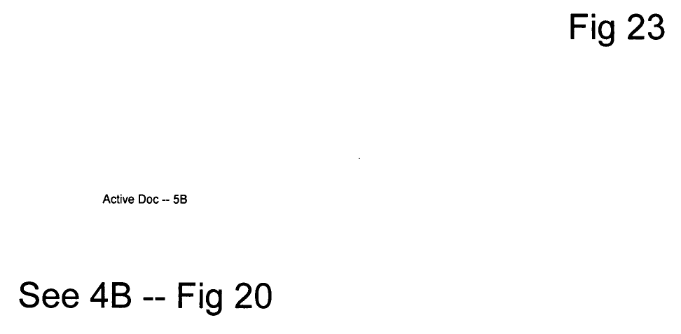

Selecting the Search/View/Edit command button in FIG. 20 displays the Active Doc SearchView/Edit screen like the one illustrated in FIG. 17. Here, again, the Time, Date, and User ID fields are again for audit purposes. A user may search for an Active Document using one or more of the following fields: Active Doc ID, Party, Type, Cat, Ind, Div, Key Word, Attorney, Manager, or Primary Contact. The user may execute the search using the Search command button.

The search results may be displayed in the Display List of Search Results field or in a pop-up window or a separate full screen. The Active Documents that match the search criteria may be listed in summary form that displays the Active Document name, the identification code, and other summary information. When a summary row is selected, the Active Document may be displayed in the same manner as described in FIG. 17 with respect to Baseline Documents. By double-clicking on the summary row in the Display Search Results field or other navigational option, a full screen display of the Active Document screen could appear in a View/Edit mode allowing the user to make changes to the Active Document and save them.

FIG. 21 illustrates an example of an interface screen that displays an example of how access to Active Documents may be split between senior and subordinate users. FIG. 22 and FIG. 23 refer back to FIG. 19 and FIG. 20, respectively, because the screen display could be functionally the same except the documents being searched/viewed/edited would be Active Documents.

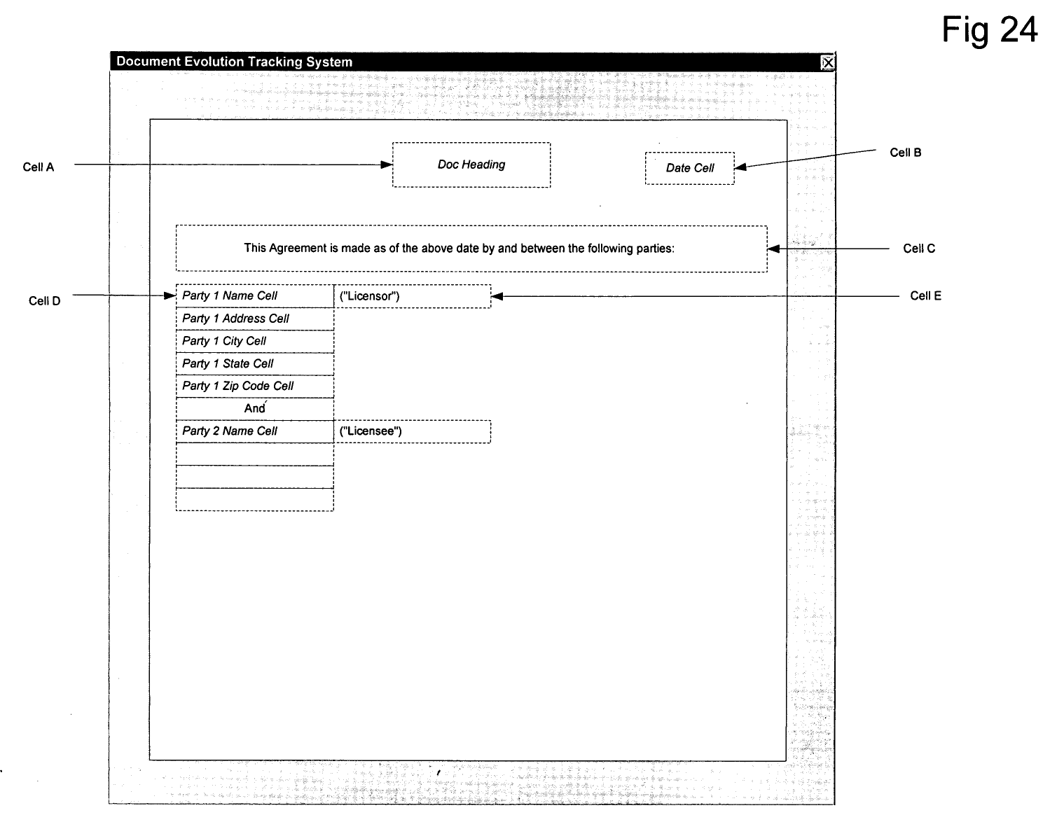

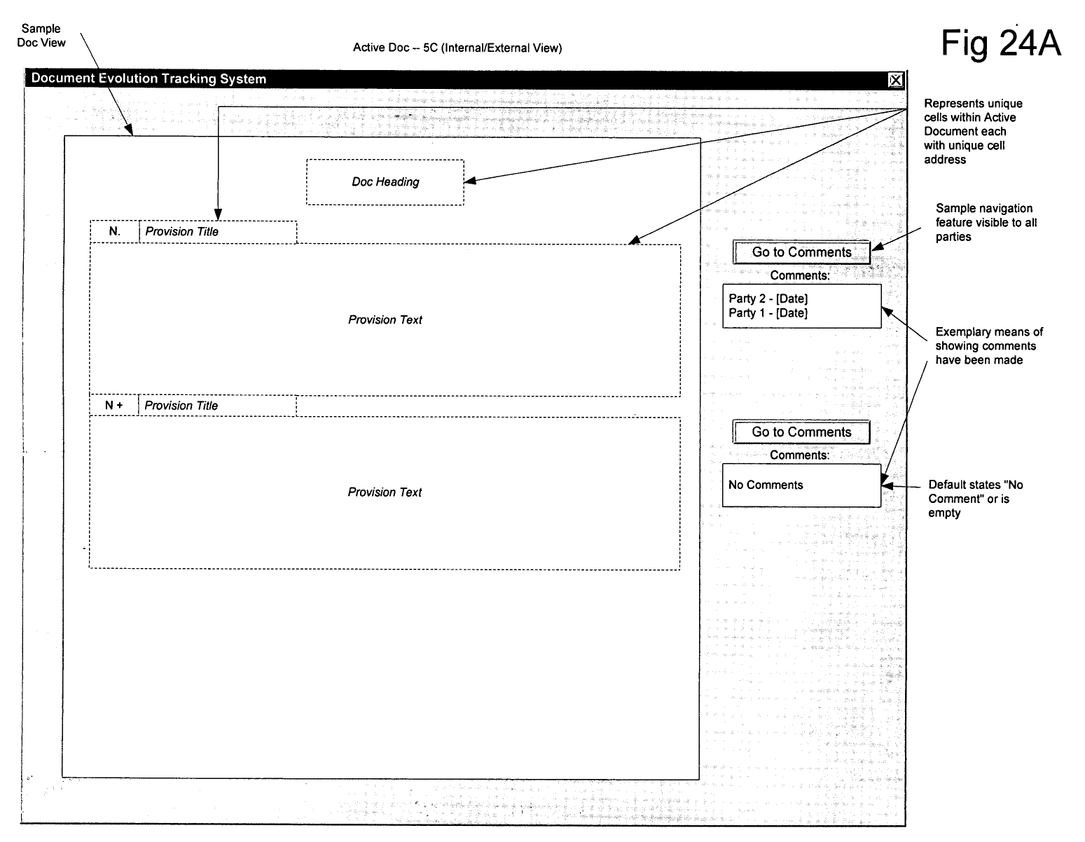

FIG. 24 illustrates an example of an interface screen that displays a Document within an Active Document Container. The dotted lines represent cells with borders that are not displayed. Cell A displays the Document heading via a reference to the heading cell in the related Baseline Document. Cell B contains the date of the Document which information will be passed back to the system to be recorded in connection with this particular Active Document identification number. Cell C displays provision/clause text, again, via a reference to the same Provision/Clause in the related Baseline Document. Cell D contains information that is derived from each party and is displayed in these Cell D and the other related address cells via a reference to a related cell in another Worksheet or via a link to a database or other data storage software program. Cell E displays the defined term label “Licensor” via a reference to the same defined term label in the related Baseline Document. Baseline Document and displayed in the Document but cannot be modified via this screen display.

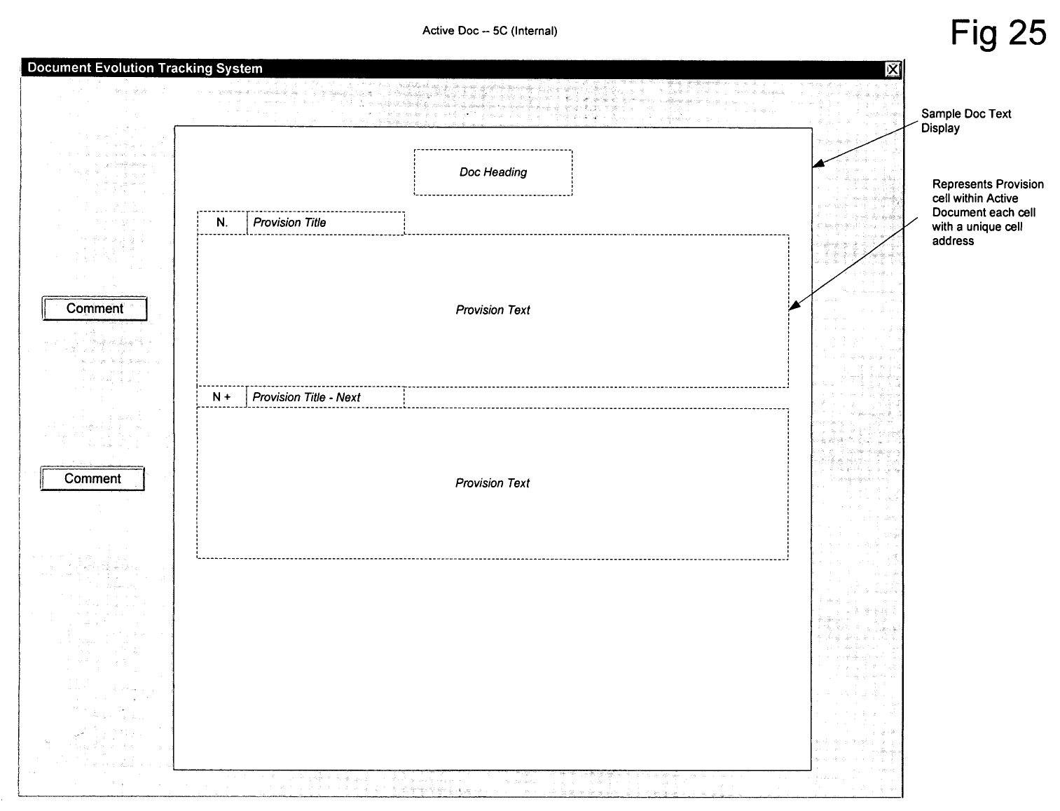

FIG. 24A illustrates an example of an interface screen that displays a Document within an Active Document Container. The dotted lines, again, represent cells with borders that are not displayed. Each cell contains information that is derived from a Baseline Document and displayed in the Document but cannot be modified via this screen display. The vertical dotted line on the right side of the display separates command buttons and Comment fields that are associated with the adjacent Provision or Clause. The Go To Comments command button allows the user to access a Comments Worksheet. The Comments field is one example of revealing to the reader whether any other reader has added any comments about the adjacent Provision or Clause. If comments have been made, the reader who added the comment and the date the comment was added may appear in the Comments field. Other possible methods of informing a reader that comments have been made is to automatically change the font and or color of the font displayed in the Provision Text field, and upon mouse-over a list identifying the reader who entered the comments and the dates of each entry could be displayed. FIG. 25 illustrates another example of the same screen display.

Other features may be added to this sample interface screen that are not illustrated in FIG. 24 or FIG. 25 such as a feature of identifying the Clauses that have comments only, proposed changes only, or both comments and proposed changes. Another feature could track and display when a comment or proposed change has been reviewed by others participating in the Active Document preparation process. These features, and variations or combinations of features, allow a reader to easily review the progress of the preparation of a particular Active Document.

An example of another feature not illustrated in FIG. 24 or FIG. 25 (but may be illustrated in an alternate embodiment) is a feature to enable a reader to display only those Clauses that have associated comments or changes. This feature enables a reader to focus only on those Clauses with which other readers have added either a comment or proposed change to the Provision or Clause language.

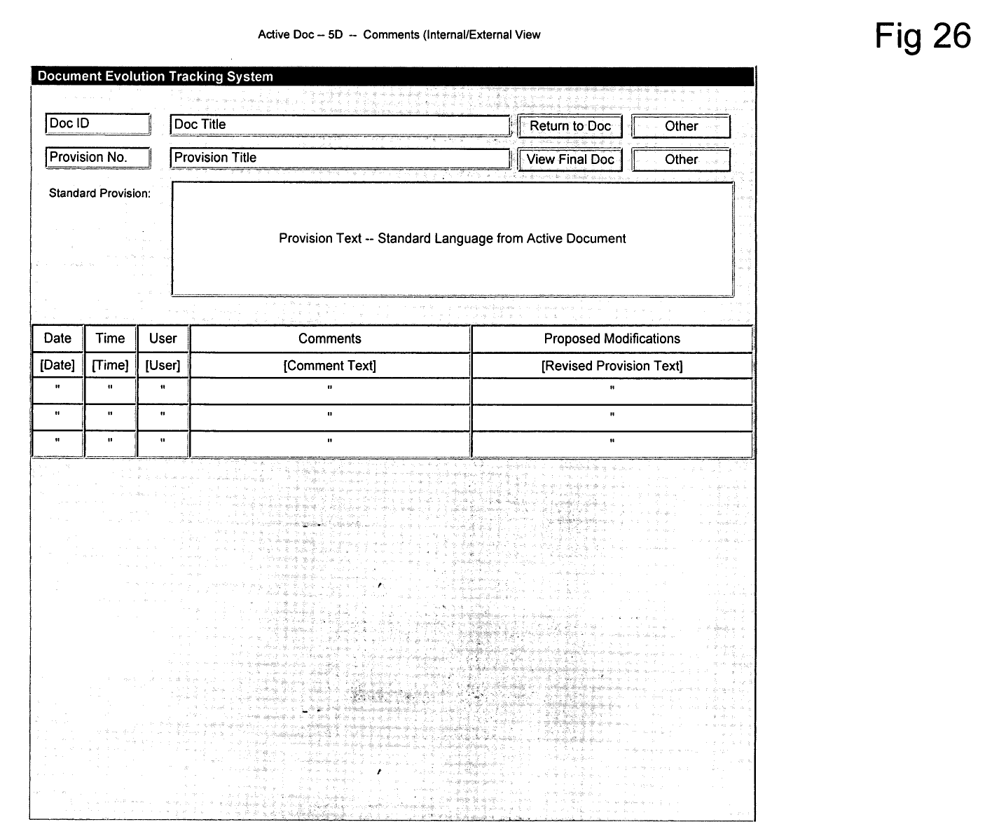

FIG. 26 illustrates an example of an interface screen that displays a Comments Worksheet in an Active Document Container. This screen displays when a reader selects the Go To Comments command button illustrated in FIG. 24. The Doc ID field displays the Active Document identification number. The Doc Title field displays the title of the Active Document. The Standard Provision field displays the Provision or Clause that is the subject of the reader's comments. This information is displayed in the Comments Worksheet so the reader does not have to return to the Active Document to reference the Provision or Clause language. The Prov. No. and Provision Title fields also displayed here the same information as it appears in the Active Document for the reader's reference. The left column under the heading “Date” stores the date the comment is added to this row. The next adjacent column to the right under the heading “Time” stores the time the comment is added to this row. The next adjacent column to the right under the heading “User” stores the reader or user identification code of the person adding the comment to this row. The next adjacent column to the right under the heading “Comments” stores the comments added to this row. The next adjacent column to the right under the heading “Proposed Modifications” stores any proposed changes to the Provision or Clause language that is added to this row. Each row is a distinct entry.

FIG. 26 also illustrates examples of command buttons labeled Return to Doc, allowing the user/reader to return to the display of the Active Document, and View Final Doc, allowing the user/reader to preview the Active Document as it would be prepared if all of the proposed modifications were included at that moment in time. Additional command buttons or fields labeled Other are also included in this illustration to indicate that additional features and/or information may be available or displayed in this view.

Examples of additional features not illustrated in FIG. 26 (but may be included in an alternate embodiment) are the automatic insertion of the date, time, and user identification code of the reader that selected the command button to access the Comments Worksheet. Also, the date, time, and user identification fields could be hidden fields that, again, are automatically filled-in with the relevant information that could be stored for later retrieval as necessary. This would provide more screen space for the Comments and Proposed Modifications fields. Also, this screen display would be viewable by all users/readers of the Active Document.

Another feature may be that upon displaying the Comments Worksheet the first empty comment row may be automatically activated and certain information may be automatically captured in the same row. For example, when a reader first activates and displays the Comments Worksheet, the first comment line would automatically be activated and the date, time, and reader identification code could be inserted automatically. The Cell 2 in a designated comment column could automatically become the focus of the display so that the reader may immediately begin entering comments or questions about the displayed Clause.

Another feature of the Comments Worksheet may allow the reader the option of entering proposed changes to the displayed Clause in a Cell 2 in the same comments row but under an adjacent column designated for storing such proposed changes.

Another feature of the Comments Worksheet may allow the reader to select a device, for example a command button or the displayed Clause's Cell 2 that automatically reproduces the displayed Clause in the same comment row in a new Cell 2 designated to store proposed Clause changes. The Cell 2 designated for storing proposed Clause changes may also be enhanced further by a feature that allows the reader to track changes to the Clause as it is displayed in the proposed Clause change Cell 2, such as a text redline/strikeout function, so the proposed changes are readily visible.

Another feature of the Comments Worksheet may allow the reader to select a device, for example a command button or other navigational device, to automatically save the reader's comments/changes in one comment line, and then move the focus of the display to the next comment line. Upon selection of this feature the next empty comment line would become active and the date, time and reader's identification code would automatically be capture in their respective columns with the Cell 2 in the designated comments column becoming the focus of the display again. This may be important if a reader has extensive comments or prefers to address several issues each in separate comment lines.

Another feature of the Comments Worksheet may allow for the display of multiple comment rows including reader comments/changes so that the reader may review the history of comments/changes for any given Clause within the Comments Worksheet that pertain to the Active Document Container.

Another feature of the Comments Worksheet may allow the reader to return to a comment previously added by the reader—but not by other readers—and to make changes to the reader's comments/changes in that comment line. However, for the Comments Worksheet to accurately reflect reader comments/changes a reader's ability to return to any given comment line, even those the reader originally created, should be controlled. For example, a reader may enter comments on day one, receive a reply in the next comment line on day two, and should not then be allowed to return to the day one comment line and make changes to that comment line. At that point, the reader should be required to enter a new comment line subsequent to the day two comment line that responds to the day two comment or further clarifies the reader's day one comment. This type of control may be accomplished by allowing a reader only the ability to make changes to a currently active comment line; or by allowing a reader the ability to make changes to any active comment line or prior comment line that the reader created during the display instance of the active Comments Worksheet. Regardless of the type of control used, the reader adding a comment/change to a Comments Worksheet should be queried in some manner such as through the use of a pop-up screen or other prompt before the reader's comments/changes are saved and become unchangeable.

Another feature of the Comments Worksheet may be that it automatically saves the reader's comments/changes in the active comment row once the reader exits the Comments Worksheet or otherwise moves to a new comment row.

Another feature of the Comments Worksheet may allow the reader to select a device, for example a command button, check box or menu item that would allow the reader to mark the reader's own previously saved comment line as one that other readers may disregard. This feature retains the comment intact for tracking purposes but alerts other readers that the comment is of no importance to the original reader/commenter.

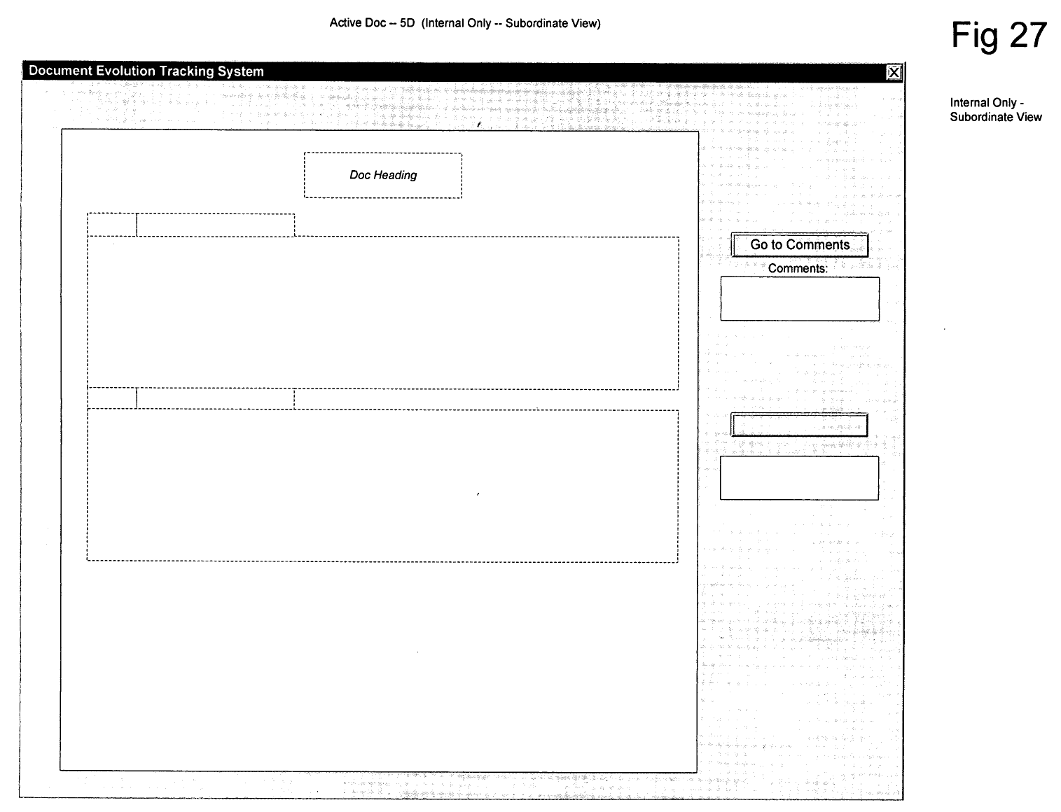

FIG. 27 illustrates an example of an interface screen that may be accessed by a subordinate user. The functionality of the items appearing in the interface depicted in FIG. 27 are similar to the features as discussed with regard to FIG. 26.

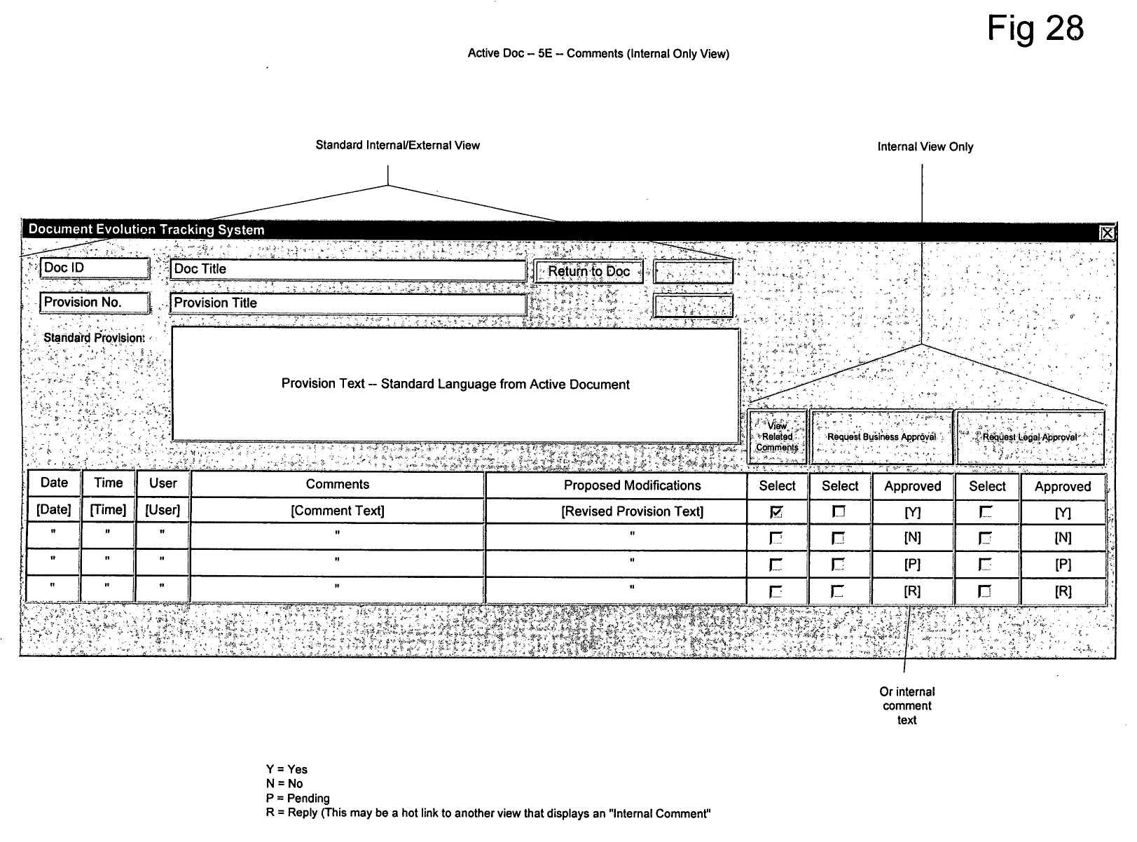

FIG. 28 illustrates an example of an interface screen of an Active Document Container Comments Worksheet that displays the same features described in FIG. 26 and additional features that would only be accessible to authorized readers/users. The portion of the screen display identified as Standard Internal/External View is the same as FIG. 26. The portion of the screen display identified as Internal View Only is only accessible to authorized users/readers via use of a password or other secure methods of entry.

The Internal View Only portion displays additional columns and extends the comment row to include other options for the authorized user/reader. The option to View Related Comments allows the user to select a comment row by activating the check box in this column and clicking on the View Related Comments command button. This could execute a query or other request that would search all of a Master Comments Worksheet for comments on the same Provision or Clause from other Active Documents regardless of the other Active Document status. For example, Active Documents that are currently being prepared and have not been finalized, Active Documents that have been finalized, Active Documents that have been cancelled or terminated, and Active Documents that have been archived could be searched. The results of this search would be displayed to the authorized user/reader who would then have the benefit of seeing how other Active Documents may have been modified to address comments and proposed modifications to the same Provision or Clause in other situations. The authorized user/reader would also have the benefit of seeing whether similar comments and/or proposed modifications were accepted or rejected by peer authorized user/readers or by the authorized business manager or authorized attorney. If no similar comments or proposed modifications appear, the authorized user/reader would have the option of requesting feedback on a comment or approval of a proposed modification. FIG. 28 includes examples of command buttons labeled Request Bus. Approval, and Request Legal Approval, for these purposes. The letters “Y” meaning yes, and “N” meaning no, and “P” meaning pending, and “R” meaning reply, each in brackets, illustrate one example of how an authorized user/reader could obtain feedback and/or approval on a particular request. These could also be in the form of hot links that when selected by an authorized user/reader could display a pop-up or new full-screen display of the related response.

Alternatively, another feature of the Comments Worksheet may be to add columns in each comment row to create Cells 2 that could contain a check box or other selection device; or to otherwise link comment row information to another worksheet (“Approval Worksheet”) 14 that allows other, perhaps senior, authorized readers to further review and approve or disapprove another reader's comments and proposed changes or either of them. This feature would capture the senior reader's reply comments to the junior reader, and the senior reader's approval or disapproval of any proposed change that is displayed for the senior reader's review. For example, a junior reader may request or may be required to seek feedback from a more experienced or senior reader under certain circumstances presented by another reader's comments/changes concerning a particular Clause. This exchange between two or more readers may contain sensitive information that should not be shared with other readers and should be stored in a manner that will protect it from such disclosure while at the same time allow the authorized readers to retrieve the information for further review when necessary.

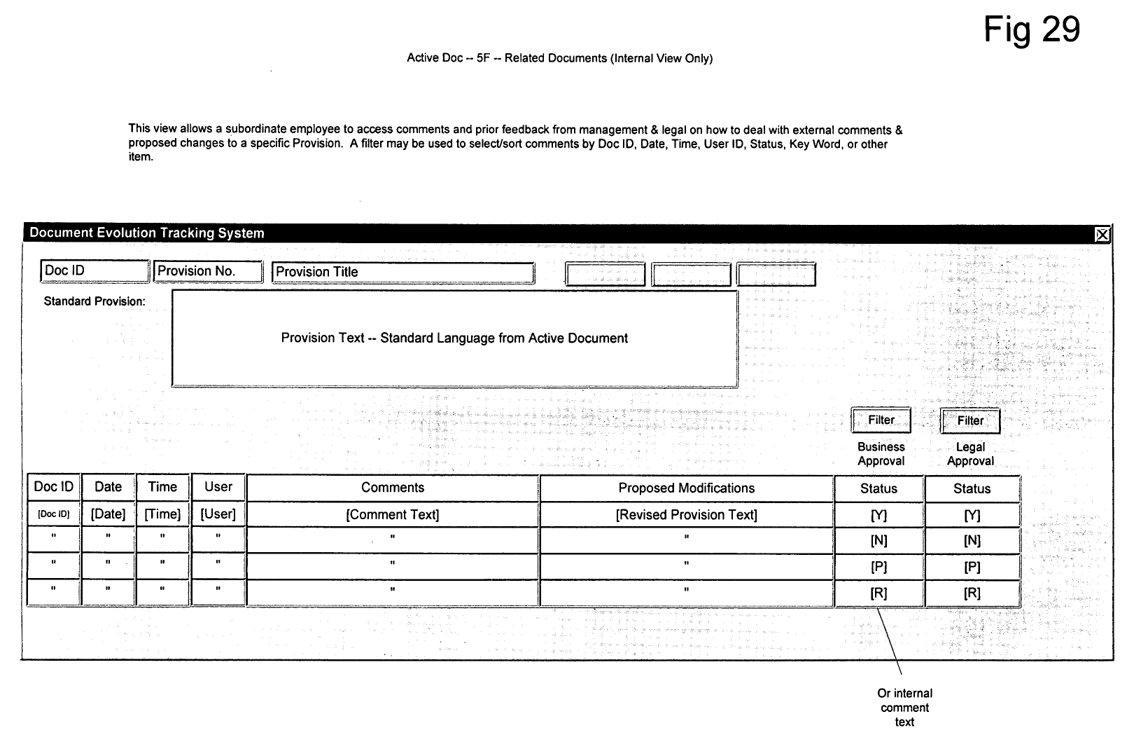

FIG. 29 illustrates an example of an interface screen that would display upon an authorized user/reader's clicking on the View Related Comments command button referenced in FIG. 28. Again, the Standard Provision field displays the same Clause or Provision language as in FIG. 28. However, the rows of comments are derived from all other Active Documents. The far left column under the heading Doc ID displays the Active Document identification number associated with the comment and/or proposed modification that was made in connection with the same Provision or Clause as displayed in the Standard Provision field. The Date, Time User, Comments, and Proposed Modifications columns are the same as in the standard Comments Worksheet. New columns under the headings Business Approval and Legal Approval reveal the status of the comments and/or proposed modifications as of that moment in time using the same letters as illustrated in FIG. 28. Again, these letters could be hot links that when clicked would display another screen with further explanatory information. At the top of the Business Approval and Legal Approval columns are command buttons labeled Filter. Clicking these command buttons would display a new screen that would allow the user/reader to apply a filter to the list of comments/modifications for this particular Provision or Clause. The filter could operate on a number of possible variables. For example, the filter could allow for a key word search or it could offer an index of issues using an alpha/numeric code that could be associated with an importance ranking or different types of issues that come up over time in the context of the particular Provision or Clause. It could also offer date, user, approved, not approved, and other similar item filters.

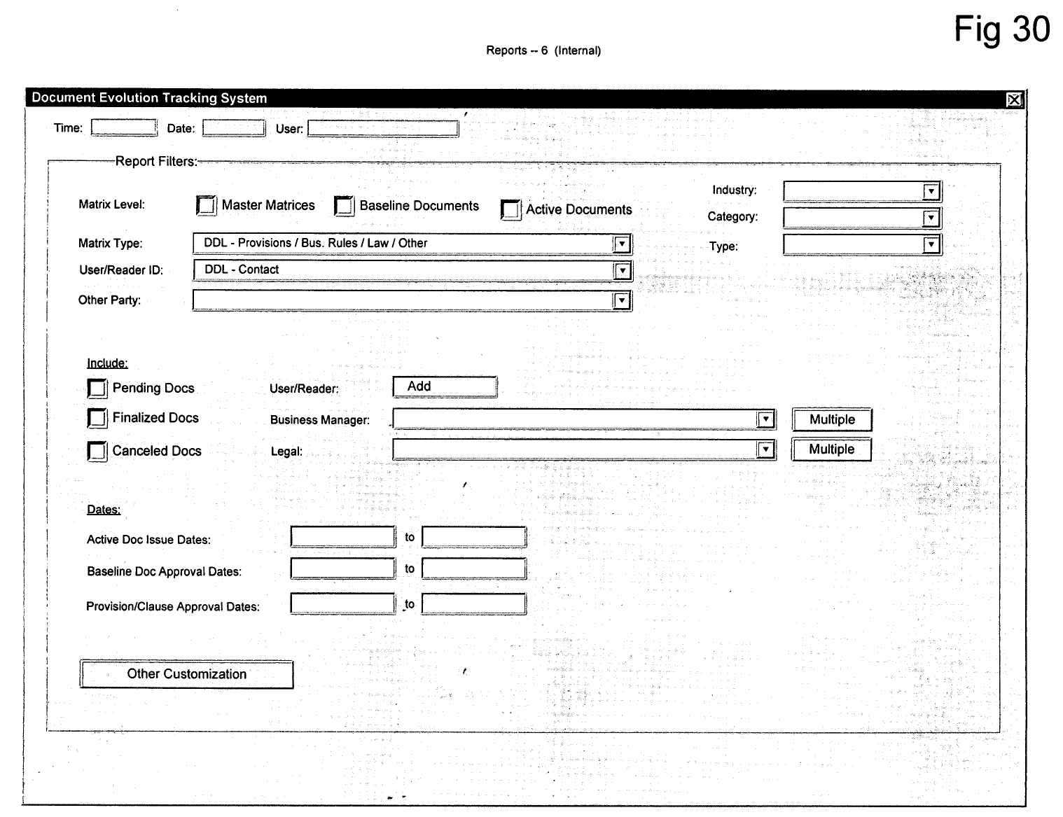

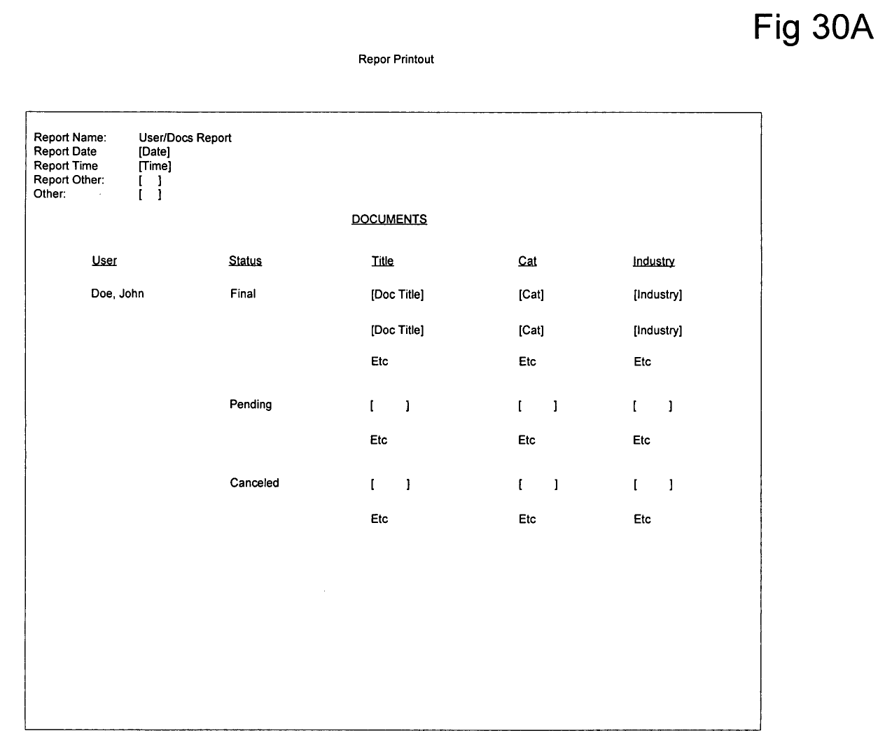

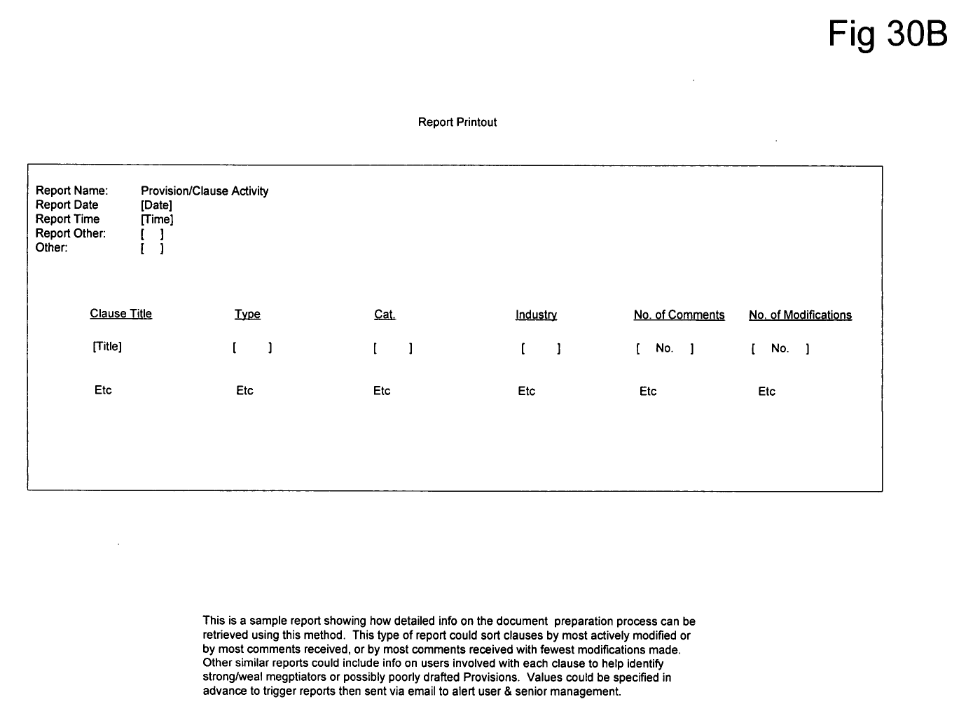

FIG. 30 illustrates an example of an interface screen that could display upon an authorized user/reader's clicking on a report command button referenced in FIG. 6A1 or by some other method. Here, again, the Time, Date, and User ID fields are for audit purposes. The Matrix Level refers to the different levels matrices that comprise the Document Provisions or Clauses that are available in this example for user selection by activating a check box appearing adjacent to the labels Master Matrices, Baseline Docs, and Active Docs. If no check box is selected then the resulting report will contain information on all of these matrices. By selecting one, or any combination of two check boxes, the authorized user/reader may limit the information appearing in the resulting report. The other fields displayed may also be used to limit the information appearing in the resulting report. By selecting the Other Customization command button, an authorized user/reader may further customize the information appearing in any given report using additional fields of limitation.

FIG. 30A illustrates an example of one report printout that may be generated using stored information. The example reveals a sample report name and places where the report date, time and other data could be displayed. The example also reveals how a user's name could be reported in a column under a heading labeled “User” with adjacent columns under headings labeled “Documents” with sub-headings labeled “Status”, “Title”, “Cat” and “Industry”. This example shows how one user may be responsible for multiple reported documents having a status of “Final” and then “Pending” and then “Canceled”.

Because this method enables easy, real-time collection of detailed information about the process of negotiating or otherwise commenting on the drafting of a document, the output or reporting capability of this system enables a multitude of benefits from a micro-management to a macro-management level.

On the micro-management level, one example is that an individual's negotiating habits (strengths, weaknesses, strategies and tactics) may be recorded and later analyzed for purposes training and developing the individual, and, on the contrary, for purposes of exploiting the weaknesses of an opponent's negotiator.

On a macro-management level, when the system is used within a peer group, the activity of the group as a whole may be tracked and analyzed at a higher level. The following scenario is one illustrative example in the context of negotiating a contract in the publishing industry. As authors begin to employ a negotiating tactic to reserve rights in their works the tactic will be recorded in relation to the grant of rights clause. Within any group of negotiators, for example twenty-five, each may experience a particular tactic only once but when analyzed on a macro-level, it becomes obvious that a particular tactic has been widely adopted by authors or those representing authors. Thus, negotiating trends/tactics may be identified faster on a macro-level. Likewise, a counter-measure to any given tactic may be adopted and implemented throughout any given peer group using the system by making changes to the clause at the Master Matrices level and adding new business rules or other annotations to the particular clause that is the subject of such tactic. The macro-level benefits may be further illustrated by another example of one negotiator within a peer group who develops a negotiating tactic that more times than not works to resolve an issue in the negotiator's favor while the other negotiators in the group are simply unaware of the tactic. A macro-level view would enable senior level management to spot this negotiating strength, and inform all others within the group to adopt the same tactic. Additional macro-level advantages also are apparent in the same context when new laws or regulations develop concerning a particular issue that is addressed (or not but as a result of new law may need to be addressed) in a specific clause. Using the method of managing clauses/provisions disclosed by the present invention would enable senior level management and legal officers to uniformly and quickly implement modifications to existing standard form contracts.

FIG. 30B illustrates an example of another report printout that may be generated using stored information. The example also reveals a sample report name and places where the report date, time and other data could be displayed. This example also reveals how the activity related to a particular clause may be tracked and reported under columns labeled “Clause Title”, “Type”, “Cat.”, “Industry”, “No. of Comments”, and “No. of Modifications”. This report shows how detailed information on the document preparation process may be retrieved using this method. By sorting the reported information by the most actively modified clause, a reader may quickly see where the document preparation process is encountering delays. This type of report could also sort clauses by those receiving the most comments. Similar reports could include information about the users involved with the documents that include these highly active clauses. This reported information may help identify strong or weak negotiators in the context of contract documents, or possibly poorly drafted clauses. These and other reports could be generated manually by users or they could be generated automatically after a specified period of time (i.e. monthly), or they could be generated based on pre-set values that if met or exceeded would trigger the generation of the report that could also be automatically emailed to specified users as an alert.

Similar advantages and output/reports can be realized employing the method described in the present invention in the context of rulemaking and particularly in the connection with federal regulations. This method enables the regulatory body responsible for collecting public comments on proposed rules to assemble the proposed rule on a clause-by-clause basis and to associate with each clause any additional comments or explanations that may help a reader to understand the purpose and context of the clause. The proposed rule would be assembled into an Active Document Container and either distributed via ftp download, email, hosted on a web site or by some other similar ways. The Active Document Container would allow the regulatory body to receive comments from disparate sources who may have a common interest in a particular issue but who have no other contact with one another and who may address the issue substantively in different ways. To illustrate the concept further, the Consumer Product Safety Commission may issue a proposed rule requiring the use of labels on products intended for use by children when those products contain small parts. Toy manufacturers may have specific comments concerning the definition of “children” and “small parts” as well as educational publishers who manufacture educational materials that could fall within either or both definitions. Employing the method of document preparation and comment management described in the present invention will enable the regulatory body responsible for issuing the proposed rule to receive comments from the toy manufacturing group and the educational publisher group pre-sorted and in the context of the two defined terms “children” and “small parts”. The individuals at the regulatory body will be able to printout all comments in the context of a particular clause in the proposed rule, and will not have to cull each response from each commenter to find the common issue, and each comment on the common issue, thus saving significant labor and time.

In the context of the government or large entity procurement, again, there are significant advantages and output/reports to using the method described in the present invention. One illustrative example can be found in the context of a request for proposals or “RFP”. This method enables the issuing entity to assemble the RFP on a clause-by-clause basis and to associate with each clause any additional comments or explanations that may help an interested party to understand the purpose and context of the clause. The RFP would be assembled into an Active Document Container and either distributed via ftp download, email, hosted on a web site or some other similar ways. The Active Document Container would allow the issuing entity to receive comments within the context of each provision in the RFP. Among other things, the system reporting/output features would also enable the issuing entity to quickly printout and read or otherwise evaluate how different respondents handled each specific issue, task, or requirement in the RFP by merely clicking on or otherwise selecting the related RFP provision and printing out or otherwise viewing all the respondents' comments associated with the provision.

In each of the contexts illustrated above, comments could be received on paper, or electronically in an email or in an attached word processing or other electronic file, which could be in various formats. In such events, the party receiving the comments generally must printout the document, read through it to find issues. Each responding party may raise the same issue at different points in their respective replies, resulting in additional time and labor for the party that issued the initial document. The entity employing the method described in the present invention, whether in the context of contracts, rulemaking, or requests for proposals, or other situations where documents are generated as a result of feedback or comments from multiple sources, will also have the benefit of receiving comments in the same format from all sources. Using this method, all comments are received in a single format, which streamlines workflow, and enables uniform printout or other output for user analysis. The Active Document Container could also include additional features that would automate some or even all of the comparative analysis on some or all of the responses.

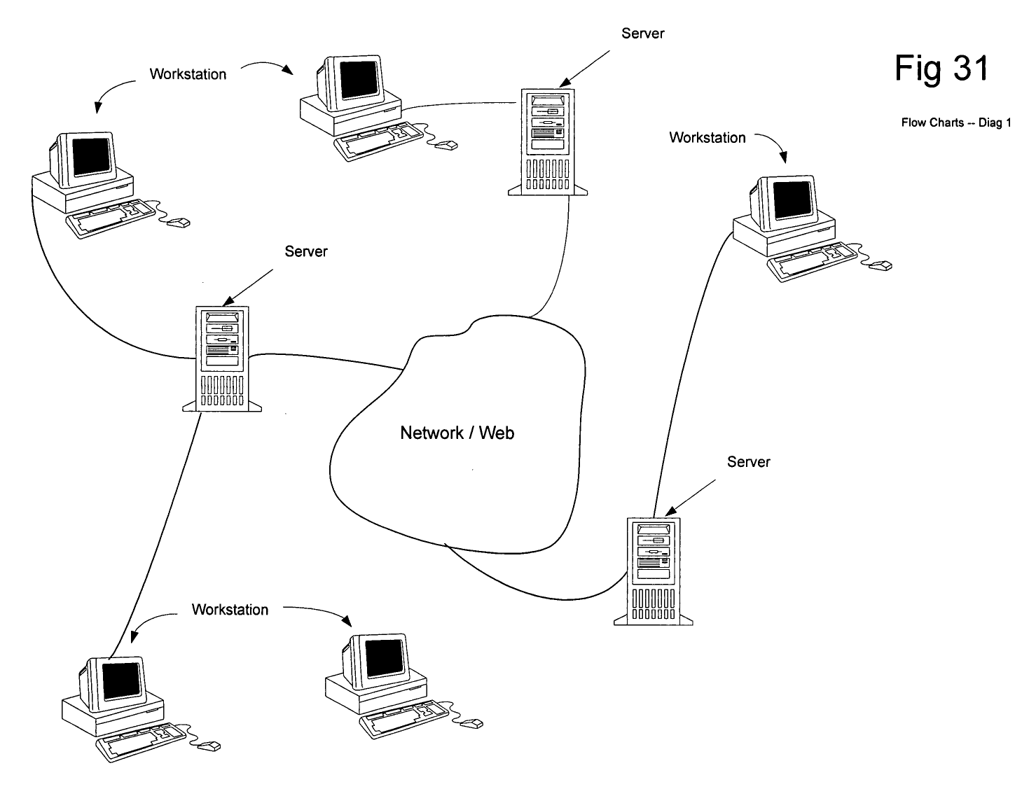

FIG. 31 illustrates an alternate system environment that demonstrates principles consistent with the present invention implemented over a network.

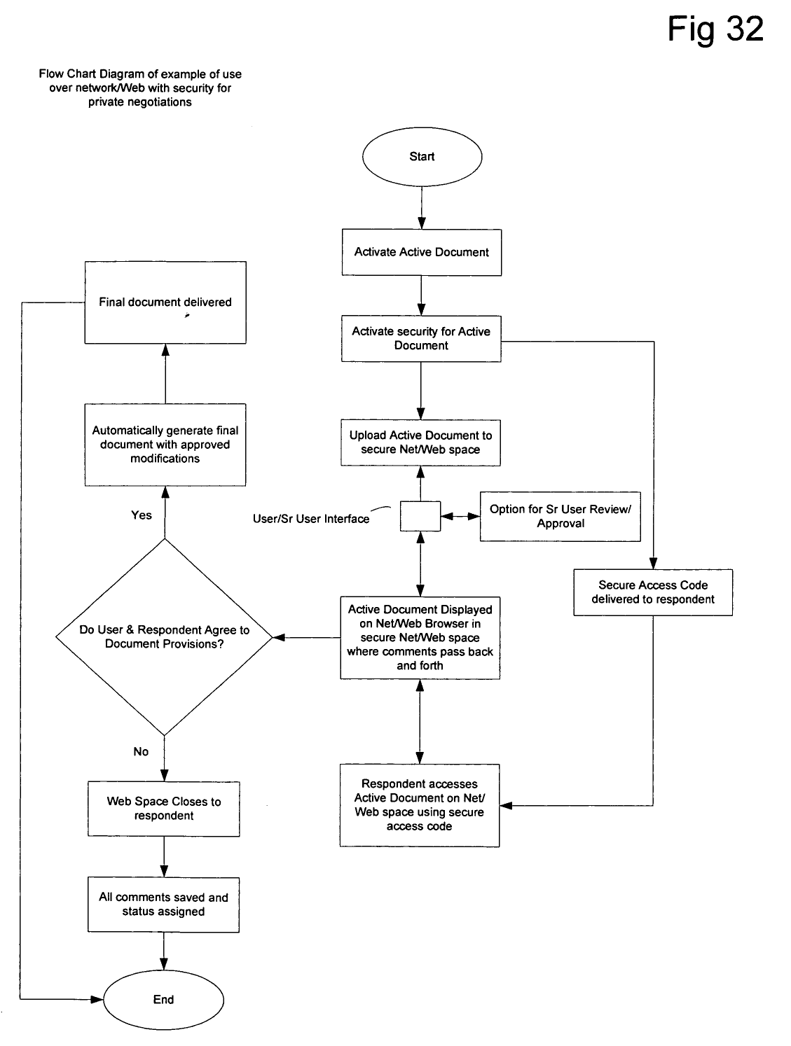

FIG. 32 illustrates a flow chart of one example of how the system may be used in a network environment where the authorized user/reader interacts with an outside reader of the Document via a web browser or other network interface. It begins at the point where Activate Active Document has been completed by an authorized user/reader for distribution to one or more readers outside the user/reader's organization. The next step is to activate the security features for the specific Active Document. Thereafter (or simultaneously) the Active Document would be uploaded to a secure area on a network or web space. The authorized user/reader would then have the ability to seek feedback from a senior user/reader or authorized business manager or authorized attorney. The next step is to make the document available to the outside reader. The sample interface screens would be displayed to each authorized reader and outside reader in accordance with the preset limitations on access and use of the system.

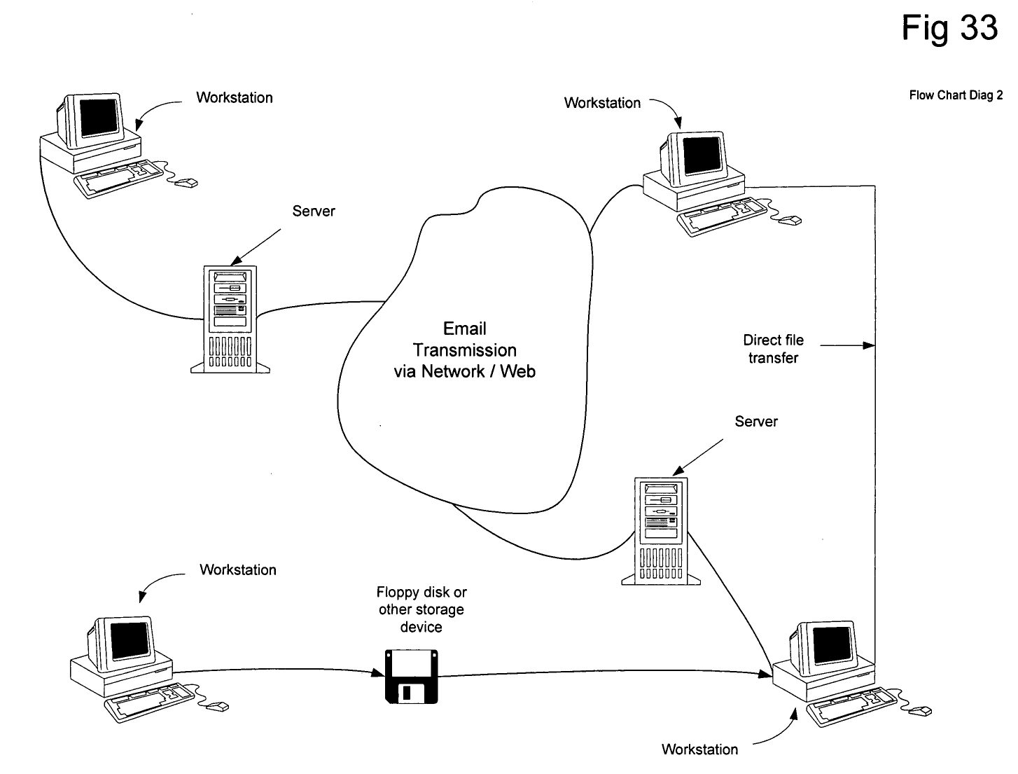

FIG. 33 illustrates a diagram of a network of computers as they may be configured in a local, wide-area or web network. As depicted in FIG. 33, in addition to use of the system over a network interface, Active Document Containers may also be created as separate files and transmitted to outside readers who would then open and view the Active Document within the Active Document Container on his/her own computer, add comments and proposed modifications, and then re-transmit the Active Document Container back to the authorized user/reader for review and further comment and/or approval. Active Document Containers may also be transferred to a floppy disk or other storage medium as a method of distributing it to others.

Active Document Containers may include all of the example interface screens previously described and a method to view them. For example, the Active Document Container could be a Workbook created in Microsoft Excel or other popular software program with similar features and functions, or it could be newly created.

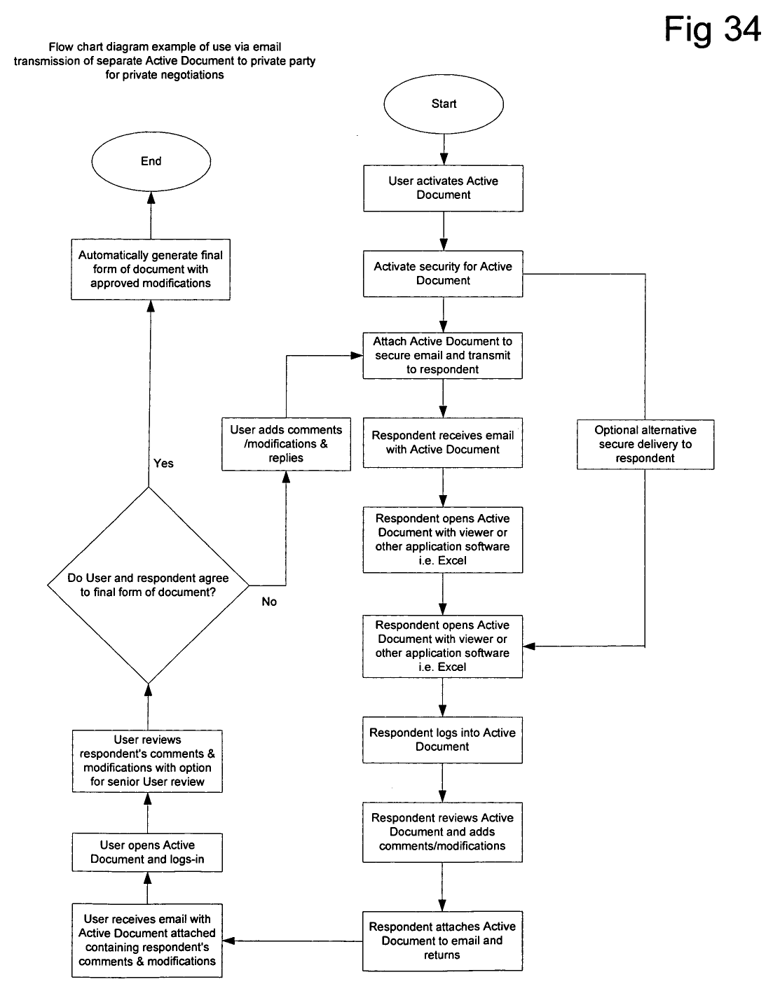

FIG. 34 illustrates a flow chart of how Active Document Containers may be used as separate files and transmitted back and forth via email as described in FIG. 33. For example, a user may activate an Active Document and activate security for the Active Document. The Active document may then be attached to an email and transmitted to a respondent who receives the email with the Active Document. The respondent may open the Active Document, log in, and review the Active Document and add comments and/or proposed modifications. The Respondent may then attach the Active Document to an email and return it to the user. The user may the view the Active Document that was modified by the Respondent, agree or disagree with the modifications added by the respondent, and generate a final form of the document with or without the proposed modifications.

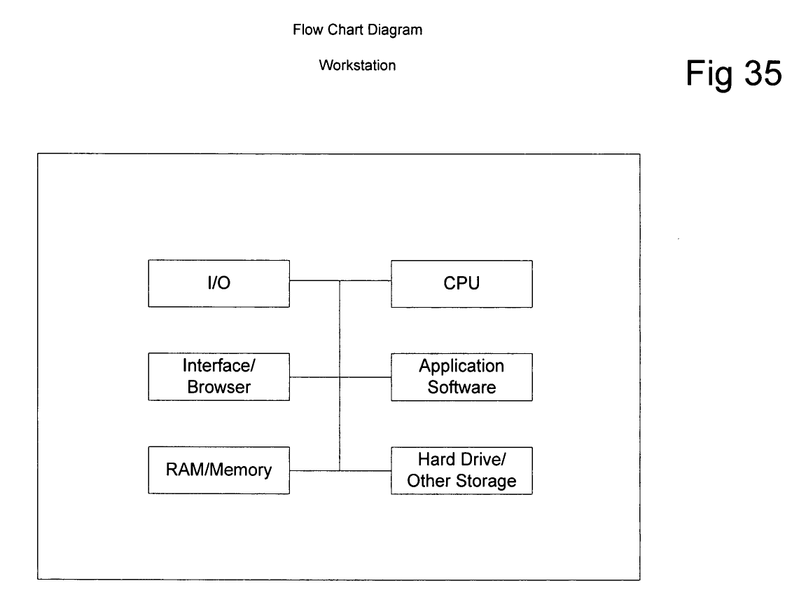

FIG. 35 illustrates a line drawing of the essential elements of a computer workstation that could be used to access the system online via a network or via a separate file that is downloaded or emailed to a user/reader using the workstation.

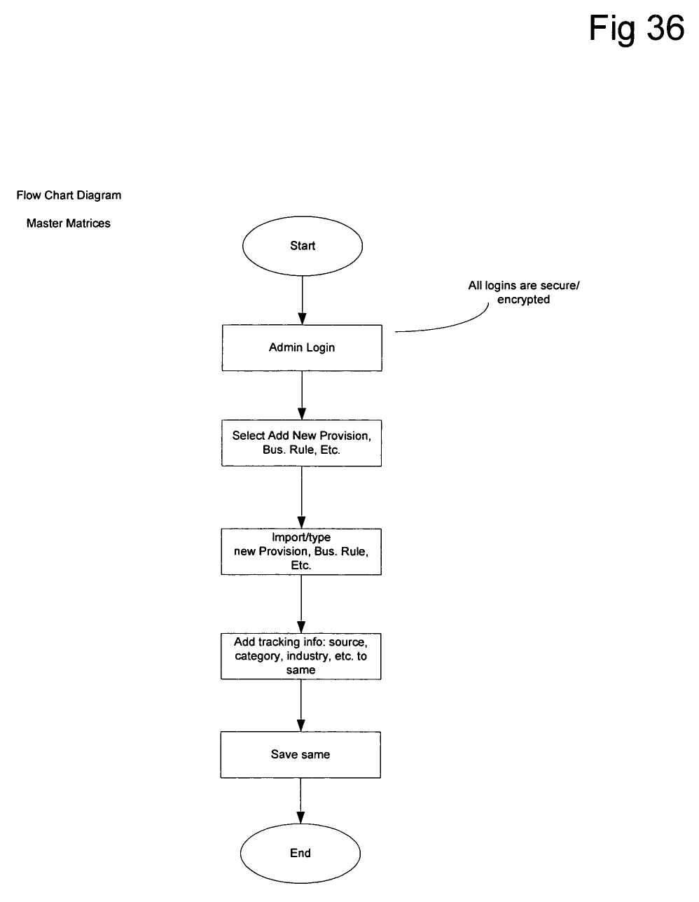

FIG. 36 illustrates a flow chart of the steps to build a Master Matrix. The administrator logs into the application using a secure/encrypted login. The administrator then selects, using the interfaces discussed above, to add a new provision, business rule, etc. The new provision, business rule, etc. is added to the application. Tracking information is added and the information that is input to the application is saved.

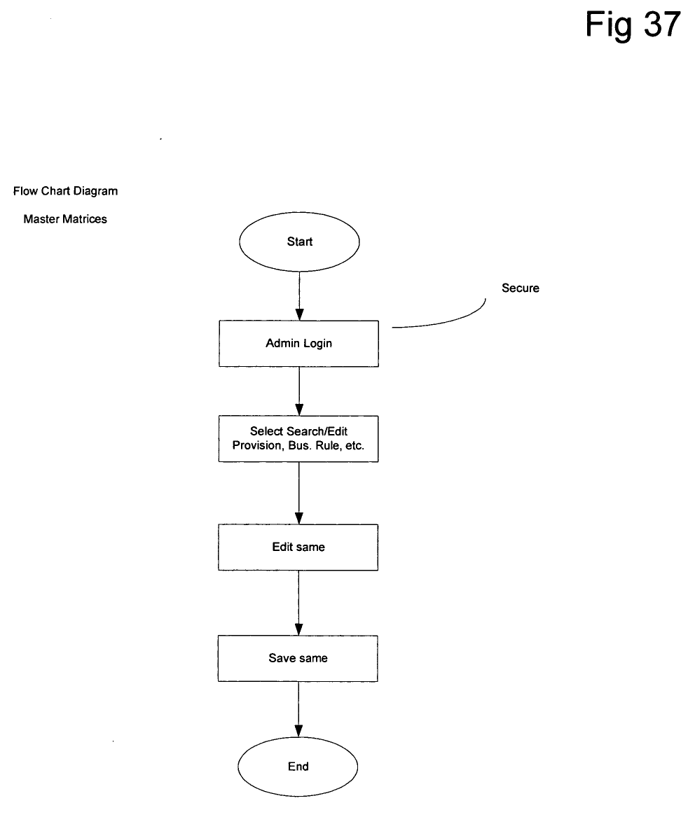

FIG. 37 illustrates a flow chart of the steps to search and retrieve and existing Master Matrix for the purpose of editing the same. The administrator logs into the application using a secure/encrypted login. The administrator then selects, using the interfaces discussed above, to search/edit a provision, business rule, etc. The provision, business rule, etc. is found/edited. The information that may have been edited is saved.

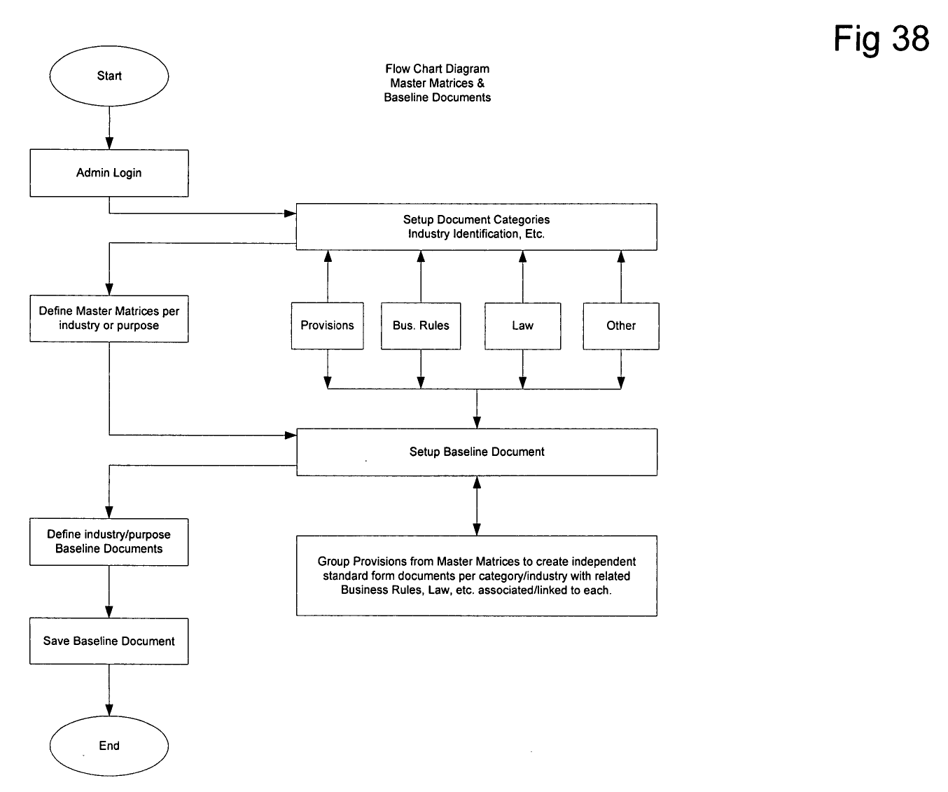

FIG. 38 illustrates an exemplary flow diagram of the steps to setup master matrices and base line documents. The administrator logs in and selects the option to create document categories, industry identification, etc. with respect to provisions, business rules, law, and other types of information. This information is used in the definition of the master matrices and the Baseline Document. Additionally, group provisions from the master matrices are used to create independent standard form documents per category/industry with the related business rules, law, etc. associated and linked to each. This information is then saved.

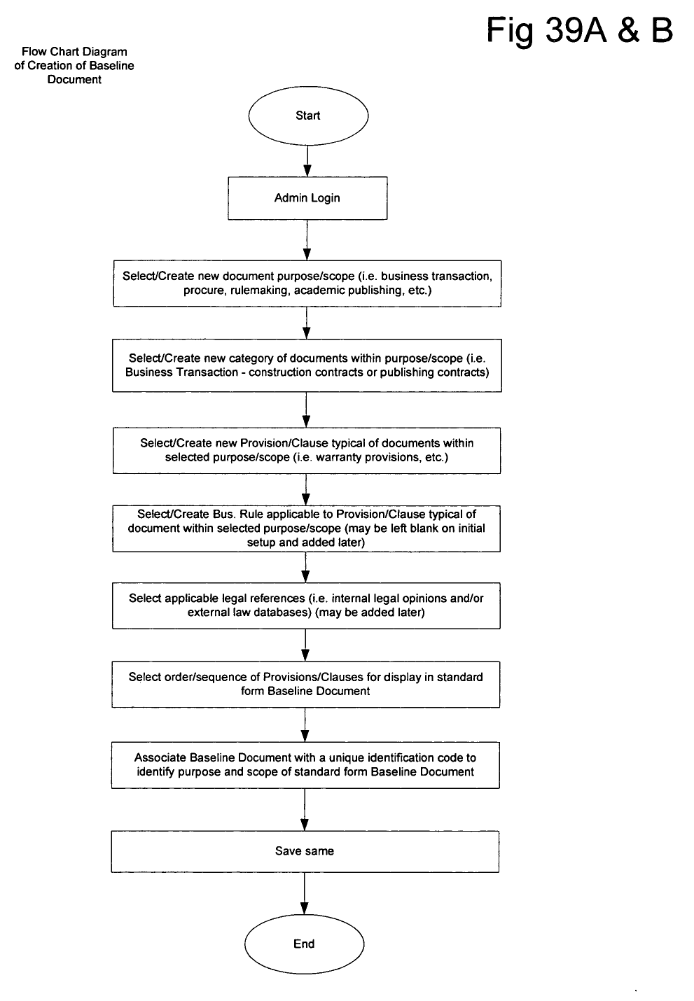

FIG. 39A and FIG. 39B illustrate an exemplary flow chart of the steps to build a Baseline Document. The administrator loges in and, using the interfaces discussed above, selects to create a now document, purpose, scope etc. i.e., business transactions, procure, rulemaking, academic publishing, etc. The user may then select to create a new category of document within the purpose selected, i.e., within the context of business transactions, the administrator may select, for example, construction contracts or publishing contracts. The administrator may then select to create a new provision or clause that is typical of the Documents with the selected purpose or scope, i.e., warranty provisions. Additionally, the administrator may select to create a business rule applicable to the provision clause that is typical of the Document within the selected purpose or scope. This information may be added at this time or added at a later time. The administrator may further select to add applicable legal references, i.e., internal legal opinions and/or external law databases. Again, this information may be added at this time or added at a later time. Additionally, other information may be added at this time. The order/sequence of the provisions and/or clauses for display in the standard form Baseline document may be input. The Baseline Document may additionally be associated with a unique identification code to identify the purpose and scope of the standard form Baseline Document. Finally, the information that has been input to the application may be saved.

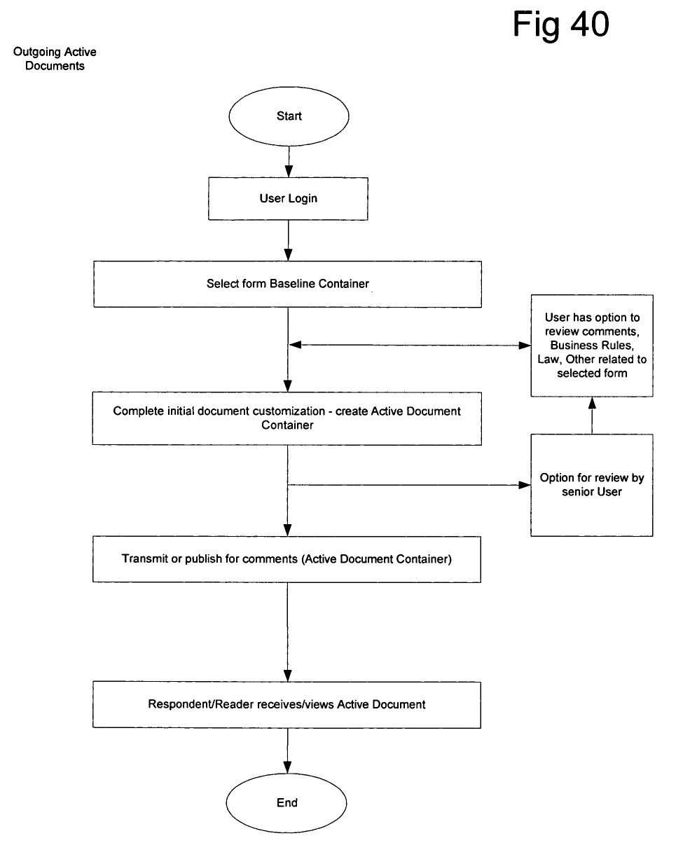

FIG. 40 illustrates a flow chart of the steps to activate an Active Document either via a network interface or via email attachment or other methods of delivering a separate Active Document Container file. After the user logs in, the user may select the form Baseline Document Container. The user has the option to review any comments, business rules, law and/or other information that is associated with the selected Baseline Document. The user may then complete the initial document customization and/or create an Active Document Container. The senior user may opt to review the information. The information is then transmitted for comments and the respondent/reader receives and viewed the Active Document in accordance with the methods discussed herein.

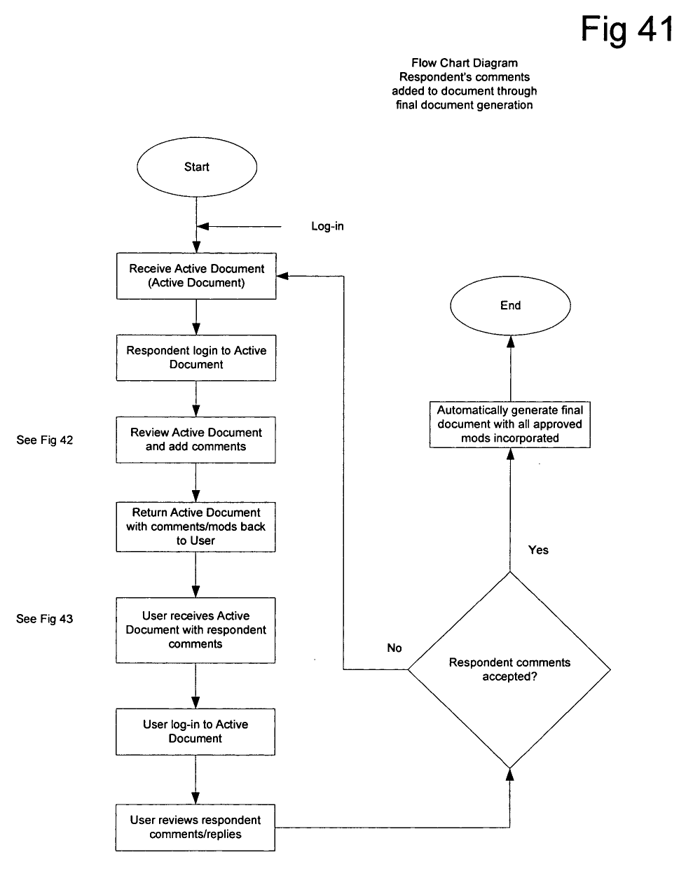

FIG. 41 depicts a flow diagram of the respondent's receipt and review of the Active Document. Upon receipt of the Active Document, the respondent logs into the application and reviews the document. The respondent may select, using the interfaces discussed above, to add comments/modifications to the Active Document. The respondent may then return the Active Document with the comments, back to the user. The user, after receiving the Active Document from the respondent, may log into the Active Document and review the comments/modifications added by the respondent. The user may select to accept the comments/modifications added by the respondent. If accepted, the Final Document may be generated with the approved modifications. If not, the process may repeat until the respondent provides comments that may be accepted by the user.

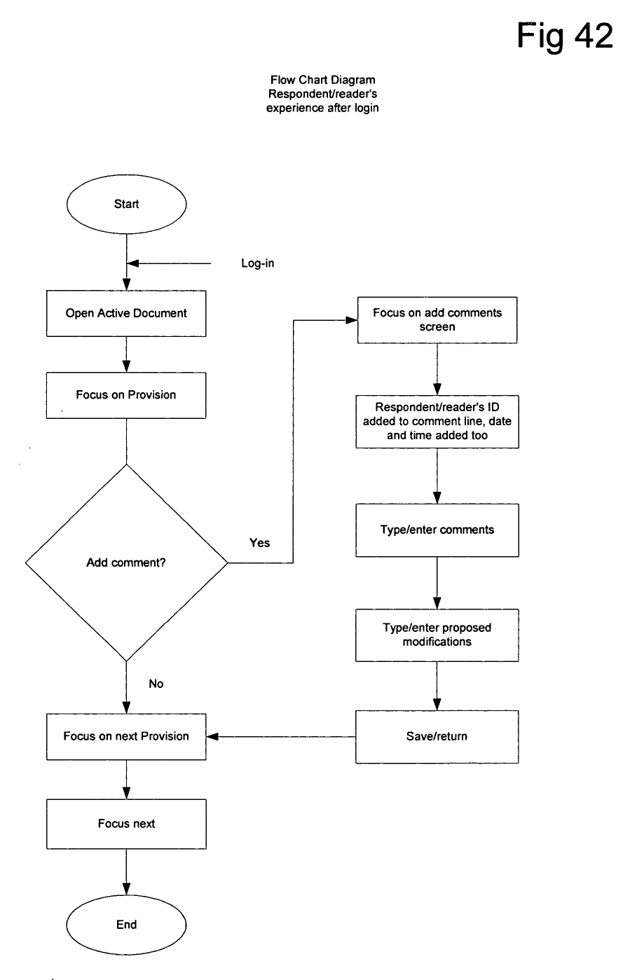

FIG. 42 depicts a flow diagram of exemplary actions the respondent may take after receiving and logging into an Active Document. Upon opening the received Active Document, the respondent may select a provision/clause consider and add comments/modifications for consideration. Upon the input of the comments/modifications, the respondent's identification number, time, and date are added to the application. The information is then saved and the respondent may then select additional provisions/clauses to add comments/modifications to.

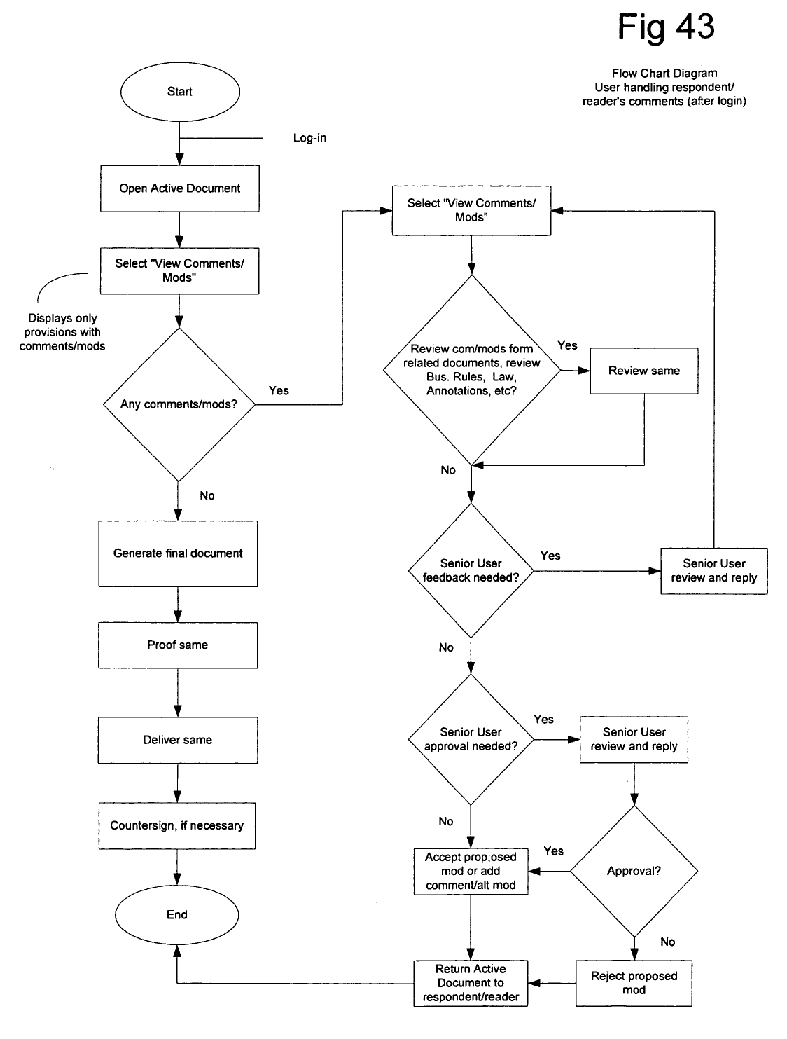

FIG. 43 illustrates a flow chart of the process of the user handling the respondent's comments after login. Upon opening the Active document, the user may select to view the comments/modifications using the interfaces discussed above. If there are comments/modifications to view, the user may view the comments/modifications added by the respondent. The user may then determine if a senior user's feedback is needed. If so, the information may be sent to the senior user for review and approval. The user may then decide to accept or deny the respondent's comments/modifications. This process is repeated until all comments/modifications are reviewed. If any comments/modifications are denied, the Active Document may be returned to the respondent for further consideration. If there are no additional comments/modifications for consideration, the Final Document may be generated.

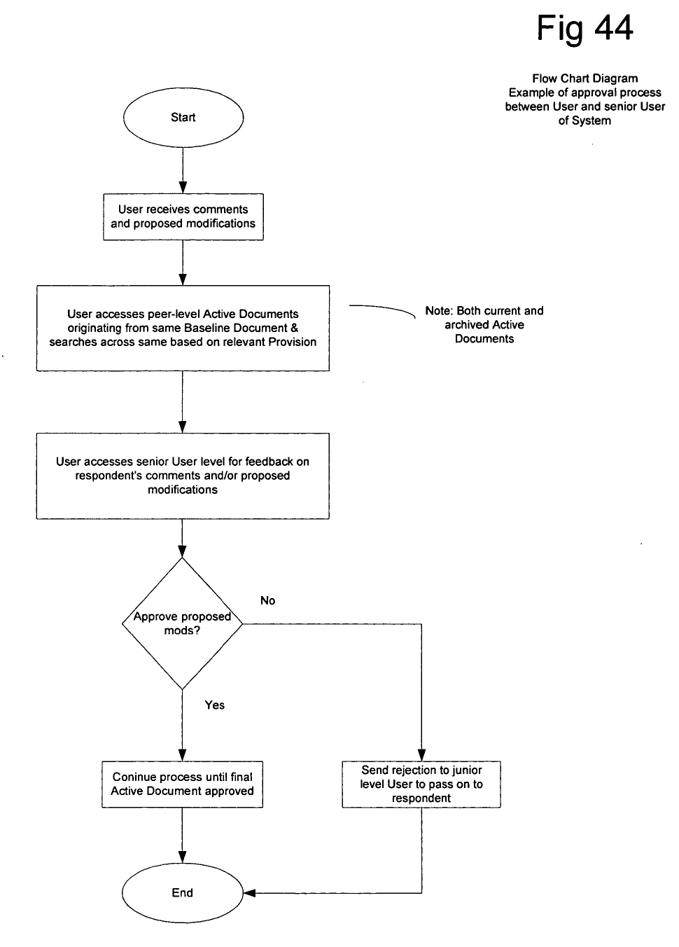

FIG. 44 illustrates a flow chart of the approval process between the user and the senior user. Upon the user's receipt of the respondent's comments/modifications, the user may access peer-level Active Documents originating from the same Baseline document and may additionally search across the same based upon the relevant provision. These searched Baseline Documents may include both current and archived Active Documents. The user may then access senior-user level for feedback on the respondent's comments/modifications. The proposed comments/modifications may be approved or denied. If denied, the rejection and/or the Active Document may ultimately be returned to the respondent where the process is repeated. If the comments/modifications are accepted, a Final Document may be generated with the approved comments/modifications.

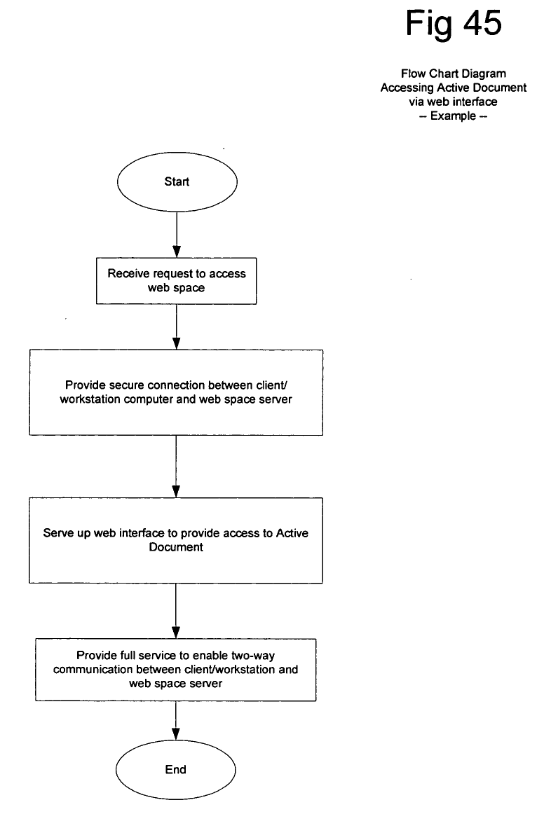

FIG. 45 illustrates a flow chart of steps to access an Active Document via a network interface connection. Upon receipt of a request to access the website, the server may provide a secure connection between the client/workstation and the server. The server application may then be accessed by the client/workstation.

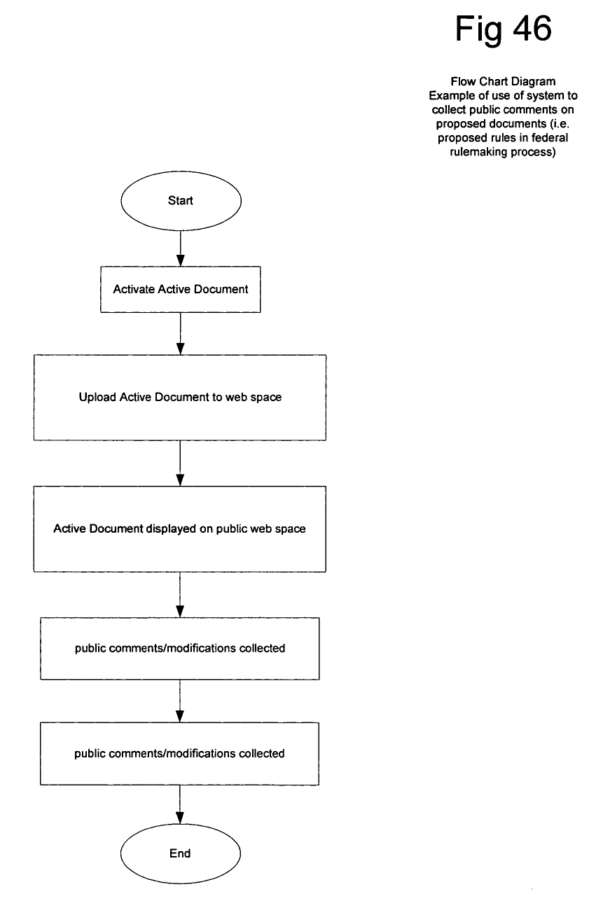

FIG. 46 illustrates a flow chart of the use of the system via network interface connection to solicit and collect public comments on an Active Document. Upon activation of the Active Document, the Active Document may be uploaded to a web server where the Active Document may be displayed such that the general public may access to the application and the Active Document. Through the application at the server, the public may add comments/modifications similar to the processes discussed above regarding the respondent. After a period of time, the ability for the public to add comments/modifications may close and the user may consider the comments/modifications proposed by the public.

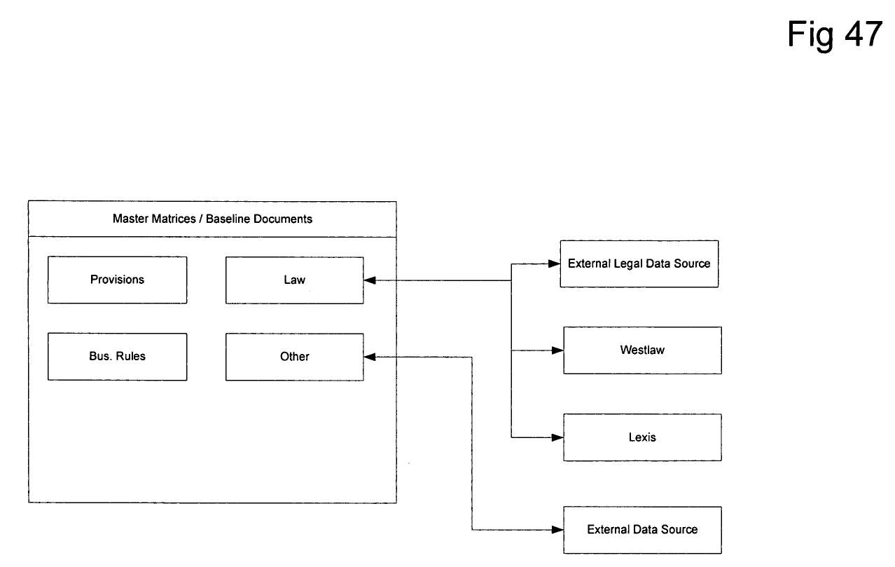

FIG. 47 illustrates a block diagram of the links between Master Matrices and/or Baseline Documents and external data sources such as legal research databases like Westlaw and Lexis, and other relevant external databases.

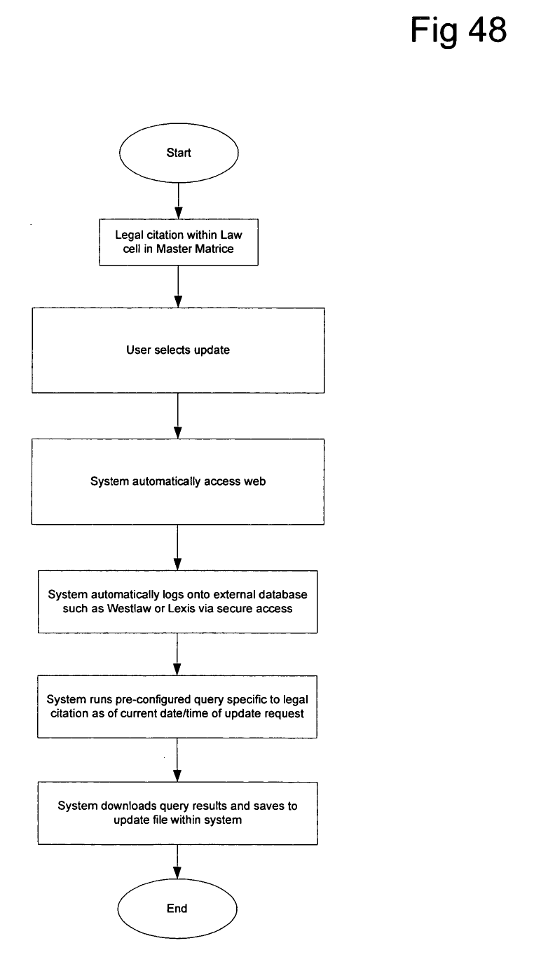

FIG. 48 illustrates a flow chart of the steps to query an online database regarding a legal citation. Where the Active Document includes a legal citation, the user may request the citation be verified to ensure the citation is still valid law. The user may select the application update the citation. The system then logs into an application including a database that may reside on a separate server on the network. The application located on the separate server may then determines if the legal citation still valid law. The system may then download the update results and saves the updated results within the system. If the law is no longer valid law, the user may be notified to update the legal citation.

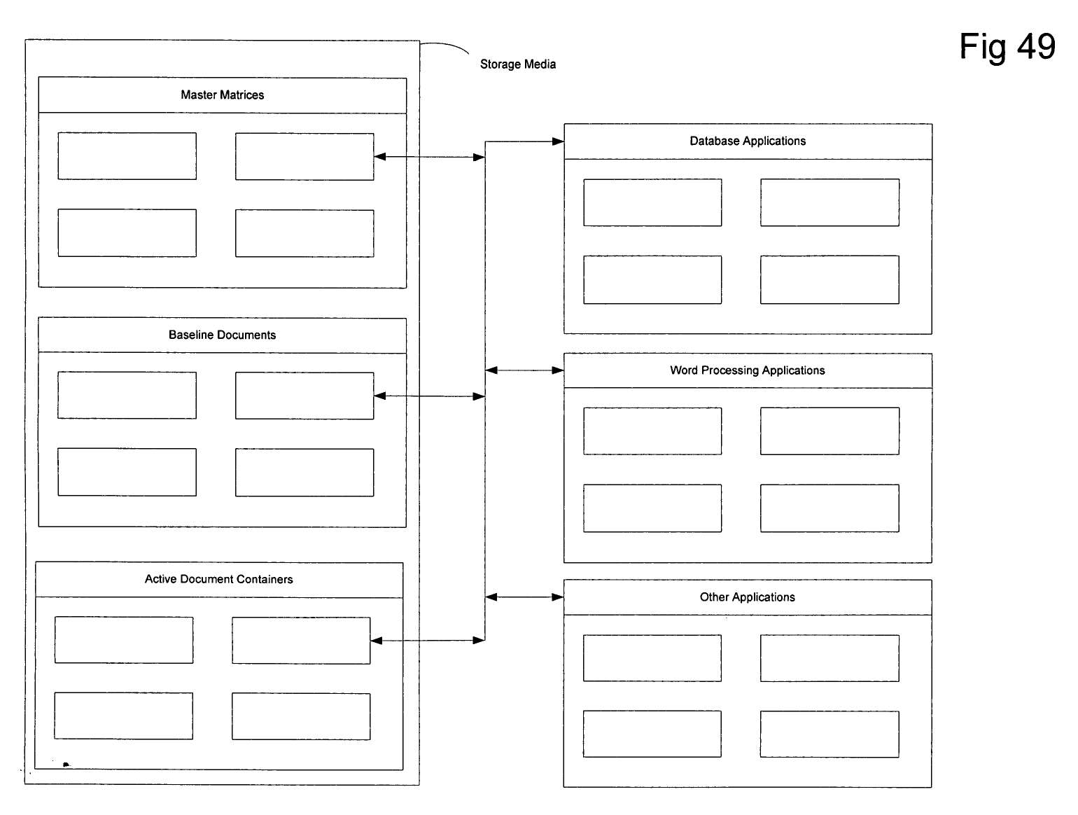

FIG. 49 illustrates a block diagram of the links between the Master Matrices, Baseline Documents, and Active Documents and other software applications such as database, word processing, spreadsheet, web, and other software.

FIGS. 49, 3 and 4 also illustrate how further indexing may be accomplished by linking Cell Addresses in one Worksheet to Cell Addresses in other Worksheets, including Cell Addresses in Worksheets in separate Workbooks, and linking Cell Addresses to other software programs such as spreadsheet, word processors, database, and web browser programs, or any combination of these programs.

In accordance with another exemplary embodiment of the present invention, a method and system of managing negotiated transactions is provided that enables the organization's negotiators, as negotiations are occurring and on a peer-to-peer level, to share successful negotiation strategies and tactics on a real-time basis, and enables the organization's negotiators to obtain approvals to use proposed negotiation strategies and tactics or to use proposed changes to contract language from senior level executives and legal counsel when necessary, all in a manner substantially more efficient than existing methods and systems.

In accordance with another embodiment of the present invention, a method and system of managing transactions may comprise at least one worksheet or table of transaction clauses, a plurality of worksheets or tables of business rules, business and legal risk tolerances, applicable law, comments, and the organization's business and legal approvals, and at least one transaction interface. The transaction interface may be a set of separately identifiable cells or data fields, each of which contains a transaction clause, that may display the transaction clauses in sequence as a single standard form contract identified by a unique contract identifier, and which also may be associated with a unique transaction identifier. Each identifiable cell or data field may be associated with a cell or data field in a plurality of worksheets or tables that contain business rules, business and legal risk tolerances, applicable law, comments, and the organization's business and legal approvals that relate to the contract clause contained in such cell or data field.

For any given transaction, the organization may issue its standard form contract consisting of a single set of contract clauses that the organization has identified as applicable to a given transaction and that are displayed via the contract interface. One contract interface would be viewable by all parties to the contract. As each other party's negotiator views the standard form contract, each negotiator could create, store and save one or more comments with respect to each contract clause. The negotiator's comment may be associated with the unique contract identifier, the unique transaction identifier, the unique cell or data field identifier, a unique negotiator identifier, the date and time the negotiator's comment was created, and the negotiator's proposed contract clause language changes based on the negotiator's comment. Each negotiator's comment would be saved and stored in the worksheet or table associated with the cell or data field containing the related contract clause. Upon the creation of any comments, the contract interface would display a notification of the creation of a new comment for the related contract clause. Each negotiator's comment would be viewable by all other negotiators who could then create a responsive record that would be saved and stored in the same worksheet or table as the initial comment for the given contract clause for the given transaction. In each instance of creating a new comment, the original contract clause would always be displayed in its original form together with all prior comments relating to that particular contract clause sorted in date and time order, without duplicating any data.

As other negotiators create records for individual contract clauses for a given transaction, the organization's negotiator may view each of the other negotiator's records for that transaction. In addition, the organization's negotiator may, via the contract interface, access the organization's confidential and proprietary information relevant to each contract clause such as: (i) the organization's business rules, business and legal risk tolerances, legal opinions and research, citations to statutory and case law; (ii) comments that have been received by the organization in connection with other transactions that use the same contract clause language and the organization's replies to comments that were received in connection with such other transactions; and (iii) the organization's internal business and legal comments, including prior approvals or disapprovals of proposed contract clause language changes; all as the organization deems such information applicable to the given contract clause.

A method of storing an organization's transaction information consistent with the principles of the present invention may include drafting and updating the organization's transaction clauses in independent statements or clauses, and electronically storing and updating them in separate identifiable cells or data fields; drafting and updating the organization's negotiating rules in independent statements or clauses, and electronically storing and updating them in separate identifiable cells or data fields; drafting and updating the organization's business risk tolerances in independent statements or clauses, and electronically storing and updating them in separate identifiable cells or data fields; drafting and updating the organization's legal risk tolerances in independent statements or clauses, and electronically storing and updating them in separate identifiable cells or data fields; electronically storing and updating information about law relating to the organization's risk tolerances; electronically relating each of the organization's negotiating rules to each applicable transaction statement or clause; electronically relating each of the organization's risk tolerances to each applicable transaction statement or clause; and/or electronically relating information about law to each of the organization's applicable risk tolerance statement or clause.

The method may including enabling the selection and ordering of transaction statements and clauses sequentially to comprise a standard form contract for a particular transaction, saving the same within a discrete electronic file, while retaining the information relationships discussed above.

The method may further include enabling the organization's negotiator to electronically transmit the information in one file. This information may be transmitted electronically, in methods known to one of ordinary skill in the art. Alternatively, this file may be transmitted by floppy disk, or other known ways. Where the file is transmitted, either by floppy disk or e-mail, a password may be required to access the file. Further, the file may be accessed and manipulated where the receiver has, for example, MicroSoft's Excel® software on his personal computer. There may be no requirement for additional proprietary software as all of the necessary proprietary software is included in the transmitted file. The receiver merely has to open the file, add any comments, if necessary, save the file, and send the file back to the sender. The receiver's comments may then be retrieved and stored as discussed above.

A method of managing transactions consistent with the principles of an alternative embodiment of the present invention may include receiving a request to display a standard form contract for a particular transaction; automatically displaying a standard form contract for a particular transaction that is associated with a unique transaction identifier where the standard form contract clauses comprise a set of transaction statements/clauses that are contained in separate cells or data fields where each cell or data field is associated with its own unique identifier where each separate cell or data field is associated with a plurality of worksheets or tables containing negotiating rules, legal risk tolerances, applicable law, and other transaction related information.

Another method of collecting, storing and retrieving information consistent with the principles of the present invention may include receiving a display of an electronic document where the electronic document is associated with an identification code or file name and where the electronic document text is contained in a plurality of discrete and separately identifiable cells or data fields and where each cell or data field is associated with a hidden worksheet or table that is accessible by the user and where the hidden worksheet or table contains a plurality of discrete and separately identifiable cells or data fields one of which contains the electronic document identification code or file name, another of which contains the associated cell or data field identification code, and other cells or data fields for collecting user information, the date and time the user accesses the worksheet or table, the user's comments about the text in the associated cell or data field, the user's proposed changes to the text in the associated cell or data field and where the hidden worksheet is associated with another hidden worksheet or table that may include secured access.

Modifications and adaptations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing information related to a document, comprising:
storing and indexing a plurality of clauses;
selecting at least one clause from the plurality of clauses;
creating a document including the at least one clause from the plurality of clauses;
providing for the receiving of information corresponding to the at least one clause;
storing and associating any received information to the at least one clause; and
displaying the received information to visually associate the received information with the at least one clause.

2. The method of claim 1, further including:
determining if the at least one clause is changed based upon the associated received information; and
storing the change to the at least one clause based upon the determination.

3. The method of claim 1, wherein any received information is at least one of a proposed change to the at least one clause, comments related to the at least one clause, identification information of the source of the received information, a time the received information was received, and a date the received information was received.

4. The method of claim 1, wherein the plurality of clauses are indexed using predefined categories.

5. The method of claim 4, wherein the predefined categories relate to different types of clauses included in contracts.

6. The method of claim 1, wherein the information associated to the at least one clause may be archived for future consideration.

7. The method of claim 1, wherein the received information may be provided over a network.

8. The method of claim 1, wherein the document resides on a server accessible by at least one client over a network.

9. The method of claim 2, further including:
generating a final document based upon the document and the associated information.

10. The method of claim 1, wherein the document relates to at least one of government procurement processes, rulemaking processes, legislative processes, and peer review processes.

11. The method of claim 8, further including:
storing additional information related to the document, wherein the additional information includes at least one of business rules, legal rules, and other information that may contribute to the generating of the final document; and
associating the additional information with the at least one clause.

12. A computer-readable medium containing instructions, executed by a processor, for performing a method for managing information related to a document, the method comprising:
storing and indexing a plurality of clauses;
selecting at least one clause from the plurality of clauses;
creating a document including the at least one clause from the plurality of clauses;
providing for the receiving of information corresponding to the at least one clause;
storing and associating any received information to the at least one clause; and
displaying the received information to visually associate the received information with the at least one clause.

13. The computer-readable medium of claim 12, further including:
determining if the at least one clause is changed based upon the associated received information; and
storing the change to the at least one clause based upon the determination.

14. The computer-readable medium of claim 12, wherein any received information is at least one of a proposed change to the at least one clause, comments related to the at least one clause, identification information of the source of the received information, a time the received information was received, and a date the received information was received.

15. The computer-readable medium of claim 12, wherein the plurality of clauses are indexed using predefined categories.

16. The computer-readable medium of claim 15, wherein the predefined categories relate to different types of clauses included in contracts.

17. The computer-readable medium of claim 12, wherein the information associated to the at least one clause may be archived for future consideration.

18. The computer-readable medium of claim 12, wherein the received information may be provided over a network.

19. The computer-readable medium of claim 12, wherein the document resides on a server accessible by at least one client over a network.

20. The computer-readable medium of claim 13, further including:
generating a final document based upon the document and the associated information.

21. The computer-readable medium of claim 12, wherein the document relates to at least one of government procurement processes, rulemaking processes, legislative processes, and peer review processes.

22. The computer-readable medium of claim 19, further including:
storing additional information related to the document, wherein the additional information includes at least one of business rules, legal rules, and other information that may contribute to the generating of the final document; and
associating the additional information with the at least one clause.

23. An apparatus for managing information related to a document, comprising:
a memory storing a program; and
a processor responsive to the program to
store and indexing a plurality of clauses;
select at least one clause from the plurality of clauses;
create a document including the at least one clause from the plurality of clauses;
provide for the receiving of information corresponding to the at least one clause;
store and associate any received information to the at least one clause; and
display the received information to visually associate the received information with the at least one clause.

24. The apparatus of claim 23, wherein the processor is further configured to:
determine if the at least one clause is changed based upon the associated received information; and
store the change to the at least one clause based upon the determination.

25. The apparatus of claim 23, wherein any received information is at least one of a proposed change to the at least one clause, comments related to the at least one clause, identification information of the source of the received information, a time the received information was received, and a date the received information was received.

26. The apparatus of claim 23, wherein the plurality of clauses are indexed using predefined categories.

27. The apparatus of claim 26, wherein the predefined categories relate to different types of clauses included in contracts.

28. The apparatus of claim 23, wherein the information associated to the at least one clause may be archived for future consideration.

29. The apparatus of claim 23, wherein the received information may be provided over a network.

30. The apparatus of claim 23, wherein the document resides on a server accessible by at least one client over a network.

31. The apparatus of claim 24, wherein the processor is further configured to:
generate a final document based upon the document and the associated information.

32. The apparatus of claim 23, wherein the document relates to at least one of government procurement processes, rulemaking processes, legislative processes, and peer review processes.

33. The apparatus of claim 30, wherein the processor is further configured to:
store additional information related to the document, wherein the additional information includes at least one of business rules, legal rules, and other information that may contribute to the generating of the final document; and
associate the additional information with the at least one clause.
